(19) United States
(12) Patent Application Publication
(10) Pub. No.: US 2008/0207481 A1
(43) Pub. Date: Aug. 28, 2008

(54) CONSUMER PRODUCTS HAVING VARYING ODORS

(75) Inventors: Georg MEINE, Mettmann (DE); Walter HOFSTETTER, Koln (DE); Hermann JONKE, Dusseldorf (DE); Piotr MALECKI, Wegberg-Arsbeck (DE)

Correspondence Address: Ratner Prestia, Suite 301, 1235 Westlakes Drive, Berwyn, PA, 19312, US

(73) Assignee: HENKEL KOMMANDITGESELLSCHAFT AUF AKTIEN, Dusseldorf (DE)

(21) Appl. No.: 12/044,457

(22) Filed: Mar. 7, 2008

Related U.S. Application Data
(63) Continuation of application No. PCT/EP2006/007957, filed on Aug. 11, 2006.

(30) Foreign Application Priority Data
Sep. 9, 2005 (DE) 10 2005 043 189.5

(51) Int. Cl. C11D 3/50

(52) U.S. Cl. 512/4; 512/20; 512/27

(57) ABSTRACT

Conventional perfumed consumer products are characterized by a uniform odor throughout the entire product. Consumer products are described that comprise at least two differently smelling perfume oils which are not evenly distributed in the product in proportion to one another. This allows the consumer to produce, using one and the same product, a variety of odors during applications and overcome the monotony of the olfactory experience associated with conventional perfumed consumer products.

### CROSS-REFERENCE TO RELATED APPLICATIONS

This application is a continuation under 35 U.S.C. §§ 120 and 365(c) of international application PCT/EP2006/007957, filed on Aug. 11, 2006. This application also claims priority under 35 U.S.C. § 119 of DE 10 2005 043 189.5, filed on Sep. 9, 2005.

### BACKGROUND OF THE INVENTION

The present invention relates to a consumer product having fragrance in which at least two differently smelling perfume oils are present which are not evenly distributed in the product in proportion to one another. The consumer product may be any industrially applicable, perfumed product, but primarily products from the fields of detergents or cleaners and cosmetics.

The use of fragrances in typical consumer products, such as, for example, detergents or cleaners, usually serves two different purposes. Firstly, the products as such are to be fragranced, secondly the objects on which the products act are to be fragranced. Using the example of detergents or cleaners, the freshly cleaned surfaces or the freshly washed laundry should convey the “freshly cleaned” odor impression which should last as long as possible; additionally, the sometimes very strong intrinsic odor of the detergents and cleaners is to be masked.

For many consumers, the scent of the consumer product, e.g. of a detergent or cleaner, also ultimately provides a welcome possibility of differentiation in view of the every more confusing array of products, for example in the fields of detergents and cleaners.

Since many consumers also, for example, perceive the scent of their detergent or cleaner as a contribution to increasing their feeling of well being and personal comfort, many detergent and cleaner manufacturers have in the meantime satisfied the consumer need for a large selection of detergents and cleaners with different scents. Thus, for example, there are entire product lines from the detergents and cleaners sector, such as, for example, fabric softeners, which essentially only differ by virtue of the supplied scent and are collected under the same trade name.

In this connection, the scent satisfies very specific consumer preferences. Thus, for example, for one and the same umbrella product, e.g. for a fabric softener, diverse scent directions, such as, for example, “almond and honey”, “peach and lime blossom”, “wild rose”, “orchid and lotus flower” or, for example, “white tulip and delicate mint” etc. are supplied so that the consumer can select the product according to his individual sensitivities and preferences.

However, for a consumer who values spontaneity and an abundance of change, the stocking-up of his products, e.g. of detergents and cleaners, remains problematic. If, for example, he would rather often vary his fabric softener scent, then he has to store a large number of fabric softeners at home. A changing perfume with different scent impressions has hitherto only been achieved for the consumer by using different products, all of which have to be stored.

The object underlying the present invention is therefore to be considered that of providing an improved supply to the consumer with a need for scent diversity.

### DESCRIPTION OF THE INVENTION

This object is achieved by a consumer product having fragrance, preferably detergent or cleaner or cosmetic composition, which comprises at least two differently smelling perfume oils which are not evenly distributed in the product in proportion to one another. According to a preferred embodiment, at least 3, 4, 5, 6 or more differently smelling perfume oils are advantageously present which are not evenly distributed in the product in proportion to one another. According to a preferred embodiment, the product comprises ingredients from the fields of detergents, cleaners and/or cosmetics.

The understanding of the invention arises directly from the comparison with the known prior art, e.g. by reference to conventional detergents or cleaners. Experience has shown that a conventional detergent or cleaner is characterized by a single and uniform characteristic scent. That is because one and the same perfume oil is distributed as evenly as possible within the product. When, for example, two portions of washing powder are removed from a conventional packet of detergent using a beaker, then each of the samples comprises one and the same perfume oil within the scope of usual product deviations. This naturally also applies when the product promise is directed, for example, to an almond/honey fragrance. The result then too is only precisely one single constant odor impression throughout the entire product.

This corresponds to current logic, according to which the scent of a product should be a uniform, unmistakable and thus unique symbol of recognition of the particular product, especially in the field of conventional detergents or cleaners.

Within the scope of the present invention, this classic concept representing the prior art of the constant odor throughout the entire product becomes completely outmoded.

The consumer product according to the invention, preferably detergent or cleaner, is characterized specifically in that it comprises more than one perfume oil, i.e. at least two differently smelling perfume oils. These are not distributed evenly in the product in proportion to one another. Were they distributed evenly in the product in proportion to one another, then a largely uniform product fragrance would nevertheless arise. However, this is not the case according to the invention. Since the perfume oils present are not distributed evenly in the product in proportion to one another, a qualitatively and optionally also quantitatively uneven product fragrance arises based on the overall product in question, preferably detergent or cleaner. According to a preferred embodiment, the consumer product according to the invention has a qualitatively uniform product fragrance.

The extent of the unevenness of the product fragrancing can be adjusted entirely infinitely over very wide ranges, both in a qualitative and quantitative respect.

Far-reaching differentiation possibilities arise, for example, firstly via the selection of the perfume oils present. There must be at least two differently smelling perfume oils present. The term “differently smelling” here covers the entire spectrum from gradual variability to total variability. One example of gradually differently smelling perfume oils would be present, for example, if perfume oil 1 radiates an orange-like scent and perfume oil 2 radiates a lemon-like scent. Both are citrus-like and thus similar scents. An example of significantly differently smelling perfume oils would be present, for example, if perfume oil 1 radiates an orange-like scent whereas perfume oil 2 radiates a honey-like scent or even an animalic or metallic odor, which leads to a total variability. However, these are only two examples plucked at random, which are merely intended to serve as illustration in simple terms.

A further differentiation possibility arises, as is directly understandable, via the number of odiferously differing perfume oils present and also via their use amount. According to a preferred embodiment, the product according to the invention comprises at least 2, 3, 4, 5 or 6 or even more differently smelling perfume oils which are not evenly in the product in proportion to one another.

A further differentiation possibility arises via the local distribution characteristics of the perfume oils.

Here, very diverse models are practicable. This will be illustrated using the example of detergents or cleaners.

One model for powder detergents would be, for example, the “layer model”. A detergent according to the invention in accordance with the “layer model” follows the principle of the layered structure. For example, 11 different washing powders can be produced in a conventional way. Washing powder 1 comprises only perfume oil 1 and washing powder 11 comprises only perfume oil 2. Washing powders 2-10 comprise both perfume oil 1 and perfume oil 2, but in varying amounts. Washing powder 2 comprises, based on the perfume oil present overall therein, 90% by weight of perfume oil 1 and 10% by weight of perfume oil 2. Correspondingly, washing powder 3 comprises 80% by weight of perfume oil 1 and 20% by weight of perfume oil 2, washing powder 4 comprises 70% by weight of perfume oil 1 and 30% by weight of perfume oil 2, etc. until washing powder 10 which comprises 10% by weight of perfume oil 1 and 90% by weight of perfume oil 2.

These washing powders are then layered one above the other in a washing powder pack in the order in which they are numbered, i.e. the lowest layer is formed by washing powder 1, then comes 2, 3, 4 etc. until washing powder 11 which is at the top. This is an example of a detergent according to the “layer model” which comprises at least two differently smelling perfume oils which are not evenly distributed in the product in proportion to one another. In this case, 2 gradually differing perfume oils, for example, could be used. Such that thus firstly the detergent produces a lemon-like scent which, as the detergent is gradually used up, converts more and more to an orange-like scent and ultimately entirely to an orange-like scent. Following this example, merely as regards the layer model, multiple creations are possible. It is possible, for example, to configure the directly bordering layers in an odiferously intensely contrasting way, thus, for example, to configure one layer sweetish mild, the following layer spicey-herb, etc. There are no limits to the perfuming creativity of the perfumer. According to the above statements, a preferred embodiment of the invention is one in which the consumer product has a layer structure where at least the layers bordering one another are differently fragranced relative to one another.

One model for liquid consumer products would be liquid detergents with solid fractions, for example in the form of capsules, microcapsules or speckles. The solids are in each case perfume oil carriers and distributed in the liquid product, where distribution is random, which means that the solids essentially stick to their position and neither rise up nor sink. In this connection, the detergent comprises at least two different species of solids, where species 1 comprises perfume oil 1 and species 2 comprises perfume oil 2. The particle species are then distributed unevenly in the liquid detergent, meaning that the perfume oils are not evenly distributed in the product in proportion to one another. When removing the product, at least gradually differing scent impressions must thus always result.

Correspondingly, according to a preferred embodiment, the product according to the invention is essentially present in liquid form. Preferably, a product according to the invention which is essentially present in liquid form comprises suspended solids which advantageously carry perfume oil(s). The expression that a composition “is essentially present in liquid form” is intended to clarify that it can also comprise solid fractions.

A further embodiment relates to so-called multiphase systems (preferably 2 liquid phases), e.g. 2-phase cleaners or detergents which are characterized by one (or more) horizontal separating line. For example, predominantly perfume oil 1 is present in the upper phase, for example predominantly perfume oil 2 is present in the lower phase, preferably in one of the phases, in particular in both phases, suspended solids are present which carry perfume.

The invention provides a large spectrum of possibilities for fragrancing of products, such as, for example, detergents or cleaners. The differently smelling perfume oils can, for example, also be distributed completely arbitrarily in the product, with the proviso that they are not distributed evenly in the product in proportion to one another. Such an arbitrary or chaotic perfume oil distribution would thus be tantamount to a scent potpourri or rather even a scent lottery. To his additional delight, the consumer here also gets the surprise effect as an additional benefit since he never knows beforehand how the item treated by him with the detergent or cleaner will ultimately smell since the perfume oil distribution in the detergent or cleaner is indeed chaotic. Thus, for virtually every wash, he would have a new, where possible even unique, possibly unrepeatable, odor experience and could thus completely break through the monotony of the olfactory experience associated with the conventional products. This would be one example of an uneven distribution of perfume oils that takes place in an unsystematic way in products such as preferably detergents or cleaners. A characteristic of such a product would be the essentially aleatoric character of the scent experience. Such a product would be a welcome enhancement for a consumer of the type of individual who enjoys experimentation. According to a preferred embodiment, the perfume oils can therefore be distributed unevenly in the product in an unsystematic way.

However, the differently smelling perfume oils can, for example, also be distributed unevenly in the product, preferably detergent or cleaner, in a very systematic way, as outlined, for example, in the layer model. According to a preferred embodiment, the perfume oils can therefore be distributed unevenly in the product in a systematic way.

There are no restrictions here on the freedom of action of those carrying out product design; only the prerequisite that there must be at least two differently smelling perfume oils present in the consumer product which are not distributed evenly in the product in proportion to one another has to be satisfied according to the invention.

The term perfume oil is preferably intended to mean fragrance compositions that are complete in themselves which are generally used for product fragrancing and, particularly according to human judgment, smell nice. This may be illustrated using an example. If, for example, a person skilled in the art wishes to make a shower gel smell nice, then he adds to it usually not just one (nice-)smelling substance, but a collective of (nice-)smelling substances. Such a collective usually consists of a large number of individual fragrances, e.g. more than 10 or 15, preferably up to 100 or more. Acting together, these fragrances form a desired nice-smelling, harmonious odor pattern. Such a collective of nice-smelling substances, a fragrance composition which where possible can also comprise perfume-specific auxiliaries, is described according to the invention by the term perfume oil. The words “complete in themselves” are intended to illustrate that a perfume oil can also be formed by mixing two or more perfume oils, but where, after mixing (in the product), the individual perfume oils are not perceived separately from one another, i.e. alongside one another, but form a common, uniform scent collective. Anyone knows this from his everyday experience. Thus, for example, a shower gel also develops a unique characteristic scent, e.g. of lemon or a unique mixed odor. It does not develop several odors separately from one another. This would only be realized if 2 or more different shower gels were used separately from one another. The uniform scent of conventional products is an automatic consequence of the fact that the perfume oils present are distributed evenly in the product in proportion to one another.

In extreme exceptional cases, a perfume oil according to the invention can even consist of just a single fragrance, although this is extremely unusual and improbable, but falls within the range of what is possible according to the invention. In the usual case, a perfume oil (thus a fragrance composition) according to the invention consists of at least 2, preferably at least 3, advantageously at least 4, different fragrances which together develop a preferably nice-smelling odor pattern.

A perfume oil according to the invention can thus comprise individual fragrance compounds, e.g. the synthetic products of the ester type, ether type, aldehyde type, ketone type, alcohol type and hydrocarbon type. Fragrance compounds of the ester type are, for example, benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allyl cyclohexylpropionate, styrallyl propionate, benzyl salicylate, cyclohexyl salicylate, floramate, melusate and jasmecyclate. The ethers include, for example, benzyl ethyl ether and ambroxan; the aldehydes include, for example, the linear alkanals having 8-18 carbon atoms, citral, citronellal, citronellyloxyacetaldehyde, cyclamenaldehyde, lilial and bourgeonal, the ketones include, for example, the ionones, α-isomethylionone and methyl cedryl ketone, the alcohols include anethole, citronellol, eugenol, geraniol, linalool, phenylethyl alcohol and terpineol, and the hydrocarbons include primarily the terpenes, such as limonene and pinene. However, preference is given to using mixtures of different fragrances which together produce an appealing scent note of the formed perfume oil.

However, the perfume oils can also comprise natural fragrance mixtures, as are obtainable from vegetable sources, for example pine, citrus, jasmine, patchouli, rose or ylang ylang oil. Likewise suitable are clary sage oil, chamomile oil, oil of cloves, melissa oil, mint oil, cinnamon leaf oil, lime blossom oil, juniper berry oil, vetiver oil, olibanum oil, galbanum oil and labdanum oil, and also orange blossom oil, neroli oil, orange peel oil and sandalwood oil.

In order to be detectable, a fragrance must be volatile, in which connection, besides the nature of the functional groups and the structure of the chemical compound, the molar mass plays an important role. For example, most fragrances have molar masses up to about 200 daltons, while molar masses of 300 daltons and above are more of an exception. On account of the varying volatility of fragrances, the odor of a perfume composed of two or more fragrances changes during evaporation, the odor impressions being divided into “top note”, “middle note or body” and “end note or dry out”.

Firmly adhering fragrances which can advantageously be used in the perfume oils within the scope of the present invention are, for example, the essential oils, such as angelica root oil, anise oil, arnica blossom oil, basil oil, bay oil, champaca blossom oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, cajeput oil, calmus oil, chamomile oil, camphor oil, canaga oil, cardamom oil, cassia oil, Scotch fir oil, copaiba balsam oil, coriander oil, spearmint oil, carraway oil, cumin oil, lemongrass oil, musk seed oil, myrrh oil, clove oil, neroli oil, niaouli oil, olibanum oil, origanum oil, palmarosa oil, patchouli oil, peru balsam oil, petitgrain oil, pepper oil, peppermint oil, pimento oil, pine oil, rose oil, rosemary oil, sandalwood oil, celery oil, star anise oil, thuja oil, thyme oil, verbena oil, vetiver oil, juniper berry oil, wormwood oil, wintergreen oil, ylang ylang oil, ysop oil, cinnamon oil, cinnamon leaf oil, and cypress oil.

However, the higher-boiling or solid fragrances of natural or synthetic origin may also advantageously be used as firmly adhering fragrances or fragrance mixtures in the perfume oils within the scope of the present invention. These compounds include the compounds specified below and mixtures of these: ambrettolide, α-amylcinnamaldehyde, anethole, anisaldehyde, anise alcohol, anisole, methyl anthranilate, acetophenone, benzyl acetone, benzaldehyde, ethyl benzoate, benzophenone, benzyl alcohol, borneol, bornyl acetate, α-bromostyrene, n-decylaldehyde, n-dodecyl-aldehyde, eugenol, eugenol methyl ether, eucalyptol, farnesol, fenchone, fenchyl acetate, geranyl acetate, geranyl formate, heliotropin, methyl heptynecarboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl n-amyl ketone, methyl methylanthranilate, p-methylacetophenone, methyl chavikol, p-methylquinoline, methyl β-naphthyl ketone, methyl n-nonylacetaldehyde, methyl n-nonyl ketone, muskone, β-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenyl-acetaldehyde dimethyl acetal, phenylacetic acid, pulegone, safrol, isoamyl salicylate, methyl salicylate, hexyl salicylate, cyclohexyl salicylate, santalol, scatol, terpineol, thymene, thymol, γ-undecalactone, vanillin, veratrumaldehyde, cinnamaldehyde, cinnamyl alcohol, cinnamic acid, ethyl cinnamate, benzyl cinnamate.

The more readily volatile fragrances which can advantageously be used in the perfume oil within the scope of the present invention include, in particular, the lower boiling fragrances of natural or synthetic origin, which can be used on their own or in mixtures. Examples of more readily volatile fragrances are alkyl isothiocyanates (alkyl mustard oils), butanedione, limonene, linalool, linalyl acetate and propionate, menthol, menthone, methyl n-heptenone, phellandrene, phenylacetaldehyde, terpinyl acetate, citral, citronellal.

All of the abovementioned fragrances can be used on their own or in a mixture in the perfume oils according to the present invention with the advantages already stated.

In particular, fragrances from the group of allyl alcohol esters, esters of secondary alcohols, esters of tertiary alcohols, allylic ketones, acetals, ketals, condensation products of amines and aldehydes and/or mixtures thereof may also be present in the perfume oil.

Allyl alcohol esters are the esters of the allyl alcohol which has the following structural feature C(OH)—C═C. Examples of allyl alcohol esters are, in particular, allyl amyl glycolate, allyl anthranilate, allyl benzoate, allyl butyrate, allyl caprate, allyl caproate, allyl cinnamate, allyl cyclohexane acetate, allyl cyclohexane butyrate, allyl cyclohexane propionate, allyl heptoate, allyl nonanoate, allyl salicylate, amyl cinnamylacetate, amyl cinnamylformate, cinnamylformates, cinnamylacetates, cyclogalbanate, geranyl acetate, geranyl acetoacetate, geranyl benzoate, geranyl cinnamate, methallyl butyrate, methallyl caproate, neryl acetate, neryl butyrate, amyl cinnamylformate, alpha-methyl cinnamylacetate, methylgeranyl tiglate, mertenyl acetate, farnesyl acetate, fenchyl acetate, geranyl anthranilate, geranyl butyrate, geranyl isobutyrate, geranyl caproate, geranyl caprylate, geranyl ethylcarbonate, geranyl formate, geranyl furoate, geranyl heptoate, geranyl methoxyacetate, geranyl pelargonate, geranyl phenylacetate, geranyl phthalate, geranyl propionate, geranyl isopropoxyacetate, geranyl valerate, geranyl isovalerate, trans-2-hexenyl acetate, trans-2-hexenyl butyrate, trans-2-hexenyl caproate, trans-2-hexenyl phenylacetate, trans-2-hexenyl propionate, trans-2-hexenyl tiglate, trans-2-hexenyl valerate, beta-pentenyl acetate, alpha-phenyl allyl acetate, prenyl acetate, trichloromethyl phenyl carbinyl acetate and/or mixtures thereof. Allyl alcohol esters may preferably be present in the perfume oil according to the invention.

Examples of esters of secondary alcohols (secondary alcohols are present if, on the C atom which carries the OH group, two H atoms are substituted by organic radicals (R¹ and R²) [general formulae: R¹—CH(OH)—R²]) are, in particular, ortho-tert-amyl cyclohexyl acetate, isoamyl benzyl acetate, secondary n-amyl butyrate, amyl vinylcarbinyl acetate, amyl vinylcarbinyl propionate, cyclohexyl salicylate, dihydro-nor-cyclopentadienyl acetates, dihydro-nor-cyclopentadienyl propionate, isobornyl acetate, isobornyl salicylate, isobornyl valerate, frutene, 2-methylbuten-2-ol-4-acetate, methyl phenylcarbinyl acetate, 2-methyl-3-phenylpropan-2-yl acetate, prenyl acetate, 4-tert-butylcyclohexyl acetates, verdox (2-tert-butyl cyclohexyl acetate), I vertenex (4-tert-butyl cyclohexyl acetate), violiff (carboxylic acid 4-cycloocten-1-ylmethyl ester), ethenyl isoamyl carbinyl acetate, fenchyl acetate, fenchyl benzoate, fenchyl n-butyrate, fenchyl isobutyrate, laevo-menthyl acetate, dl-menthyl acetate, menthyl anthranilate, menthyl benzoate, methyl isobutyrate, menthyl formate, laevo-menthyl phenyl acetate, menthyl propionate, menthyl salicylate, menthyl isovalerate, cyclohexyl acetates, cyclohexyl anthranilate, cyclohexyl benzoate, cyclohexyl butyrate, cyclohexyl isobutyrate, cyclohexyl caproate, cyclohexyl cinnamate, cyclohexyl formate, cyclohexyl heptoate, cyclohexyl oxalate, cyclohexyl pelargonate, cyclohexyl phenyl acetate, cyclohexyl propionate, cyclohexyl thioglycolate, cyclohexyl valerate, cyclohexyl isovalerate, methyl amyl acetate, methyl benzyl carbinyl acetate, methyl butyl cyclohexanyl acetate, 5-methyl-3-butyl tetrahydropyran-4-yl acetate, methyl citrate, methyl isocampholate, 2-methyl cyclohexyl acetate, 4-methyl cyclohexyl acetate, 4-methyl cyclohexyl methyl carbinyl acetate, methyl ethyl benzyl carbinyl acetate, 2-methylheptanol-6-acetate, methylheptenyl acetate, alpha-methyl n-hexyl carbinyl formate, methyl 2-methylbutyrate, methyl nonyl carbinyl acetate, methyl phenyl carbinyl acetate, methyl phenyl carbinyl anthranilate, methyl phenyl carbinyl benzoate, methyl phenyl carbinyl n-butyrate, methyl phenyl carbinyl isobutyrate, methyl phenyl carbinyl; caproate, methyl phenyl carbinyl caprylate, methyl phenyl carbinyl cinnamate, methyl phenyl carbinyl formate, methyl phenyl carbinyl phenyl acetate, methylphenyl carbinylpropionate, methyl phenyl carbinyl salicylate, methyl phenyl carbinyl isovalerate, 3-nonanyl acetate, 3-nonenyl acetate, nonanediol 2,3-acetate, nonynol acetate, 2-octanyl acetate, 3-octanyl acetate, n-octyl acetate, sec-octyl isobutyrate, beta-pentenyl acetate, alpha-phenyl allyl acetate, phenyl ethyl methyl carbinyl isovalerate, phenyl ethylene glycol diphenyl acetate, phenylethyethylcarbinyl acetate, phenyl glycol diacetate, sec-phenyl glycol monoacetate, phenyl glycol monobenzoate, isopropyl caprate, isopropyl caproate, isopropyl caprylate, isopropyl cinnamate, para-isopropyl cyclohexanyl acetate, propyl glycol diacetate, propylene glycol diisobutyrate, propylene glycol dipropionate, isopropyl n-heptoate, isopropyl n-hept-1-yne carbonate, isopropyl pelargonate, isopropyl propionate, isopropyl undecylenate, isopropyl n-valerate, isopropyl n-valerate, isopropyl isovalerate, isopropyl sebacate, isopulegyl acetate, isopulegyl acetoacetate, isopulegyl isobutyrate, isopulegyl formate, thymyl propionate, alpha-2,4-trimethylcyclohexane methyl acetates, trimethyl cyclohexyl acetate, vanillin triacetate, vanillylidene diacetate, vanillyl vanillate, and/or mixtures of these. These esters may preferably be present in the perfume oil according to the invention.

Preferred examples of esters of tertiary alcohols (tertiary alcohols are those in which, on the α-carbon atom which carries the OH group, three H atoms are substituted by organic radicals R¹, R², R³ (general formula R¹R²R³C—OH)) are tertiary-amyl acetate, caryophyllene acetate, cedrenyl acetate, cedryl acetate, dihydromyrcenyl acetate, dihydroterpinyl acetate, dimethylbenzyl carbinyl acetate, dimethylbenzyl carbinyl isobutyrate, dimethylheptenyl acetate, dimethylheptenyl formate, dimethylheptenyl propionate, dimethylheptenyl isobutyrate, dimethylphenyl ethyl carbinyl acetate, dimethylphenyl ethyl carbinyl isobutyrate, dimethylphenyl ethyl carbinyl isovalerate, dihydro-nor-dicyclopentadienyl acetate, dimethyl benzyl carbinyl butyrate, dimethyl benzyl carbinyl formate, dimethyl benzyl carbinyl propionate, dimethyl phenylethylcarbinyl n-butyrate, dimethyl phenylethylcarbinyl formate, dimethyl phenylethyl carbinyl propionate, elemyl acetate, ethynyl cyclohexyl acetate, eudesmyl acetate, ugenyl cinnamate, eugenyl formate, isoeugenyl formate, eugenyl phenyl acetate, isoeudehyl phenyl acetate, guaiyl acetate, hydroxycitronellyl ethyl carbonate, linallyl acetate, linallyl anthranilate, linallyl benzoate, linallyl butyrate, linallyl isobutyrate, linallyl caproate, linallyl caprylate, linallyl cinnamate, linallyl citronellate, linallyl formate, linallyl heptoate, linallyl N-methylanthranilate, linallyl methyl tiglate, linallyl pelargonate, linallyl phenyl acetate, linallyl propionate, linallyl pyruvate, linallyl salicylate, linallyl n-valerate, linallyl isovalerate, methyl cyclopentenolone butyrate, methyl cyclopentenolone propionate, methylethyl phenyl carbinyl acetate, methyl heptynecarbonate, methyl nicotinate, myrcenyl acetates, myrcenyl formate, myrcenyl propionate, cis-ocimenyl acetate, phenyl salicylate, terpinyl acetate, terpinyl anthranilate, terpinyl benzoate, terpinyl n-butyrate, terpinyl isobutyrate, terpinyl cinnamate, terpinyl formate, terpinyl phenyl acetate, terpinyl propionate, terpinyl n-valerate, terpinyl isovalerate, tributyl acetyl citrate, and/or mixtures thereof. These esters may preferably be present in the perfume oil according to the invention.

Some scent esters may either be esters of allylic and secondary or allylic and tertiary alcohols, such as, in particular, amyl vinylcarbinyl acetate, amyl vinylcarbinyl propionate, hexyl vinylcarbinyl acetate, 3-nonenyl acetate, 4-hydroxy-2-hexenyl acetate, linallyl anthranilate, linallyl benzoate, linallyl butyrate, linallyl isqbutyrate, linallyl caproate, linallyl caprylate, linallyl cinnamate, linallyl citronellate, linallyl formate, linallyl heptoate, linallyl N-methylanthranilate, linallyl methyl tiglate, linallyl pelargonate, linallyl phenyl acetate, linallyl propionate, linallyl pyruvate, linallyl salicylate, linallyl n-valerate, linallyl isovalerate, myrtenyl acetate, nerolidyl acetate, nerolidyl butyrate, beta-pentenyl acetate, alpha-phenyl allyl acetate, and/or mixtures thereof. These esters may also preferably be present in the perfume oil according to the invention.

Allylic ketones are characterized by the following structural feature C—C(═O)—C═C. Preferred examples are acetylfuran, allethrolone, allyl ionone, allyl pulegone, amyl cyclopentenone, benzylidene acetone, benzylidene acetophenone, alpha-isomethylionone, 4-(2,6,6-trimethyl-1-cyclohexen-1-yl)-3-buten-2-one, betadamascone (1-(2,6,6-trimethylcyclohexen-1-yl)-2-buten-1-one), damascenone (1-(2,6,6-trimethyl-1,3-cyclohexadien-1-yl)-2-buten-1-one), delta damascone (1-(2,6,6-trimethyl-3-cyclohexen-1-yl)-2-buten-1-one), alpha-ionone (4-(2,6,6-trimethyl-1-cyclohexenyl-1-yl)-3-buten-2-one), beta-ionone (4-(2,6,6-trimethyl-1-cyclohexen-1-yl)-3-buten-2-ones), gamma-methylionone (4-(2,6,6-trimethyl-2-cyclohexyl-1-yl)-3-methyl-3-buten-2-ones), pulegone and/or mixtures thereof. Allylic ketones may preferably be present in the perfume oil according to the invention.

Acetals are geminal diethers of the general formula R¹CH(OR²)(OR³). Preferred examples are acetaldehyde benzyl beta-methoxyethyl acetal, acetaldehyde diisoamyl acetal, acetaldehyde dipentanediol acetal, acetaldehyde di-n-propyl acetal, 10-acetaldehyde ethyl-trans-3-hexenyl acetal, acetaldehyde phenyl ethylene glycol acetal, acetaldehyde phenylethyl n-propyl acetal, cinnamic aldehyde dimethyl acetal, acetaldehyde benzyl beta-methoxyethyl acetal, acetaldehyde diisoamyl acetal, acetaldehyde diethyl acetal, acetaldehyde di-cis-3-hexenyl acetal, acetaldehyde dipentanediol acetal, acetaldehyde di-n-propyl acetal, acetaldehyde ethyl trans-3-hexenyl acetal, acetaldehyde phenyl ethylene glycol acetal, acetaldehyde phenylethyl n-propyl acetal, acetylvanillin dimethylacetal, alpha-amylcinnamic aldehyde diisopropyl acetal, p-tert-amyl phenoxyacetaldehyde diethyl acetal, anisaldehyde diethyl acetal, anisaldehyde dimethyl acetal, isoapioles, benzaldehyde diethyl acetal, benzaldehyde di(ethylene glycol monobutyl ether) acetal, benzaldehyde dimethyl acetal, benzaldehyde ethylene glycol acetal, benzaldehyde glyceryl acetal, benzaldehyde propylene glycol acetal, cinnamic aldehyde diethyl acetal, citral diethyl acetal, citral dimethyl acetal, citral propylene glycol acetal, alpha-methyl cinnamic aldehyde diethyl acetal, alpha-cinnamic aldehyde dimethyl acetal, phenyl acetaldehyde 2,3-butylene glycol acetal, phenyl acetaldehyde citronellyl methyl acetal, phenyl acetaldehyde diallyl acetal, phenyl acetaldehyde diamyl acetal, phenyl acetaldehyde dibenzyl acetal, phenyl acetaldehyde dibutyl acetal, phenyl acetaldehyde diethyl acetal, phenyl acetaldehyde digeranyl acetal, phenyl acetaldehyde dimethyl acetal, phenyl acetaldehyde ethylene glycol acetal, phenyl acetald glyceryl acetal, citronellal cyclomonoglycol acetal, citronellal diethyl acetal, citronellal dimethyl acetal, citronellal diphenyl ethyl acetal, geranoxyacetaldehyde diethyl acetal and/or mixtures thereof. Acetals may preferably be present in the perfume oil according to the invention.

Ketals are geminal diethers of the general formula R¹R²C(OR³)(OR⁴). Preferred examples are acetone diethyl ketal, acetone dimethyl ketal, acetophenone diethyl ketal, methylamyl catechol kbtal, methylbutyl catechol ketal and/or mixtures thereof. Ketals may preferably be present in the perfume oil according to the invention.

Preferred examples of condensation products of amines and aldehydes are anisaldehyde methyl anthranilate, aurantiol (hydroxycitronellal methyl anthranilate), verdantiol (4-tert-butyl-alpha-methyldihydrocinnam-aldehyde methyl anthranilate), vertosin (2,4-dimethyl-3-cyclohexenecarb-aldehyde), hydroxycitronellal ethyl anthranilate, hydroxycitronellal linallyl anthranilate, methyl N-(4-(4-hydroxy-4-methylpentyl)-3-cyclohexenylmethyl-idene) anthranilate, methyl naphthyl ketone methyl anthranilate, methyl nonyl acetaldehyde methyl anthranilate, methyl N-(3,5,5-trimethylhexylidene) anthranilate, vanillin methyl anthranilate and/or mixtures thereof. Condensation products of amines and aldehydes may preferably be present in the perfume oil according to the invention.

In particular, it is advantageous if fragrances such as, for example, adoxal (2,6,10-trimethyl-9-undecen-1-al), amyl acetate, anisaldehyde (4-methoxybenzaldehyde), bacdanol (2-ethyl-4-(2,2,3-trimethyl-3-cyclopenten-1-yl)-2-buten-1-ol), benzaldehyde, benzophenone, benzyl acetate, benzyl salicylate, 3-hexen-1-ol, cetalox (dodecahydro-3A,6,6,9A-tetramethyluaphtho-[2,1B]furan), cis-3-hexenyl acetate, cis-3-hexenyl salicylate, citronellol, coumarin, cyclohexyl salicylate, cymal (2-methyl-3-(para-isopropylphenyl)-propionaldehyde), decyl aldehyde, ethylvanillin, ethyl 2-methylbutyrate, ethylene brassylate, eucalyptol, eugenol, exaltolide (cyclopentadecanolide), florhydral (3-(3-isopropylphenyl)butanol), galaxolide (1,3,4,6,7,8-hexahydro-4,6,6,7,8,8-hexamethylcyclopenta-gamma-2-benzopyran), gamma-decalactone, gamma-dodecalactone, geraniol, geranylnitrile, helional (alpha-methyl-3,4-(methylenedioxy)hydrocinnamaldehyde), heliotropin, hexyl acetate, hexylcinnamaldehyde, hexyl salicylate, hydroxyambran (2-cyclo-dodecylpropanol), hydroxycitronellal, iso E super (7-acetyl-1,2,3,4,5,6,7,8-octahydro-1,1,6,7-tetramethylnaphthalene), isoeugenol, isojasmone, koavone (acetyldiisoamylene), laurylaldehyde, Irg 201 (2,4-dihydroxy-3,6-dimethyl-benzoic acid methyl ester), lyral (4-(4-hydroxy-4-methylpentyl)-3-cyclohexene-1-carboxaldehyde), majantol (2,2-dimethyl-3-(3-methylphenyl)propanol), mayor (4-(1-methylethyl)cyclohexanemethanol), methyl anthranilate, methyl beta-naphthyl ketone, methyl cedrylone (methyl cedrenyl ketone), methylchavicol (1-methyloxy-4,2-propen-1-ylbenzene), methyl dihydrojasmonate, methylnonylacetaldehyde, musk indanone (4-acetyl-6-tert-butyl-1,1-dimethylindane), nerol, nonalactone (4-hydroxynonanoic acid, lactone), norlimbanol (1-(2,2,6-trimethylcyclohexyl)-3-hexanol), P.T. bucinal (2-methyl-3-(para-tert-butylphenyl)propionaldehyde), para-hydroxyphenyl-butanone, patchouli, phenylacetaldehyde, phenylethyl acetate, phenylethyl alcohol, phenylethyl phenylacetate, phenylhexanol/phenoxanol (3-methyl-5-phenylpenta nol), polysantol (3,3-dimethyl-5-(2,2,3-trimethyl-3-cyclopenten-1-yl)-4-penten-2-ol), rosaphene (2-methyl-5-phenylpentanol), sandalwood, alpha-terpinene, tonalide/musk plus (7-acetyl-1,1,3,4,4,6-hexamethyltetralin), undecalactone, undecavertol (4-methyl-3-decen-5-ol), undecylaldehyde or undecenaldehyde, vanillin and/or mixtures are present in the perfume oil according to the invention.

If desired, at least one of the perfume oils present can also be combined with a perfume fixative. It is assumed that perfume fixatives are able to slow the evaporation of the more highly volatile fractions of perfume, which may be advantageous according to the invention.

According to a further preferred embodiment, at least one of the perfume oils present comprises a perfume fixative, preferably in the form of diethyl phthalates, musk (derivatives), and mixtures of these, where the amount of fixative is preferably 1 to 55% by weight, advantageously 2 to 50% by weight, more advantageously 10 to 45% by weight, in particular 10 to 40% by weight of the total amount of the perfume oil in question in each case.

According to a further preferred embodiment, at least one of the perfume oils present comprises an agent that increases the viscosity of liquids, in particular of perfume, preferably PEG (polyethylene glycol), advantageously with a molecular weight of from 400 to 2000, where the agent that increases the viscosity is present in a preferred manner in amounts of from 0.1 to 20% by weight, advantageously from 0.15 to 10% by weight, in a further advantageous manner from 0.2 to 5% by weight, in particular from 0.25 to 3% by weight, based on the total amount of the perfume oil in question in each case.

It has been found that agents increasing the viscosity of liquids, in particular of perfume, can make a contribution to perfume stabilization.

According to a preferred embodiment of the invention, at least one perfume oil comprises an agent that increases the viscosity, preferably polyethylene glycols (abbreviation: PEG), which can be described by the following general formula:

H—(O—CH₂—CH₂)ₙ—OH

The degree of polymerization n can vary from about 5 to >100 000, corresponding to molar masses of from 200 to 5 000 000 gmol⁻¹. The products with molar masses below 25 000 gmol⁻¹ are referred to here as suitable polyethylene glycols whereas higher molecular weight products are often referred to in the literature as polyethylene oxides (abbreviation: PEOX). The preferably used polyethylene glycols can have a linear or branched structure, where in particular linear polyethylene glycols are preferred, and be terminally capped.

Particularly preferred polyethylene glycols include those with relative molecular masses between 400 and 2000. It is also possible in particular to use polyethylene glycols which are per se present in a liquid state at room temperature and a pressure of 1 bar; the discussion here is primarily of polyethylene glycol with a relative molecular mass of 200, 400 and 600.

As has already been mentioned above, the structure of a perfume composition can be divided into “top note”, “middle note or body” and “end note or dry out”. The top note (head, top, initial odor) essentially comprises readily volatile fragrances, preferably mostly of fresh character. The middle note (bouquet, body, heart, heart note) essentially comprises moderately volatile fragrances, preferably mostly of floral character, and the end note (base, after-odor) essentially comprises fragrances of low volatility, essentially determine the basic character (lead odor) of the perfume.

This thus means that the top note essentially determines the first phase of the scent progression of a perfume or of a product fragranced with the perfume, such as, for example, a detergent. It is attributed the decisive role for the first impression of the smell experience, i.e. for example when opening the detergent pack and when pouring the detergent into the washing machine. The top note should essentially attract attention and interest for the perfume and thus for the product fragranced therewith, which is why it essentially constitutes a mixture of light, volatile substances, although sometimes notes from body and base may also already play a role in the first scent phase. Typical constituents of the top note are, for example, the agrumen oils, fruit notes, lavender, dihydromyrcenol or rose oxide. The person skilled in the art knows a large number of other constituents from daily experience or can find these in the relevant specialist literature.

The second, middle phase of the scent progression of a perfume or of a product fragranced with the perfume, such as, for example, a detergent, is determined by the middle note. This is preferably formed by a mixture of more round, more complex notes which give a perfume fullness, character and a certain direction. It can be characterized, for example, predominantly by floral components such as lily of the valley, jasmine or rose. Additionally, many of the spicy constituents of a perfume such as, for example, eugenol (essential clove fragrance) can be found here. The person skilled in the art knows a large number of further constituents from daily experience or can find these in the relevant specialist literature.

The end note of the perfume (with which, for example, a detergent is fragranced) determines the character of the scent. It adheres for a very long time on the frangranced objects and is essentially composed of heavier, warmer notes. For example, a fine wood base can be combined with isolated odor carriers of other woods and, for example, also with musk fragrances and/or an animalic complex and also predestined end notes such as patchouli and vanilla.

The perfume compositions are generally created on the basis of this generally customary perfume note concept; in this connection, a perfume of complex structure can even consist of several hundred individual components. Experience shows that often only a very well balanced mixture of many constituents (for example at least 15 to 10, in many cases at least 30 or 50 or even more) leads to perfumistic success, i.e. to a pleasant smell. According to a preferred embodiment, the notes of one and the same perfume oil differ with regard to their quantitative weighting, where preferably
(a) the top note is quantitatively more highly weighted than middle note and end note, where the two lower weighted notes can essentially be weighted equally to one another or where one of the lower weighted notes is more highly weighted than the other, or
(b) the middle note is quantitatively more highly weighted than the top note and end note, where the two lower weighted notes can essentially be weighted equally to one another or where one of the lower weighted notes is more highly weighted than the other, or
(c) the end note is quantitatively more highly weighted than top note and middle note, where the two lower weighted notes can essentially be weighted equally to one another or where one of the lower weighted notes is more highly weighted than the other.
   That a note is quantitatively more highly weighted than another means that the total mass of the fragrances forming the more highly weighted note is greater than the total mass of the fragrances forming the lower weighted note, advantageously by at least 10% by weight, preferably at least 20% by weight, in particular at least 30% by weight, based on the total mass of the perfume composition in question in each case.

According to a preferred embodiment, the notes of at least two different perfume oils differ with regard to their quantitative weighting, where preferably
(a) the top note of perfume oil 1 is quantitatively more highly weighted than the top note of perfume oil 2, or vice versa, and/or
(b) the middle note perfume oil 1 is quantitatively more highly weighted than the middle note of perfume oil 2, or vice versa, and/or
(c) the end note of perfume oil 1 is quantitatively more highly weighted than the end note of perfume oil 2, or vice versa.
   That a note is quantitatively more highly weighted than another means here that the total mass of the fragrances of the one perfume oil forming the higher weighted note is greater than the total mass of the fragrances of the other perfume oil forming the lower weighted note, advantageously by at least 10% by weight, preferably at least 20% by weight, in particular at least 30% by weight, based on the particular total mass of the perfume oil in question in each case.

According to another preferred embodiment, all of the notes of the perfume composition are essentially weighted equally.

As has already been emphasized, the present invention allows the person skilled in the art increased room for maneuver when fragrancing products insofar as he is placed in the position of creating products with a totally new type of scent profile. In this connection, it is particularly preferred according to the invention if the perfume oils to be used comprise quite specific scent notes. For this purpose, the product according to the invention can, according to a preferred embodiment, comprise in particular fragrances with a(n)
(a) almond-like odor, such as preferably benzaldehyde, pentanal, heptenal, 5-methylfurfural, methylbutanal, furfural and/or acetophenone or
(b) apple-like odor, such as preferably (S)-(+)-ethyl 2-methylbutanoate, diethyl malonate, ethyl butyrate, geranyl butyrate, geranyl isopentanoate, isobutyl acetate, linalyl isopentanoate, (E)-β-damascone, heptyl 2-methylbutyrate, methyl 3-methylbutanoate, 2-hexenyl pentyl methylbutyrate, ethyl methylbutyrates and/or methyl 2-methylbutanoate or
(c) apple peel-like odor, such as preferably ethyl hexanoate, hexyl butanoate and/or hexyl hexanoate or
(d) apricot-like odor such as preferably γ-undecalactone or
(e) banana-like odor, such as preferably isobutyl acetate, isoamyl acetate, hexenyl acetate and/or pentyl butanoate or
(f) bitter almond-like odor such as preferably 4-acetyltoluene or
(g) blackcurrant-like odor, such as preferably mercaptomethylpentanone and/or methoxymethylbutanethiol or
(h) citrus-like odor such as preferably linalyl pentanoate, heptanal, linalyl isopentanoate dodecanal, linalyl formate, α-p-dimethylstyrene, p-cymenol, nonanal, β-cubebene, (Z)-limonene oxide, cis-6-ethenyltetrahydro-2,2,6-trimethylpyran-3-ol, cis-pyranoid linalool oxide, dihydrolinalool, 6(10) —dihydromyrcenol, dihydromyrcenol, β-farnesene, (Z)-β-farnesene, (Z)-ocimene, (E)-limonene oxide, dihydroterpinyl acetate, (+)-limonene, (epoxymethylbuty)methylfuran and/or p-cymene or
(i) cocoa-like odor such as preferably dimethylpyrazine, butyl methylbutyrate and/or methylbutanal or
(j) coconut-like odor, such as preferably γ-octalactone, γ-nonalactone, methyl laurate, tetradecanol, methyl nonanoate, (3S,3aS,7aR)-3a,4,5,7a-tetra-hydro-3,6-dimethylbenzofuran-2(3H)-one, 5-butyldihydro-4-methyl-2(3H)-furanone, ethyl undecanoate and/or 6-decalactone or
(k) cream-like odor, such as preferably diethyl acetal, 3-hydroxy-2-butanone, 2,3-pentadione and/or 4-heptenal or
(l) flower-like odor such as preferably benzyl alcohol, phenyl acetic acid, tridecanal, p-anisyl alcohol, hexanol, (E,E)-farnesyl acetone, methyl geranate, trans-crotonaldehyde, tetradecylaldehyde, methyl anthranilate, linalool oxide, epoxylinalool, phytol, 10-epiy-eudesmol, nerol oxide, ethyl dihydrocinnamate, γ-dodecalactone, hexadecanol, 4-mercapto-4-methyl-2-pentanol, (Z)-ocimene, cetyl alcohol, nerolidol, ethyl (E)-cinnamate, elemicin, pinocarveol, α-bisabolol, (2R,4R)-tetrahydro-4-methyl-2-(2-methyl-1-propenyl)-2H-pyran, (E)-isoelemicin, methyl 2-methylpropanoate, trimethylphenylbutenone, 2-methylanisole, β-farnesol, (E)-isoeugenol, nitrophenylethane, ethyl vanillate, 6-methoxyeugenol, linalool, p-ionone, trimethylphenylbutenone, ethyl benzoate, phenylethyl benzoate, isoeugenol and/or acetophenones or
(m) fresh odor such as preferably methyl hexanoate, undecanone, (Z)-limonene oxide, benzyl acetate, ethyl hydroxyhexanoate, isopropyl hexanoate, pentadecanal, β-elemene, α-zingiberene, (E)-limonene oxide, (E)-p-mentha-2,8-dien-1-01, methone, piperitone, (E)-3-hexenol and/or carveol or
(n) fruit odor such as preferably ethylphenyl acetate, geranyl valerate, γ-heptalactone, ethyl propionate, diethyl acetal, geranyl butyrate, ethyl heptylate, ethyl octanoate, methyl hexanoate, dimethyl heptenal, pentanone, ethyl 3-methylbutanoate, geranyl isovalerate, isobutyl acetate, ethoxypropanol, methyl-2-butenal, methylnonanedione, linalyl acetate, methyl geranate, limonene oxide, hydrocinnamic alcohol, diethyl succinate, ethyl hexanoate, ethylmethylpyrazine, neryl acetate, citronellyl butyrate, hexyl acetate, nonyl acetate, butyl methylbutyrate, pentenal, isopentyldimethylpyrazine, p-menth-1-en-9-ol, hexadecanone, octyl acetate, γ-dodecalactone, epoxy-β-ionone, ethyl octenoate, ethyl isohexanoate, isobornyl propionate, cedrenol, p-menth-1-en-9-yl acetate, cadinadiene, (Z)-3-hexenyl hexanoate, ethyl cyclohexanoate, 4-methylthio-2-butanone, 3,5-octadienone, methylcyclohexanecarboxylate, 2-pentylthiophene, α-ocimenes, butanediol, ethyl valerate, pentanol, isopiperitone, butyl octanoate, ethyl vanillate, methyl butanoate, 2-methyl butyl acetate, propyl hexanoate, butyl hexanoate, isopropyl butanoate, spathulenol, butanol, δ-dodecalactone, methylquinoxaline, sesquiphellandrene, 2-hexenol, ethyl benzoates, isopropyl benzoate, ethyl lactate and/or citronellyl isobutyrate or
(o) geranium-like odor, such as preferably geraniol, (E,Z)-2,4-nonadienal, octadienone and/or o-xylene or
(p) grape-like odor such as preferably ethyl decanoate and/or hexanone or
(q) grapefruit-like odor such as preferably (+)-5,6-dimethyl-8-isopropenyl-bicyclo[4.4.0]dec-1-en-3-one and/or p-menthenethiol or
(r) grass-like odors such as preferably 2-ethylpyridine, 2,6-dimethylnaph-thalene, hexanal and/or (Z)-3-hexenol or
(s) green note, preferably 2-ethylhexanol, 6-decenal, dimethylheptenal, hexanol, heptanol, methyl-2-butenal, hexyl octanoates, nonanoic acid, undecanone, methyl geranate, isobornyl formates, butanal, octanal, nonanal, epoxy-2-decenal, cis-linalool, pyran oxide, nonanol, alpha, γ-dimethylallyl alcohol, (Z)-2-penten-1-ol, (Z)-3-hexenyl butanoate, isobutyl-thiazole, (E)-2-nonenal, 2-dodecenal, (Z)-4-decenal, 2-octenal, 2-hepten-1-al, bicyclogermacrenes, 2-octenal, α-thujenes, (Z)-β-farnesenes, (−)-γ-elemenes, 2,4-Qctadienal, fucoserratene, hexenyl acetate, geranylacetone, valencenes, β-eudesmol, 1-hexenol, (E)-2-undecenal, artemisia ketone, viridiflorol, 2,6-nonadienal, trimethylphenylbutenone, 2,4-nonadienal, butyl isothiocyanate, 2-pentanol, elemol, 2-hexenal, 3-hexenal, (+)-(E)-limonene oxide, cis-isocitral, dimethyloctadienal, bornyl formate, bornyl isovalerate, isobutyraldehyde, 2,4-hexadienal, trimethylphenylbutenone, nonanone, (E)-2-hexenal, (+)-cis-rose-oxide, menthones, coumarin, (epoxymethylbutyl)methylfuran, 2-hexenol, (E)-2-hexenol and/or carvyl acetate or
(t) green tea-like odor, preferably (−)-cubenol or
(u) herb-like odor, preferably octanone, hexyl octanoate, caryophyllene oxides, methylbutenol, safranal, benzyl benzoate, bornyl butyrate, hexyl acetate, β-bisabolol, piperitol, β-selinenes, α-cubebenes, p-menth-1-en-9-ol, 1,5,9,9-tetramethyl-12-oxabicyclododeca-4,7-diene, T-muurolol, (−)-cubenol, levomenol, ocimenes, α-thujenes, p-menth-1-en-9-yl acetate, dehydrocarveol, artemisia alcohol, γ-muurolenes, hydroxypentanone, (Z)-ocimenes, β-elemenes, δ-cadinol, (E)-β-ocimenes, (Z)-dihydrocarvones, α-cadinol, calamenene, (Z)-piperitol, lavandulol, β-bourbonenes, (Z)-3-hexenyl-2-methylbutanoate, 4-(1-methylethyl)benzenemethanol, artemisia ketone, methyl-2-butanol, heptanol, (E)-dihydrocarvone, p-2-menthen-1-ol, α-curcumenes, spathulenol, sesquiphellandrene, citronellyl valerate, bornyl isovalerate, 1,5-octadien-3-ol, methyl benzoate, 2,3,4,5-tetrahydroanisole and/or hydroxycalamenene or
(v) honey-like odor, preferably ethyl cinnamates, β-phenethyl acetate, phenylacetic acid, phenylethanal, methyl anthranilate, cinnamic acid, β-damascanones, ethyl (E)-cinnamate, 2-phenylethyl alcohol, citronellyl valerates, phenylethyl benzoates and/or eugenol or
(w) hyacinth-like odor, preferably hotrienol or
(x) jasmine-like odor, preferably methyl jasmonate, methyl dihydro-epijasmonate and/or methyl epijasmonate or
(y) lavender-like odor, preferably linalyl valerates and/or linalool or
(z) lemon-like odor, preferably neral, octanal, δ-3-carenes, limonene, geranial, 4-mercapto-4-methyl-2-pentanol, citral, 2,3-dehydro-1,8-cineol and/or α-terpinene or
(aa) lily-like odor, preferably dodecanal or
(bb) magnolia-like odor, preferably geranyl acetone or
(cc) mandarin-like odor, preferably undecanol or
(dd) melon-like odor, preferably dimethylheptenal or
(ee) mint-like odor, preferably menthones, ethyl salicylate, p-anisaldehyde, 2,4,5,7a-tetrahydro-3,6-dimethylbenzofuran, epoxy-p-menthenes, geranial, (methylbutenyl)methylfuran, dihydrocarvyl acetate, β-cyclocitral, 1,8-cineol, β-phellandrenes, methylpentanone, (+)-limonene, dihydrocarveol (−)-carvone, (E)-p-mentha-2,8-dien-1-ol, isopulegyl acetate, piperitone, 2,3-dehydro-1,8-cineol, α-terpineol, D,L-carvone and/or α-phellandrenes or
(ff) nut-like odor, preferably 5-methyl-(E)-2-hepten-4-one, γ-heptalactone, 2-acetylpyrrole, 3-octen-2-one, dihydromethylcyclopentapyrazine, acetylthiazole, 2-octenal, 2,4-heptadienal, 3-octenone, hydroxypentanone, octanol, dimethylpyrazine, methylquinoxaline and/or acetylpyrroline or
(gg) orange-like odor, preferably methyl octanoate, undecanone, decyl alcohol, limonene and/or 2-decenal or
(hh) orangepeel-like odor, preferably decanal and/or β-carenes or
(ii) peach-like odor, preferably γ-nonalactone, (Z)-6-dodecene-γ-lactone, δ-decalactone, R-δ-decenolactone, hexyl hexanoate, 5-octanolide, γ-decalactone and/or δ-undecalactone, or
(jj) peppermint-like odor, preferably methyl salicylate and/or I-menthol or
(kk) pine-like odor, preferably β-p-dimethylstyrene, β-pinenes, bornyl benzoate, δ-terpinene, dihydroterpinyl acetate and/or α-pinene or
(ll) pineapple-like odor, preferably propyl butyrate, propyl propanoate and/or ethyl acetate or
(mm) plum-like odor, preferably benzyl butanoate, or
(nn) raspberry-like odor, preferably β-ionones or
(oo) rose-like odor, preferably β-phenethyl acetate, 2-ethylhexanol, geranyl valerate, geranyl acetate, citronellol, geraniol, geranyl butyrate, geranyl isovalerate, citronellyl butyrate, citronellyl acetate, isogeraniol, tetrahydro-4-methyl-2-(2-methyl-1-propenyl)-2,5-cis-2H-pyran, isogeraniol, 2-phenylethyl alcohol, citronellyl valerate and/or citronellyl isobutyrate, or
(pp) green mint-like odor, preferably carvyl acetates and/or carveol, or
(qq) strawberry-like odor, preferably hexylmethyl butyrate, methyl cinnamate, pentenal, methyl cinnamates or
(rr) sweetish odor, preferably benzyl alcohol, ethylphenyl acetate, tridecanal, nerol, methyl hexanoate, linalyl isovalerate, undecanealdehyde, caryophyllene oxide, linalyl acetate, safranal, uncineol, phenylethanal, p-anisaldehyde, eudesmol, ethylmethylpyrazine, citronellyl butyrate, 4-methyl-3-penten-2-one, nonyl acetate, 10-epi-γ-eudesmol, β-bisabolol, (Z)-6-dodecene-γ-lactone, β-farnesenes, 2-dodecenal, γ-dodecalactone, epoxy-β-ionone, 2-undecenal, styrene glycol, methylfuraneol, (−)-cis-rose oxide, (E)-β-ocimenes, dimethylmethoxyfuranone, 1,8-cineols, ethylbenzaldehyde, 2-pentylthiophene, α-farnesenes, methionol, 7-methoxycoumarin, (Z)-3-hexenyl-2-methylbutanoate, o-aminoaceto-phenone, viridiflorol, isopiperitones, β-sinensal, ethyl vanillate, methyl butanoate, p-methoxystyrene, 6-methoxyeugenol, 4-hexanolide, δ-dodecalactone, sesquiphellandrene, diethyl malate, linalyl butyrate, guaiacol, coumarin, methyl benzoate, isopropyl benzoate, safrols, durenes, γ-butyrolactone, ethyl isobutyrate and/or furfural or
(ss) vanilla-like odor, preferably vanillin, methyl vanillate, acetovanillone and/or ethyl vanillate or
(tt) watermelon-like odor, preferably 2,4-nonadienal or
(uu) wood-like odor, preferably α-muurolenes, cadina-1,4-dien-3-ol, isocaryophyllenes, eudesmol, α-ionone, bornyl butyrate, (E)-α-bergamotene, linalool oxide, ethylpyrazine, 10-epi-γ-eudesmol, germacrenes B, trans-sabinene hydrate, dihydrolinalool, isodihydro-carveol, β-farnesenes, β-sesquiphellandrene, δ-elemenes, α-calacorenes, epoxy-β-ionone, germacrenes D, bicyclogermacrenes, alloaromadendrenes, α-thujenes, oxo-β-ionone, (−)-γ-elemenes, γ-muurolenes, sabinenes, α-gualenes, α-copaenes, γ-cadinenes, nerolidol, β-eudesmol, α-cadinol, δ-cadinenes, 4,5-dimethoxy-6-(2-propenyl)-1,3-benzodioxole, [ar-(1 aalpha,4aalpha,7alpha,7abeta,7balpha)]-decahydro-1,1,7-trimethyl-4-methylene-1H-cycloprop[e]azulene, α-gurjunene, guaiol, α-farnesenes, γ-selinenes, 4-(1-methylethyl)benzenemethanol, perillene, elemol, α-humulenes, β-caryophyllenes and/or β-guaienes or
(vv) mixtures of the above.

The abovementioned fragrances may preferably be present in the perfume oil according to the invention. They are particularly highly suitable for the fragrancing of detergents, cleaners or care compositions or cosmetic compositions.

As the person skilled in the art directly recognizes here, a great diversity of creations can be realized here, for example a detergent according to the layer model with apple-like, orange-like and magnolia-like odor etc.

Within the scope of the present invention, it likewise corresponds to a preferred embodiment if at least one, preferably at least two, advantageously at least three, in particular at least four, of the perfume oils present in each case comprise at least one, preferably at least two, advantageously at least three, in a further advantageous manner at least four, in a still more advantageous manner, at least five, in particular at least six, fragrance alcohols, which are preferably selected from acetovanillone, allyl amyl glycolate, allyl isoamyl glycolate, α-amylcinnamyl alcohol, anisyl alcohol, benzoin, benzyl alcohol, benzyl salicylate, 1-butanol, butyl lactate, 2-t-butyl-5-methylphenol, 2-t-butyl-6-methylphenol, carvacrol, carveol, 4-carvomenthenol, cedrol, cetyl alcohol, cinnamic alcohol, citronellol, o-cresol, m-cresol, p-cresol, crotyl alcohol, decahydro-2-naphthol, 1-decanol, 1-decen-3-ol, 9-decen-1-ol, diethyl malate, diethyl tartrate, dihydrocarveol, dihydromyrcenol, 2,6-diiso-propylphenol, dimethicone copolyol, 2,6-dimethoxyphenol, 1,1-dimethoxy-3,7-dimethyloctan-7-ol, 2,6-dimethyl-4-heptanol, 2,6-dimethylheptan-2-ol, 6,8-dimethyl-2-nonanol, 3,7-dimethyl-2,6-octadien-1-ol, 3,7-dimethyl-1,6-octadien-3-ol, 3,7-dimethyl-1-octanol, 3,7-dimethyl-3-octanol, 3,7-dimethyl-6-octen-1-ol, 3,7-dimethyl-7-octen-1-ol, dimetol, 2-ethylfenchol, 4-ethylguaiacol, 2-ethyl-1-hexanol, ethyl 2-hydroxybenzoate, ethyl 3-hydroxybutyrate, 3-ethyl-2-hydroxy-2-cyclopenten-1-one, ethyl 2-hydroxycaproate, ethyl 3-hydroxyhexanoate, ethyl lactate, ethyl maltol, p-ethylphenol, ethyl salicylate, eugenol, farnesol, fenchyl alcohol, geraniol, glucose pentaacetate, glycerol, glyceryl monostearate, guaiacol, 1-heptanol, 2-heptanol, 3-heptanol, cis-4-heptenol, cis-3-heptenol, n-hexanol, 2-hexanol, 3-hexanol, cis-2-hexenol, cis-3-hexenol, trans-3-hexenol, 4-hexenol, cis-3-hexenylhydrocinnamyl alcohol, 2-hydroxy-benzoate, 2-hydroxyacetophenone, 4-hydroxybenzyl alcohol, 3-hydroxy-2-butanone, hydroxycitronellal, 4-(4-hydroxy-3-methoxyphenyl)-2-butanone, 2-hydroxy-3-methyl-2-cyclopenten-1-one, 4-(p-hydroxyphenyl)-2-butanone, 2-hydroxy-3,5,5-trimethyl-2-cyclohexenone, delta-isoascorbic acid, isoborneol, isoeugenol, isophytol, isopropyl alcohol, p-isopropylbenzyl alcohol, 4-isopropylcyclohexanol, 3-isopropylphenol, 4-isopropylphenol, 2-isopropyl-phenol, isopulegol, lauryl alcohol, linalool, maltol, menthol, 4-methoxybenzyl alcohol, 2-methoxy-4-methylphenol, 2-methoxy-4-propylphenol, 2-methoxy-4-vinylphenol, α-methylbenzyl alcohol, 2-methylbutanol, 3-methyl-2-butanol, 3-methyl-2-buten-1-ol, 2-methyl-3-buten-2-ol, methyl 2,4-dihydroxy-3,6-dimethylbenzoate, 4-methyl-2,6-dimethoxyphenol, methyl N-3,7-dimethyl-7-hydroxyoctylideneanthranilate, methyl 3-hydroxyhexanoate, 6-methyl-5-hepten-2-ol, 2-methylpentanol, 3-methyl-3-pentanol, 2-methyl-4-phenylbutan-2-ol, 2-methyl-3-phenylpropan-2-ol, methyl salicylate, 3-methyl-5-(2,2,3-trimethyl-3-cyclopenten-1-yl)-4-penten-2-ol, 2-methyl-2-vinyl-5-(1-hydroxy-1-methylethyl)-3,4-dihydrofuran, myrtenol, neohesperidin dihydrochalcone, neomenthol, nerol, nerolidol, trans-2-cis-6-nonadienol, 1,3-nonanediol acetate, nonadyl, 2-nonanol, cis-6-nonen-1-ol, trans-2-nonen-1-ol, nonyl alcohol, 1-octanol, 2-octanol, 3-octanol, cis-3-octen-1-ol, cis-2-octen-1-ol, trans-2-octen-1-ol, cis-6-octen-1-ol, cis-octen-1-ol, 1-octen-3-ol, oleyl alcohol, patchouli alcohol, 3-pentanol, n-pentanol, 2-pentanol, 1-penten-1-ol, cis-2-penten-1-ol, perillyl alcohol, 2-phenoxyethanol arabinogalactan, beta-phenylethyl alcohol, phenethyl salicylate, phenol, phenylacetaldehyde glyceryl acetal, 3-phenyl-1-pentanol, 5-phenyl-1-pentanol, 1-phenyl-1-pentanol, 1-phenyl-2-pentanol, 1-phenyl-3-methyl-1-pentanol, phytol, pinacol, polyalkylene glycol, polysorbate 20, polysorbate 60, polysorbate 80, prenol, n-propanol, propenyl guaethol, propylene glycol, 2-propylphenol, 4-propylphenol, resorcinol, retinol, salicylaldehyde, sorbitan monostearate, sorbitol, stearyl alcohol, syringealdehyde, α-terpineol, tetrahydrogeraniol, tetrahydrolinalool, tetrahydromyrcenol, thymol, triethyl citrate, 1,2,6-trihydroxyhexane, p-α,α-trimethylbenzyl alcohol, 2-(5,5,6-trimethylbicyclo[2.2.1]hept-2-ylcyclohexanol, 5-(2,2,3-trimethyl-3-cyclopentenyl)-3-methylpentan-2-ol, 3,7,11-trimethyl-2,6,10-dodecatrien-1-ol, 3,7,11-trimethyl-1,6,10-dodeceatrien-3-ol, 3,5,5-trimethyl-1-hexanol, 10-undecen-1-ol, undecyl alcohol, vanillin, o-vanillin, vanillyl butyl ether, 4-vinylphenol, 2,5-xylenol, 2,6-xylenol, 3,5-xylenol, 2,4-xylenol and/or xylose. In this connection, it is preferred if more than one perfume oil comprises fragrance alcohols, that all perfume oils comprise different fragrance alcohols. Furthermore, it is clearly preferred according to the invention if the product according to the invention comprises at least 1, 2, 3, 4, 5 or 6 or even more of the abovementioned fragrances.

Within the scope of the present invention, it likewise corresponds to a preferred embodiment if at least one, preferably at least two, advantageously at least three, in particular at least four, of the perfume oils present in each case comprise at least one, preferably at least two, advantageously at least three, in a further advantageous manner, at least four, in a still more advantageous manner, at least five, in particular at least six, fragrances with carbonyl function which are preferably selected from 4-acetoxy-3-pentyltetrahydropyran, allyl cinnamate, allyl 2-ethylbutyrate, allyl cyclohexanepropionate, allyl heptanoate, allyl hexanoate, allyl isovalerate, allyl nonanoate, allyl octanoate, allyl phenoxyacetate, allylphenyl acetate, allyl propionate, α-amyl cinnamyl acetate, amyl octanoate, anisyl acetate, anisyl phenyl acetate, benzyl acetate, benzyl acetoacetate, benzyl butyrate, benzyl cinnamate, benzyl isobutyrate, benzyl isovalerate, benzyl phenyl acetate, benzyl propionate, bornyl acetate, bornyl isovalerate, bornyl valerate, butyl acetate, butyl butyrate, butyl butyryl lactate, 4-t-butyl cyclohexylacetate, butyl heptanoate, butyl hexanoate, butyl isobutyrate, butyl isovalerate, butyl laurate, butyl propionate, butyl stearate, 3-butylidenephthalide, butyl 2-methylbutyrate, butyl 10-undecenoate, gamma-butyrolactone, carvyl acetate, carvyl propionate, caryophyllene acetate, cedryl acetate, trans-cinnamyl acetate, trans-cinnamyl butyrate, cinnamyl cinnamate, cinnamyl isobutyrate, citronellyl acetate, citronellyl butyrate, citronellyl isobutyrate, citronellyl propionate, citronellyl valerate, cyclohexane ethyl acetate, cyclohexyl acetate, cyclohexyl butyrate, cyclohexyl isovalerate, cyclohexyl propionate, delta-decalactone, epsilon-decalactone, gamma-decalactone, 4-decanolide, decyl acetate, decyl butyrate, decyl propionate, diethyl malonate, diethyl sebacate, diethyl succinate, dihydrocarvyl acetate, dihydrocoumarin, dihydromyrcenyl acetate, dihydronordicyclopentadienyl acetate, dihydroterpinyl acetate, 3,7-dimethyl-1,6-octadien-3-yl acetate, 3,7-dimethyl-1,6-octadien-3-yl propionate, 3,7-dimethyloctan-3-yl acetate, α,α-dimethylphenethyl acetate, α,α-dimethyl-phenethyl butyrate, 6,10-dimethyl-5,9-undecadien-2-yl acetate, delta-dodecalactone, epsilon-dodecalactone, gamma-dodecalactone, ethyl acetate, ethyl acetoacetate, ethyl 6-acetoxyhexanoate, ethyl 2-acetyl-3-phenyl-propionate, ethyl benzoylacetate, 2-ethylbutyl acetate, ethyl butyrate, ethyl cinnamate, ethyl cyclohexanepropionate, ethyl decanoate, ethylene brassylate, ethyl 2-ethyl-6,6-dimethyl-2-cyclohexenecarboxylate, ethyl 2,3-epoxybutyrate, ethyl 2-methyl-4-petenoate, ethyl heptanoate, ethyl hexanoate, ethyl trans-3-hexenoate, 2-ethylhexyl acetate, ethyl isobutyrate, ethyl isovalerate, ethyl laurate, ethyl 2-mercaptopropionate, ethyl 3-mercapto-propionate, ethyl 2-methylbutyrate, ethyl 2-methylpentanoate, ethyl (methylthio)acetate, methyl (methylthio)acetate, methyl 2-(methylthio)-propionate, ethyl myristate, ethyl nonanoate, ethyl octanoate, ethyl palmitate, ethyl phenylacetate, ethyl 3-phenylpropionate, ethyl 3-phenyl-2,3-epoxybutyrate, ethyl 3-phenylpropionate, ethyl propionate, ethyl stearate, ethyl 2,3,6,6-tetramethyl-2-cyclohexenecarboxylate, ethyl (p-tolyloxy)acetate, ethyl undecanoate, ethyl valerate, eugenyl acetate, fenchyl acetate, geranyl acetate, geranyl butyrate, geranyl phenylacetate, geranyl propionate, guaiacyl phenylacetate, guaic wood acetate, gamma-heptalactone, heptyl acetate, heptyl butyrate, heptyl isobutyrate, omega-6-hexadecenelactone, delta-hexylactone, gamma-hexylactone, 3-hexenyl acetate, cis-3-hexenyl 2-methyl-butanoate, cis-3-hexenyl cis-3-hexanoate, cis-3-hexenyl phenylacetate, trans-2-hexenyl acetate, hexyl acetate, hexyl butyrate, hexyl hexanoate, hexyl isobutyrate, hexyl propionate, hexyl 2-methylbutanoate, hexyl 3-methyl-butanoate, hexyl phenylacetate, isoamyl acetate, isoamyl acetoacetate, isoamyl butyrate, isoamyl cinnamate, isoamyl hexanoate, isoamyl isobutyrate, isoamyl isovalerate, isoamyl laurate, isoamyl nonanoate, isoamyl octanoate, isoamyl phenylacetate, isoamyl propionate, isobornyl acetate, isobornyl propionate, isobutyl acetate, isobutyl butyrate, isobutyl cinnamate, isobutyl hexanoate, isobutyl isobutyrate, isobutyl 2-methylbutyrate, isobutyl propionate, isoeugenyl acetate, isopropyl cinnamate, isobutyl phenylacetate, isopropyl acetate, isopropyl butyrate, isopropyl isobutyrate, isopropyl myristate, isopropyl palmitate, isopropyl phenylacetate, lauryl acetate, linanyl acetate, linanyl butyrate, linanyl isovalerate, menthalactone, menthyl acetate, menthyl cyclohexanecarboxylate, menthyl isovalerate, 4-methoxybenzyl acetate, 4-methoxybenzyl propionate, 2-methoxyphenyl acetate, 2-methoxy-4-(1-propenyl)phenyl acetate, methyl acetate, α-methylbenzyl acetate, α-methyl-benzyl butyrate, α-methylbenzyl propionate, 2-methylbutyl acetate, 2-methyl-butyl butyrate, 2-methylbutyl isovalerate, 3-methylbutyl 2-methylbutanoate, 2-methylbutyl 2-methylbutanoate, methyl p-t-butylphenyl acetate, methyl butyrate, methyl cinnamate, methyl decanoate, methyl heptanoate, methyl hexanoate, methyl isobutyrate, methyl isovalerate, methyl laurate, methyl N-2-methyl-3-(4-t-butylphenylpropylidene)anthranilate, methyl myristate, methyl nonanoate, methyl octanoate, methyl palmitate, 4-(4-methyl-3-pentenyl)-3-cyclohexenylmethyl acetate, methyl 2-methylbutyrate, 2-methyl-6-methylene-7-octen-2-yl acetate, methyl 4-methylvalerate, methyl 2-methylpentanoate, methyl phenoxyacetate, 2-methyl-3-phenylpropan-2-yl acetate, methyl 3-phenylpropionate, methyl propionate, 2-methylpropylphenyl acetate, methylphenyl acetate, 2-methyl-3-phenylpropan-2-yl acetate, methyl stearate, methyl (p-tolyloxy)acetate, methyl 9-undecenoate, methyl valerate, myrtenyl acetate, neryl acetate, neryl butyrate, neryl isobutyrate, delta-nonalactone, gamma-nonalactone, 1,3-nonanediol diacetate, nonyl acetate, octahydro-coumarin, gamma-octalactone, 1-octen-3-yl acetate, 1-octen-3-yl butyrate, octyl acetate, octyl butyrate, octyl isobutyrate, octyl isovalerate, octyl octanoate, octyl propionate, oxacycloheptadec-10-en-2-one, omega-penta-decalactone, pentyl acetate, pentyl butyrate, pentyl hexanoate, pentyl octanoate, phenethyl acetate, phenethyl butyrate, phenethyl cinnamate, phenethyl hexanoate, phenethyl isobutyrate, phenethyl isovalerate, phenethyl 2-methylbutyrate, phenethyl 2-methylbutyrate, phenethyl 2-methylpropionate, phenethyl octanoate, phenethyl phenylacetate, phenethyl propionate, phenoxyethyl propionate, 2-phenoxyethyl 2-methylpropionate, 3-phenyl-2-propenyl propionate, 3-phenylpropyl acetate, 2-phenylpropyl butyrate, 2-phenylpropyl isobutyrate, 2-phenylpropyl isovalerate, piperonyl acetate, piperonyl isobutyrate, prenyl acetate, propyl acetate, propyl butyrate, propyl heptanoate, propyl hexanoate, 3-propylidenephthalide, propyl isobutyrate, propyl propionate, propyl phenylacetate, sucrose octaacetate, terpinyl acetate, terpinyl butyrate, terpinyl isobutyrate, terpinyl propionate, tetrahydrofurfuryl acetate, tetrahydrofurfuryl butyrate, tetrahydrofurfuryl propionate, tetrahydro-linalyl acetate, 2,6,6,8-tetramethyltricyclo[5.3.1.0(1.5)]udecan-8-yl acetate, p-tolyl acetate, p-tolyl isobutyrate, p-tolyl phenylacetate, triacetin, tributyl acetyl citrate, tributyrin, tripropionine, 3,5,5-trimethylhexyl acetate, 6-undecalactone, gamma-undecalactone, gamma-valerolactone, vanillin acetate, vanillyl isobutyrate, 1-vinyl-2-(1-methylpropyl)cyclohexyl acetate, whiskeylactone, butyraldehyde, citronellal, decanal, cis-4-decenal, trans-4-decenal, 2,4-dimethyl-3-cyclohexene-1-carbaldehyde, 2,6-dimethyl-5-heptenal, 3,7-dimethyloctanal, 2-ethylbutyraldehyde, glutaric dialdehyde, heptanal, cis-4-heptenal, hexanal, hydrocinnamaldehyde, isobutyraldehyde, 3-(p-isopropyl-phenyl)propionaldehyde, isovaleraldehyde, lauricaldehyde, 2-methyl-butyraldehyde, 2-methyl-3-(p-isopropylphenyl)propionaldehyde, 2-methyl-pentanal, 4-(4-methyl-3-pentenyl)-3-cyclohexene-1-carbaldehyde, 4-methyl-phenylacetaldehyde, 3-(methylthio)butanal, 2-methyl-4-(2,6,6-trimethyl-2-cyclohexen-1-yl)butanal, 2-methylundecanal, nonanal, cis-6-nonenal, octanal, phenylacetaldehyde, 2-phenylpropionaldehyde, 3-phenylpropionaldehyde, propionaldehyde, p-tolylacetaldehyde, tridecanal, 2,4,6-trimethyl-3-cyclohexene-1-carbaldehyde, 2,6,10-trimethyl-9-undecanal, 7-undecenal, 8-undecenal, 9-undecenal, 10-undecenal, valeraldehyde, acetanisole, 1′-acetonaphthone, 2′-acetonaphthone, acetone, acetophenone, 2-acetoxy-2,5-dimethyl-3(2H)furanone, 2-acetylcyclopentanone, 4-acetyl-1,1-dimethyl-6-t-butylindane, 7-acetyl-1,1,3,4,4,6-hexamethylindane, 2-acetyl-2-thizoline, 6-acetyl-1,1,2,4,4,7-hexamethyltetralin, allyl-α-ionone, benzylideneacetone, 2,3-butanedione, 2-sec-butylcyclohexanone, 5-t-butyl-3,5-dinitro-2,6-dimethyl-acetophenone, butyrophenone, camphor, 2-decanone, 3-decanone, 3-decen-2-one, dihycrocarvone, dihydro-beta-ionone, dihydrojasmone, 4,5-dihydro-3(2H)-thiophenone, 2′,4′-dimethylacetophenone, 3,4-dimethyl-1,2-cyclopenta-dione, 3,5-dimethyl-1,2-cyclopentadione, 2,6-dimethyl-4-heptanone, 1,3-diphenyl-2-propanone, 4-(1-ethoxyvinyl)-3,3,5,5-tetramethylcyclohexanone, p-ethylacetophenone, ethyl vinyl ketone, geranyl acetone, 2,3-heptanedione, 2-heptanone, 3-heptanone, 4-heptanone, 3,4-hexanedione, 3-hexanone, 4-hexen-3-one, 2-hexylidenecyclopentanone, α-ionone, beta-ionone, 4-iso-butyl-2,6-dimethyl-3,5-d initroacetophenone, isophorone, 6-isopropyldeca-hydro-2-naphthone, cis-jasmone, livescone, 4-methoxyacetophenone, 4-(p-methoxyphenyl)-2-butanone, 4′-methylacetophenone, 3-methyl-1,2-cyclo-hexanedione, 3-methyl-2-cyclohexen-1-one, 2-(2-(4-methyl-3-cyclohexen-1-yl)propyl)cyclopentanone, 3-methyl-2-cyclopenten-1-one, methyl dihydro-jasmonate, methyl ethyl ketone, 2-methyl-3-heptanone, 5-methyl-2-hepten-4-one, 6-methyl-5-hepten-2-one, 5-methyl-α-ionone, 1-(2-methyl-5-isopropyl-2-cyclohexenyl)-1-propanone, 4-methyl-2-pentanone, 3-methyl-2-(2-pentenyl)-2-cyclopenten-1-one, 4-methyl-1-phenyl-2-pentanone, 2-methyltetrahydrofuran-3-one, 2-methyltetrahydrothiophen-3-one, 2-nonanone, 3-nonanone, 2-octanone, 3-octanone, 1-octen-3-one, 3-octen-2-one, 4-oxoisophorone, 2-pentadecanone, 2,3-pentanedione, 2-pentanone, 3-pentanone, 3-penten-2-one, 1-phenyl-1,2-propanedione, propiophenone, pulegon, 2-tridecanone, 2,2,6-trimethylcyclohexanone, 4-(2,6,6-trimethyl-2-cyclohexen-1-yl)-3-methyl-3-buten-2-one, 2-undecanone, and 6-undecanone. Furthermore, according to the invention it is clearly preferred if the product according to the invention comprises at least 1, 2, 3, 4, 5 or 6 or even more of the above-mentioned fragrances.

In a preferred embodiment, the product comprises certain minimum values of perfume oil, namely at least 0.05% by weight, advantageously at least 0.1% by weight, in considerably advantageous manner at least 0.15% by weight, in more advantageous manner at least 0.2% by weight, in further advantageous manner at least 0.25% by weight, in still further advantageous manner at least 0.3% by weight, in very advantageous manner at least 0.35% by weight, in particularly advantageous manner at least 0.4% by weight, in very particular advantageous manner at least 0.45% by weight, in considerably advantageous manner at least 0.5% by weight, in very considerably advantageous manner at least 0.55% by weight, in extremely advantageous manner at least 0.6% by weight, in highly advantageous manner at least 0.65% by weight, in extremely advantageous manner at least 0.7% by weight, in exceptionally advantageous manner at least 0.75% by weight, in extraordinarily advantageous manner at least 0.8% by weight, in exceedingly advantageous manner at least 0.85% by weight, in particular at least 0.9% by weight, of perfume oil, based on the total product.

In a preferred embodiment, however, the product comprises relatively large amounts of perfume oil, namely at least 1% by weight, advantageously at least 2% by weight, in considerably advantageous manner at least 5% by weight, in more advantageous manner at least 10% by weight, in further advantageous manner at least 13% by weight, in still further advantageous manner at least 14% by weight, in very advantageous manner at least 15% by weight, in particularly advantageous manner at least 16% by weight, in very particularly advantageous manner at least 17% by weight, in considerably advantageous manner at least 18% by weight, in very considerably advantageous manner at least 19% by weight, in particular at least 20% by weight, of perfume oil, based on the total product. Such products may be, for example, so-called aroma shower gels.

However, it is rather unusual to realize very high perfume oil contents in consumer products in order to prevent the product being too overpowering. Rather, it is often desired for the amount of perfume oil present to be limited. In a preferred embodiment, the product therefore comprises certain maximum values of perfume oil, namely not more than 15% by weight, advantageously not more than 10% by weight, in considerably advantageous manner not more than 9% by weight, in more advantageous manner not more than 8% by weight, in further advantageous manner not more than 7% by weight, in yet further advantageous manner not more than 6% by weight, in very advantageous manner not more than 5% by weight, in particularly advantageous manner not more than 4.5% by weight, in very particularly advantageous manner not more than 4% by weight, in considerably advantageous manner not more than 3.5% by weight, in particular not more than 3% by weight, of perfume oil, based on the total product.

It may also be advantageous to match the amounts of the different perfume oils present to one another. Thus, according to a preferred embodiment which comprises two different perfume oils, the ratio of perfume oil 1 to perfume oil 2 is more than 1/1, but less than 6/1, preferably less than 5/1, advantageously less than 4/1, in further advantageous manner less than 3/1, in yet further advantageous manner less than 2/1, in particular less than 3/2.

In a preferred embodiment, the perfume oils comprise fewer than 8, advantageously fewer than 7, in more advantageous manner fewer than 6, in again advantageous manner fewer than 5, in further advantageous manner fewer than 4, even more advantageously fewer than 3, preferably fewer than 2, in particular no, fragrances from the list amylcinnamal, amylcinnamyl alcohol, benzyl alcohol, benzyl salicylate, cinnamyl alcohol, cinnamyl, citral, coumarin, eugenol, geraniol, hydroxycitronellal, hydroxymethylpentylcyclo-hexenecarboxaldehyde, isoeugenol, anisyl alcohol, benzyl benzoate, benzyl cinnamate, citronellol, farnesol, hexylcinnamaldehyde, lilial, d-limonene, linalool, methyl heptynecarbonate, 3-methyl-4-(2,6,6-trimethyl-2-cyclohexen-1-yl)-3-buten-2-one, oak moss extract, tree moss extract.

According to general dermatological findings, it is certainly true, especially for detergents or cleaners, which are preferred compositions according to the invention, that the application concentrations barely comprise the amount of fragrance which could trigger a skin allergy, but it may also be desired to instead avoid certain substances to which an allergenic potential is ascribed, where possible by a third party.

Preferred products for the purposes of the invention are detergents or cleaners, cosmetic compositions, adhesives, sealants, coatings and air fresheners.

Preferred products for the purposes of the invention are also the so-called washing auxiliaries. These include, in particular:
(a) spot treatments, such as, for example, grease removers. These serve primarily for the (pre)treatment of local grease and/or pigment soilings and are applied directly to the textiles.
(b) soaking agents. These are mostly more alkaline auxiliaries (up to about pH 13) with a lower surfactant content. They favor swelling processes in the case of soilings and lower the soil adhesion.
(c) separate bleaches, such as stain removal salts, liquid bleaches, detergency enhancers. They can either be used as detergent additive or as pretreatment.
(d) separate softeners, preferably comprising builders, such as, for example, citrates and/or zeolites, and dispersants, such as, for example, polycarboxylates.
(e) separate discoloration inhibitors,
(f) special stain removers for individual type of stain.
   Preferred products for the purposes of the invention are also aftertreatment compositions. These include, in particular:
(a) fabric softeners, also called hand modifiers or fabric conditioners, and also corresponding wipes for dryer application
(b) laundry strips which have the effect of giving the laundry a stiff and full shape
(c) shape rinses, which have the effect that textiles treated therewith are strengthened in the fiber structure, thus giving the laundry a gentle stiffened feel to substantial starch feel
(d) hygiene rinses, which are preferably added to the last rinse cycle and comprise an antimicrobial active ingredient and preferably nonionic surfactants
(e) ironing aids, which are, for example, sprayed on and have a fiber-smoothing effect, even without ironing, to a certain extent if, for example after spraying, the still damp laundry is stretched by hand
(f) (net) whiteners which have the purpose of increasing the degree of whiteness (of nets) and optionally have a fiber-strengthening effect
(g) care rinses, which equip the textile during textile treatment (e.g. machine washing) with active ingredients (e.g. oils) which, upon wearing the textile, can be released onto the human skin and be advantageous to the skin and/or care for it
(h) ironing waters which comprise low-mineral or completely demineralized water, preferably preservatives and fragrances, for use in steam irons
(i) textile fresheners, i.e. products which remove odors from many textile materials, e.g. via encapsulation of the odors to be removed with the help of suitable agents, such as, for example, cyclodextrins, or else via other active ingredients, such as, for example, zinc ricinoleate.

However, particular preference is given to those textile treatment compositions, such as, for example, detergents or fabric softeners, in liquid and in solid form. Preferred products for the purposes of the invention are therefore detergents. These include in particular:
(a) standard detergents (comprises preferably bleaches, optical brighteners, enzymes etc.)
(b) color detergents (essentially free from bleaches and optical brighteners, preferably comprising discoloration inhibitors, celluloses etc.)
(c) light-duty detergents (essentially free from bleaches and optical brighteners, preferably of lower alkalinity),
(d) special detergents, such as, for example, in particular
   i) wool detergents (preferably free from bleaches, optical brighteners, enzymes, preferably pH neutral)
   ii) net detergents,
   iii) detergents for hand washing,
   iv) detergents with additional benefits, such as preferably
      detergents with odor absorber,
      UV protection detergents
      hygiene detergents
      easy-iron detergents,
      special detergents for black or white laundry,
      sensitive detergents, preferably comprising care substances, such as, for example, almond oil, aloe vera extract etc.
      scent-intensive or aroma detergents.

Preferred cleaners include, in particular, hand dishwashing detergents and machine dishwashing detergents.

Preferred cleaners include, inter alia, toilet cleaners or WC cleaners, i.e. products for cleaning toilet bowls and urinals, which are preferably supplied as powders, tablets, shaped bodies or liquids, preferably gels. Besides other customary ingredients such as surfactants, they mostly comprise organic acids (e.g. citric acid and/or lactic acid) or sodium hydrogensulfate, amidosulfuric acid or phosphoric acid for removing lime deposits or so-called urine scale.

Preferred cleaners include, inter alia, also pipe cleaning compositions or drain cleaners. These are preferably strongly alkaline preparations which usually serve to eliminate pipe blockages of organic materials—such as hair, grease, food residues, soap deposits etc. Additives of Al or Zn powder can serve to form H₂ gas with effervescent effect. Possible ingredients are generally alkalis, alkaline salts, oxidizing agents and neutral salts. In pulverulent supply forms, sodium nitrate and sodium chloride are also preferably present. Pipe cleaning compositions in liquid form can preferably also comprise hypochlorite. There are also drain cleaners based on enzymes. Acidic preparations are likewise possible.

Preferred cleaners also include, inter alia, universal or all-purpose cleaners. These are cleaners that can be universally used for all hard surfaces for domestic and commercial use which can be wiped off wet or damp. As a rule, these are neutral or weakly alkaline or weakly acidic products, in particular liquid products. All-purpose cleaners generally comprise surfactants, builders, solvents and hydrotropes, dyes, preservatives etc.

There are also specifically disinfectant all-purpose cleaners. These additionally comprise antimicrobial active ingredients (e.g. aldehydes, alcohols, quaternary ammonium compounds, amphoteric surfactants, triclosan).

Preferred cleaners include, inter alia, also sanitary cleaners. These are products for cleaning in the bathroom and toilet. The alkaline sanitary cleaners are preferably used for removing grease soiling, whereas the acidic sanitary cleaners are used primarily for removing limescale deposits. Sanitary cleaners advantageously also have a considerable disinfectant effect, in particular the strongly alkaline, chlorine-containing sanitary cleaners.

Preferred cleaners include, inter alia, also oven cleaners and grill cleaners, which are advantageously supplied in the form of gels or foam sprays. These generally serve to remove burnt-on or carbonized food residues. Preferably, oven cleaners are rendered strongly alkaline, for example, with sodium hydroxide, sodium metasilicate, 2-aminoethanol. Furthermore, they usually comprise anionic and/or nonionic surfactants, water-soluble solvents and sometimes thickeners, such as polycarboxylates, carboxymethylcellulose.

Preferred cleaners include, inter alia, also metal cleaners. These are cleaners for certain types of metal such as stainless steel or silver. Besides acids (preferably up to 3% by weight, e.g. citric acid, lactic acid), surfactants (in particular up to 5% by weight, preferably nonionic and/or anionic surfactants), water, stainless steel cleaners preferably also comprise solvents (preferably up to 15% by weight) for removing grease-containing soilings and further substances, such as, for example, thickeners and preservatives. Very fine polishing bodies are also contained in products for preferably shiny stainless steel surfaces. Silver cleaners in turn are preferably rendered acidic. They preferably comprise complexing agents (e.g. thiourea, sodium thiosulfate) in particular for removing black deposits of silver sulfide. Typical supply forms are cleaning wipes, immersion baths, pastes, liquids. Copper and nonferrous cleaners (e.g. for brass and bronze) serve to remove dark discolorations (oxide layers). These are generally rendered weakly alkaline (preferably with ammonia) and generally comprise polishing agents and preferably also ammonium soaps and/or complexing agents.

Preferred cleaners also include, inter alia, glass cleaners and window cleaners. These serve preferably to remove in particular grease-containing soiling from glass surfaces. They preferably include substances such as anionic and/or nonionic surfactants (in particular up to 5% by weight) ammonia and/or ethanolamine (in particular up to 1% by weight), ethanol and/or 2-propanol, glycol ethers (in particular 10-30% by weight), water, preservatives, dyes, antimisting agents etc.

Preferred cleaners also include, inter alia, all special cleaners, e.g. those for hobs made of glass ceramic, and also carpet and upholstery cleaners and stain removers.

Products preferred according to the invention are car care products. Preferred car care products include, inter alia, paint preservers, paint polishes, paint cleaners, wash preservers, shampoos for carwashes, car washing and wax products, polishes for decorative metals, protective films for decorative metals, plastic cleaners, tar removers, window cleaners, engine cleaners, etc.

Adhesives or sealants, preferably also in the form of films, bands or sticks, can advantageously also be counted among the compositions according to the invention, as can advantageously coatings, likewise advantageously solvent-containing liquids (single-phase or multiphase).

Preferred cosmetic compositions are preferably
(a) cosmetic compositions for skin care, in particular bath preparations, skin washing and cleaning compositions, skincare compositions, eye cosmetics, lipcare compositions, nailcare compositions, personal hygiene compositions, footcare compositions
(b) cosmetic compositions with a special effect, in particular photoprotective compositions, skin tanning compositions, depigmentation compositions, deodorants, antihydrotics, hair removal compositions, shaving compositions, scent compositions
(c) cosmetic compositions for dental care, in particular dental and oral care compositions, denture care compositions, dental prosthesis cleaners, dental prosthesis adhesives,
(d) cosmetic compositions for hair care, in particular hair washing compositions, haircare compositions, hair setting compositions, hair shaping compositions, hair colorants.

Preferred ingredients of the consumer products according to the invention, in particular of the cosmetic compositions, can be defined by their function. Some ingredients may of course also be multifunctional. Preferred ingredients of the consumer products according to the invention, preferably cosmetic products may be:

### a) Absorbents

These preferably have the task of absorbing water-soluble and/or oil-soluble dissolved or finely divided substances.

### b) Antimicrobial Substances

These can be added to the products in order, quite generally, to reduce the activity of microorganisms, e.g. on the skin and in the oral cavity.

### c) Antioxidants

These are intended to serve to prevent reactions triggered by oxygen, such as oxidation, and thus to extend the shelf life of the products, i.e. retain the quality of the products.

### d) Antiperspirants

These are preferably used in cosmetics and reduce the release of perspiration.

### e) Antifoams

These can be added, for example, to eliminate foam during production or in order to reduce the tendency of the finished products toward excessive foam formation.

### f) Antidandruff Active Ingredients

These are primarily used in haircare products since they can counteract the formation of dandruff.

### g) Antistats

These are, for example, combability aids in haircare products. They generally reduce the electrostatic charging of objects, for example of the surface of the hair. Hair can thus be combed significantly more easily.

### h) Binders

They ensure, for example, the cohesion of pulverulent products, such as, for example, cosmetic preparations.

### i) Substances of Biological Origin

These are, for example, certain plant ingredients, e.g. green tea extract. They are intended to impart to a product certain desired properties which are related to the corresponding biological material, or else further improve existing properties or suppress undesired properties or reduce them as far as possible.

### j) Bleaches

These can, for example, serve to lighten the shade of hair or of skin.

### k) Chelating Agents

These are added, for example, to cosmetic compositions so that they form complexes with metal ions in order, in so doing, for example, to manipulate the stability and/or the appearance of the compositions

### l) Deodorants/Antiperspirants

These can contribute to preventing or reducing the formation of unpleasant body odors. They can conceal such odors and in some cases reduce the formation of perspiration

### m) Emollients

In the cosmetic sector these have, for example, the task of making the skin supple and of smoothing it.

### n) Emulsifiers

These are surface-active substances which are preferably able to stably distribute immiscible liquids such as oil and water in one another.
o) Emulsion stabilizers
These can yet further assist the process of emulsification (cf. emulsifiers) and, in so doing, further improve the stability and shelf life of the product.

### p) Hair Removers

These serve for the preferably selective removal of body hair.

### q) Moisturizers

These can contribute to retaining or restoring skin moisture and counteract the drying out of the skin.

### r) Film Formers

These are able, for example in cosmetic compositions, to produce a protective, stabilizing film on surfaces, preferably skin, hair or nails

### s) Dyes

These are added, for example, also to cosmetic products in order to produce a product coloration or else also to bring about indirect object coloration, e.g. hair coloring

### t) Preservatives

These are added, for example, to cosmetic compositions in order to protect them from the harmful effect of microorganisms (bacteria, fungi, yeasts) and thus to avoid their decay.

### u) Corrosion Inhibitors

These can serve, for example, to prevent the corrosion of the packaging of, for example, a cosmetic composition, or else also the corrosion of parts which otherwise come into contact with the composition.

### v) Solvents

They can, for example, be the basis of, for example, liquid cosmetic preparations, or else be used as constituent of solid products.

### w) Oral Care Substances

These can serve for the care of teeth and gums.

### x) Oxidizing Agents

These can serve to alter the chemical nature of another substance through oxidation.

### y) pH Regulators/Buffer Substances

In cosmetics, for example, these can serve to establish and/or to stabilize a desired pH

### z) Reducing Agents

These are able to alter the chemical nature of another substance through redox processes.

### aa) Abrasives

These can serve to remove materials from various (body) surfaces, for example in order to assist mechanical tooth cleaning or to improve tooth shine.

### bb) Surfactants/Washing-Active Substances

These are interface-active compounds which serve for cleaning purposes.

### cc) Propellant Gases

These are gaseous substances with which products, for example cosmetic compositions, can be placed under pressure into pressure-resistant containers in order then to dispense the contents upon decompression.

### dd) Opacifiers

These can preferably be added to transparent or translucent products in order to make them impermeable for visible light or light-near radiation.
ee) UV absorber/photofilter substances
These are able to filter certain UV rays and can, in so doing, protect, for example, the skin against premature, photoinduced aging and against sunburn.

### ff) Denaturants

These are added, for example, to cosmetic compositions which comprise ethanol in order to make them unpalatable.

### gg) Viscosity Regulators

These are able to increase and also to reduce the viscidity of a product.

According to a preferred embodiment, the above-mentioned ingredients may be present in the products according to the invention, preferably cosmetic compositions.

According to the invention, it may be of great advantage if certain fragrances are present in the products, preferably in certain products.

It corresponds to a preferred embodiment if the products according to the invention comprise at least one fragrance, preferably 2, 3 or more fragrances, from the list galaxolide, dihydromyrcenol, 4-tert-butyl cyclohexylacetate, gamma-iso-methylionone, tetrahydrolinalool, hexylcinnamaldehyde, lilial, linalool, amylcinnamaldehyde, 6-methyl-gamma-ionone, methyl oleate, neryl acetate, 15-pentadecalactone, phenoxyethyl isobutyrate, phenylethyl methanoate, a-pinenes, b-pinenes, rose oxides, sabinenes, anethole, 2-hydroxypentyl benzoate, diphenyl ether, benzophenone, cyclamenaldehyde, a-damascone, decanal, dicyclopentadiene alcohol, allyl cyclohexylpropionate, isobornyl acetate, bornyl acetate, dihydro-methyl jasmonate, eucalyptol, n-dodecanol, ethyl palmitate, geraniol acetate, hexyl acetate, n-hexyl salicylate, a-ionone, 1-limonene, methyl palmitate, 2-naphthyl methyl ketone, isopropyl myristate, rosephenone, a-terpineol, styrallyl acetate, thujopsene, dimethyl benzylcarbinyl butyrate, d-limonene, dimethyl benzylcarbinyl acetate, citronellol, 2-tert-butylcyclohexanol, caryophyllenes, ethyl stearate, tonalide, 2,4-hexadienal, methanoazulene, methyl laurate, methyl myristate, 2-methylundecanal, myrcenes, nonanal, nopyl acetate, 15-pentadecalactone, beta-phellandrenes, 3-phenyl-2-methylpropene, rose acetate, traseolides, widdrenes and/or d-limonene.

The fragrances here are most preferably methyl oleate, methyl palmitate, methyl laurate, eucalyptol, dihydromethyl jasmonate, dimethyl benzylcarbinyl acetate, diphenyl ether, hexylcinnamaldehyde, lilial, linalool, methyl oleate, methyl myristate, d-limonene, dihydromyrcenol, 4-tert-butylcyclohexyl acetate, a-damascone, a-terpineol, tonalide, galaxolide, dodecanol, isopropyl myristate, gamma-isomethylionone, isobornyl acetate, bornyl acetate, 6-methyl-gamma-ionone and/or tetrahydrolinalool.

The fragrance dihydromyrcenol is extraordinarily preferred particularly in solid, preferably pulverulent products, especially in detergents and machine dishwashing detergents. The fragrance d-limonene may be preferred particularly in liquid, preferably gel-like, products, especially in cleaners.
The above embodiment is specifically then very highly preferred if the products according to the invention are detergents or cleaners.

It corresponds to a preferred embodiment if the products according to the invention have at least one fragrance, preferably 2, 3 or more fragrances, from the list bergamot oil, dihydromyrcenol, tangerine oil, dimethyl anthranilate, aldehyde c 11.(en), allyl amyl glycolate, cyclovertal, calone, styrolyl acetate, ethyllinanool, isobornyl acetate, eucalyptus oil (globulus), aldehyde C 12, dynascone 10, limonene, orange oil, cyclovertal, ethyl 2-methylbutyrate, tetrahydrolinalool, undecavertol, aldehyde c 10, styrolyl acetate, Otbca, waterfruit base, citronitrile, such fragrances are particularly advantageous for aiding the scent impression “freshness”.

It corresponds to a preferred embodiment if the products according to the invention comprise at least one fragrance, preferably 2, 3 or more fragrances, from the list aldehyde C 14, decalactone gamma, cyclamenaldehyde, lilial, troenan, canthoxal, citronellol, geraniol, phenylethyl alcohol, dihydrofloriffones, Dmbca, phenirate, phenylethyl isobutyrate, rose oxide, jasmelia, hexylcinnamaldehyde (alpha), ionone beta, ylang, cyclohexyl salicylate, hexenyl salicylate (cis-3), sandelice, santobar, bacdanol, guaiac wood oil, iso E super, timberol (forte), norlimbanol, ambroxan, cinnamyl alcohol, cyclopentadecanolide, nirvanol, javanol, aldehyde C 11, habanolide, maltol, benzylacetone, coumarin, benzyl salicylate, melonal, galbanum (oil), ethylvanillin, koavones, Ptbca 25 cis, hedione, lilial, dihydrofloriffones, isoraldein, such fragrances are particularly advantageous in order to assist the scent impression “care”. Perfume oils which comprise such fragrances with care impression are preferably applied to bentonite-containing carrier material. It may be particularly advantageous if fragrances which, as just stated above, aid the scent impression “freshness”, are combined with those which, as just stated above, assist the scent impression “care”.

Particularly preferred products are also air fresheners. Such products comprise volatile and in most cases pleasantly smelling substances which, advantageously even in very small amounts, can conceal nasty odors. Air fresheners for living spaces comprise in particular natural and synthetic essential oils, such as conifer needle oils, citrus oils, eucalyptus oil, lavender oil etc., for example in amounts up to 50% by weight. As aerosols, they comprise rather smaller amounts of such essential oils, for example less than 5% by weight or less than 2% by weight, instead preferably still substances such as acetaldehyde (in particular <0.5% by weight), isopropyl alcohol (in particular <5% by weight), mineral oil (in particular <5% by weight) and propellant gases. Other administration forms are sticks and blocks. For their production, a gel concentrate of essential oils is preferably used. Furthermore, formaldehyde (for preservation) and chlorophyll (preferably <5% by weight) can be added, as can further ingredients.

Air fresheners are not, however, limited to living spaces, but can also be intended for cars, cupboards, dishwashers, fridges, shoes and even the application in vacuum cleaners is possible. In the home (e.g. in cupboards), apart from the odor improvers, disinfectants are also used, which preferably comprise substances such as calcium phosphate, talc, stearin and essential oils, for example in the form of small bags.

The composition according to the invention can be used directly or indirectly for the fragrancing of an object, of a surface or of a space, preferably of textile fabrics, household surfaces, shoes, waste containers, recycling containers, air, relatively large domestic appliances, cat litter, pets, pet beds, in particular of items of clothing, carpets, carpeting, curtains, net curtains, upholstered furniture, bedding, tents, sleeping bags, car seats, car carpets, textile car interiors, bar surfaces, walls, floors, bathroom surfaces, kitchen surfaces, refrigerators, freezers, washing machines, dishwashers, tumble dryers, ovens and microwave ovens. The composition can in this connection be applied in any desired form, for example be sprayed by means of a spray applicator.

According to a further preferred embodiment, the perfume oils can comprise substances from the group
essences of fruits, fruit parts and/or other plant parts, preferably herbs, drugs, essential oils obtained therefrom, preferably terpene-free oils; and/or
artificial essences, preferably from synthetic fragrances and/or flavors, particularly preferably vanillin, menthol, diacetyl and/or eucalyptol; and/or
aromas, preferably essential oils, anise oil, star anise oil, bitter almond oil, eucalyptus oil, fennel oil, peppermint oil, lemon oil, wintergreen oil, clove oil, menthol and/or carraway oil; and/or
synthetic fragrance compounds of the ester type, preferably benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methyl phenyl glycinate, allyl cyclohexylpropionate, styrallyl propionate and/or benzyl salicylate; and/or
synthetic fragrance compounds of the ether type, preferably benzylethyl ether; and/or
synthetic fragrance compounds of the aldehyde type, preferably linear alkanals having 8-18 carbon atoms, citral, citronellal, citronellyloxyacet-aldehyde, cyclamenaldehyde, hydroxycitronellal, lilial and/or bourgeonal; and/or
synthetic fragrance compounds of the ketone type, preferably ionones, isomethylionone and/or methyl cedryl ketone; and/or
synthetic fragrance compounds of the alcohol type, preferably anethole, citronel citronellol, eugenol, geraniol, linalool, phenylethyl alcohol and/or terpineol; and/or
synthetic fragrance compounds of the hydrocarbon type, preferably terpenes, preferably limonene and piniene; and/or
natural fragrance mixtures from plant sources, preferably pine, citrus, jasmine, patchouli, rose or ylang ylang oil, clary sage oil, chamomile oil, clove oil, melissa oil, mint oil, cinnamon leaf oil, linden blossom oil, juniper berry oil, vetiver oil, olibanum oil, galbanum oil, labdanum oil, orange blossom oil, neroliol, orange peel oil and/or sandalwood oil.

It may be advantageous to accelerate or retard the release of the fragrances, i.e. of the perfume oil constituents, depending on the particular intended use. For example, when using compositions according to the invention in a washing or cleaning liquor, it may be advantageous for release to be delayed since in such cases it may be desirable for the fragrances only to develop fully on the treated article.

However, it may also be desirable, for example when cleaning hard surfaces, that the fragrances or perfume oils develop at an essentially uniform rate over the duration of the cleaning step. For these purposes, the perfume oils can be combined with carrier substances or they can be incorporated into carrier substances, which corresponds to a preferred embodiment. Suitable carrier substances for the fragrances or perfume oils may preferably be selected from the group comprising polymers, siloxanes, silicon-containing compounds modified with organic radicals, betaines, paraffins, surfactants, in particular ethoxylated fatty alcohols, fatty acids, silicone oils and/or fatty alcohol, preferably lipophilic substances, where lipophilic substances with a melting point above 25° C. are particularly preferred.

Carrier substances which are particularly suitable according to the invention for the fragrances and perfume oils that can be used according to the invention are meltable or softenable substances from the group of waxes, paraffins, polyalkylene glycols and the like. The meltable or softenable substances preferably have a melting range between about 45° C. and about 75° C. In the present case this means that the melting range occurs within the stated temperature interval, and does not denote the breadth of the melting range.

“Waxes” is understood as meaning a series of natural or synthetic substances which usually melt above 40° C. without decomposition, and are of comparatively low viscosity and non-stringing, even at just little above the melting point. They have a highly temperature-dependent consistency and solubility. The waxes are divided into three groups depending on their origin: the natural waxes, chemically modified waxes, and the synthetic waxes.

The natural waxes include, for example, plant waxes such as candelilla wax, carnauba wax, Japan wax, espartograss wax, cork wax, guaruma wax, rice germ oil wax, sugarcane wax, ouricury wax, or montan wax, animal waxes such as beeswax, shellac wax, spermaceti, lanolin (wool wax), or uropygial grease, mineral waxes such as ceresin or ozokerite (earth wax), or petrochemical waxes such as petrolatum, paraffin waxes or microcrystalline waxes.

The chemically modified waxes include, for example, hard waxes such as montan ester waxes, sassol waxes or hydrogenated jojoba waxes.

Synthetic waxes are generally understood as meaning polyalkylene waxes or polylalkylene glycol waxes. Meltable or softenable substances that can be used for the masses that harden by cooling are also compounds from other classes of substance which meet the stated requirements with regard to the softening point. Suitable synthetic compounds have proven to be, for example, higher esters of phthalic acid, in particular dicyclohexyl phthalate, which is commercially available under the name Unimoll® 66 (Bayer AG). Also suitable are synthetically produced waxes from lower carboxylic acids and fatty alcohols, for example dimyristyl tartrate, which is available under the name Cosmacol® ETLP (Condea). Conversely, synthetic or partially synthetic esters of lower alcohols with fatty acids from natural sources may also be used. This class of substance includes, for example, Tegin® 90 (Goldschmidt), a glycerol monostearate palmitate. Shellac as well, for example Shellack-KPS-Dreiring-SP (Kalkhoff GmbH), can be used according to the invention as meltable or softenable substances.

For the purposes of the present invention, the waxes likewise include, for example, the so-called wax alcohols. Wax alcohols are relatively high molecular weight, water-insoluble fatty alcohols having generally about 22 to 40 carbon atoms. The wax alcohols occur, for example, in the form of wax esters of relatively high molecular weight fatty acids (wax acids) as the main constituent of many natural waxes. Examples of wax alcohols are lignoceryl alcohol (1-tetracosanol), cetyl alcohol, myristyl alcohol or melissyl alcohol. Further meltable and softenable substances that can be used are the wool wax alcohols, which are understood as meaning triterpenoid alcohols and steroid alcohols, for example lanolin, which is available, for example, under the tradename Argowax® (Pamentier & Co). Likewise possible for use, at least proportionally, as a constituent of the meltable or softenable substances are, in the context of the present invention, fatty acid glycerol esters or fatty acid alkanolamides, and also, optionally, water-insoluble or only sparingly water-soluble polyalkylene glycol compounds. Particularly preferred meltable or softenable carrier substances are those from the group of polyethylene glycols (PEG) and/or polypropylene glycols (PPG), where polyethylene glycols with molar masses between 1500 and 36 000 are preferred, those with molar masses from 2000 to 6000 are particularly preferred and those with molar masses from 3000 to 5000 are especially preferred. Corresponding methods which are characterized in that the plastically deformable material(s) comprises/comprise at least one substance from the group polyethylene glycols (PEG) and/or polypropylene glycols (PPG) are preferred.

Particular preference is given here to masses which comprise propylene glycols (PPG) and/or polyethylene glycols (PEG) as the sole meltable or softenable substances. Polypropylene glycols (abbreviation PPG) that can be used according to the invention are polymers of propylene glycol which satisfy the general formula below, where n can assume values between 10 and 2000. Preferred PPG have molar masses between 1000 and 10 000, corresponding to values of n between 17 and about 170.

Polyethylene glycols (abbreviation PEG) that can preferably be used according to the invention as polymeric support substances here are polymers of ethylene glycol which satisfy the general formula H—(O—CH₂—CH₂)ₙ—OH, where n can assume values between 20 and about 1000. The abovementioned preferred molecular weight ranges correspond here to preferred ranges of the value n in formula IV of from 30 to 820, in particular from 34 to 818, particularly preferably from 40 to 150, in particular from 45 to 136 and more preferably still from 70 to 120, in particular from 68 to 113.

According to a further preferred embodiment of the invention, the product according to the invention thus comprises supported fragrance or perfume oil, where the support substance(s) are preferably selected from the group comprising polymers, siloxanes, silicon-containing compounds modified with organic radicals, betaines, paraffins, surfactants, in particular ethoxylated fatty alcohols, fatty acids, silicone oils and/or fatty alcohol, preferably lipophilic substances, where lipophilic substances with a melting point above 25° C. are particularly preferred.

According to a further preferred embodiment for the product according to the invention, the ratio of perfume oil to support substance(s) in the case of a supported perfume oil is in the range from 20:1 to 1:10, preferably 5:1 to 10:1 and preferably 3:1.

In a further preferred embodiment, the meltable and softenable support substances used according to the invention predominantly comprise paraffin wax. This means that at least 50% by weight of the total meltable or softenable substances present, preferably more, is composed of paraffin wax. Of particular suitability are paraffin wax contents (based on the total amount of meltable or softenable substances) of about 60% by weight, about 70% by weight or about 80% by weight, where even higher fractions of, for example, more than 90% by weight, are particularly preferred. In a particular embodiment of the invention, the total amount of the meltable or softenable substances used of at least one mass consists exclusively of paraffin wax.

Within the context of the present invention, paraffin waxes have the advantage over the other specified natural waxes that in an alkaline cleaning composition environment, no hydrolysis of the waxes takes place (as is to be expected, for example, with the wax esters) since paraffin wax contains no hydrolyzable groups.

Paraffin waxes consist primarily of alkanes, and also small fractions of isoalkanes and cycloalkanes. The paraffin that can be used according to the invention preferably has essentially no constituents with a melting point of more than 70° C., particularly preferably of more than 60° C. Fractions of high-melting alkanes in the paraffin may, if the temperature of the cleaning composition liquor goes below this melting temperature, leave unwanted wax residues on the surfaces to be cleaned or on the item to be cleaned. Wax residues of this kind generally lead to an unattractive appearance of the cleaned surface and ought therefore to be avoided. Meltable or softenable support substances or support substance mixtures for preferred processing comprise at least one paraffin wax with a melting range from 50° C. to 60° C., where preferred methods are characterized in that the deformable mass(es) comprises/comprise a paraffin wax with a melting range from 50° C. to 55° C.

Preferred support substances suitable for use with the perfume oils can also be selected from the group of water-soluble polymers, of which only the most important will be listed:

water-soluble nonionic polymers (polyvinylpyrrolidones, vinylpyrrolidone/vinyl ester copolymers, cellulose ethers); water-soluble amphoteric polymers (alkylacrylamide/acrylic acid copolymers, alkylacrylamide/methacrylic acid copolymers, alkylacrylamide/methylmethacrylic acid copolymers, alkylacrylamide/acrylic acid/alkylaminoalkyl(meth)acrylic acid copolymers, alkylacrylamide/methacrylic acid/alkylaminoalkyl(meth)acrylic acid copolymers, alkylacrylamide/methylmethacrylic acid/alkylaminoalkyl (meth)acrylic acid copolymers, alkylacrylamide/alkyl methacrylate/alkylaminoethyl methacrylate/alkyl methacrylate copolymers; copolymers of unsaturated carboxylic acids, cationically derivatized unsaturated carboxylic acids, optionally further ionic or nonionogenic monomers; water-soluble zwitterionic polymers (acrylamidoalkyltrialkylammonium chloride/acrylic acid copolymers and their alkali metal and ammonium salts, acrylamidoalkyltrialkylammonium chloride/methacrylic acid copolymers and their alkali metal and ammonium salts, methacroylethylbetaine/methacrylate copolymers); water-soluble anionic polymers (vinyl acetate/crotonic acid copolymers, vinylpyrrolidone/vinyl acrylate copolymers, acrylic acid/ethyl acrylate/N-tert-butylacrylamide terpolymers, graft polymers of vinyl esters, esters of acrylic acid or methacrylic acid alone or in a mixture, copolymerized with crotonic acid, acrylic acid or methacrylic acid with polyalkylene oxides and/or polyalkylene glycols); grafted and crosslinked copolymers (from the copolymerization of a) at least one monomer of the nonionic type, b) at least one monomer of the ionic type, c) of polyethylene glycol and d) a crosslinker; copolymers obtained by copolymerization of at least one monomer of each of the three following groups: a) esters of unsaturated alcohols and short-chain saturated carboxylic acids and/or esters of short-chain saturated alcohols and unsaturated carboxylic acids, b) unsaturated carboxylic acids, c) esters of long-chain carboxylic acids and unsaturated alcohols and/or esters of the carboxylic acids from the group of saturated or unsaturated, straight-chain or branched C₈₋₁₈-alcohols; terpolymers of crotonic acid, vinyl acetate and an allyl or methallyl ester; tetra- and pentapolymers of a) crotonic acid or allyloxyacetic acid, b) vinyl acetate or vinyl propionate, c) branched allyl or methallyl esters, d) vinyl ethers, vinyl esters or straight-chain allyl or methallyl esters; crotonic acid copolymers with one or more monomers from the group ethylene, vinylbenzene, vinyl methyl ether, acrylamide and water-soluble salts thereof; terpolymers of vinyl acetate, crotonic acid and vinyl esters of a saturated aliphatic monocarboxylic acid branched in x position); water-soluble cationic polymers (quaternized cellulose derivatives, polysiloxanes with quaternary groups, cationic guar derivatives, polymeric dimethyldiallylammonium salts and copolymers thereof with esters and amides of acrylic acid and methacrylic acid, copolymers of vinylpyrrolidone with quaternized derivatives of dialkylaminoacrylate and -methacrylate, vinylpyrrolidone-methoimidazolinium chloride copolymers, quaternized polyvinyl alcohol, polymers specified under the INCI names Polyquaternium 2, Polyquaternium 17, Polyquaternium 18 and Polyquaternium 27. Carrier substances in the form of water-soluble polymers for the purposes of the invention are those polymers which are soluble to more than 2.5% by weight in water at room temperature. According to the invention, the support substances can be used alone or in mixtures.

According to a preferred embodiment, a composition according to the invention consequently comprises supported perfume oil.

According to a further preferred embodiment, the product according to the invention, such as, in particular, washing, care or cleaning compositions, has at least one, preferably two or more, active components, in particular washing-, care- and/or cleaning-active components, advantageously selected from the group comprising anionic surfactants, cationic surfactants, amphoteric surfactants, nonionic surfactants, acidifying agents, alkalizing agents, anticrease compounds, antibacterial substances, antioxidants, antiredeposition agents, antistats, builder substances, bleaches, bleach activators, bleach stabilizers, bleach catalysts, ironing aids, cobuilders, shrink preventers, electrolytes, enzymes, color protectants, colorants, dyes, color transfer inhibitors, fluorescent agents, fungicides, germicides, odor-complexing substances, auxiliaries, hydrotropes, rinse aids, complexing agents, preservatives, corrosion inhibitors, optical brighteners, perfume carriers, pearlizing agents, pH extenders, phobicization and impregnation agents, polymers, swelling and antislip agents, foam inhibitors, sheet silicates, soil repellent substances, silver protectants, silicone oils, UV protection substances, viscosity regulators, thickeners, discoloration inhibitors, graying inhibitors, vitamins and/or fabric softeners.

For the purposes of this invention, unless stated otherwise, data for the product according to the invention in % by weight is based on the total weight of the product according to the invention. The terms product according to the invention, consumer product and composition are used synonymously, unless stated otherwise.

The amounts of the individual ingredients in the compositions according to the invention are governed in each case by the intended use of the compositions in question, and the person skilled in the art is familiar with the orders of magnitude of the amounts of the ingredients to be used, or can take them from the relevant technical literature. For example, the surfactant content chosen will be higher or lower depending on the intended use of the compositions according to the invention. The surfactant content of, for example, laundry detergents, can usually be, for example, between 10 and 50% by weight, preferably between 12.5 and 30% by weight and in particular between 15 and 25% by weight, whereas detergents for machine dishwashing, for example, can usually comprise between 0.1 and 10% by weight, preferably between 0.5 and 7.5% by weight and in particular between 1 and 5% by weight of surfactants.

Preferred ingredients of the compositions according to the invention are described in more detail below. Anionic surfactants are preferably present in the products according to the invention. The anionic surfactants used are, for example, those of the sulfonate and sulfate type. Suitable surfactants of the sulfonate type here are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Alkanesulfonates which are obtained from C₁₂₋₁₈-alkanes, for example by sulfochlorination or sulfoxidation with subsequent hydrolysis or neutralization, are also suitable. The esters of α-polyhydroxy fatty acids (ester sulfonates), for example the α-sulfonated methyl esters of hydrogenated coconut, palm kernel or tallow fatty acids, are also suitable.

Further suitable anionic surfactants are sulfated fatty acid glycerol esters. Fatty acid glycerol esters are understood as meaning the mono-, di- and triesters, and mixtures thereof, as are obtained in the production by esterification of a monoglycerol with 1 to 3 mol of fatty acid or in the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric acid half-esters of C₁₂-C₁₈-fatty alcohols, for example of coconut fatty alcohol, tallow fatty alcohol, lauryl, myristyl, cetyl or stearyl alcohol, or of C₁₀-C₂₀-oxo alcohols and those half-esters of secondary alcohols with these chain lengths. Also preferred are alk(en)yl sulfates of the specified chain length which contain a synthetic straight-chain alkyl radical prepared on a petrochemical basis and which have analogous degradation behavior to the equivalent compounds based on fatty chemical raw materials. From the point of view of washing, preference is given to the C₁₂-C₁₆-alkyl sulfates and C₁₂-C₁₅-alkyl sulfates, and C₁₄-C₁₅-alkyl sulfates. 2,3-Alkyl sulfates, which can be obtained as commercial products of Shell Oil Company under the name DAN®, are also suitable anionic surfactants.

Also suitable are the sulfuric acid monoesters of the straight-chain or branched C₇₋₂₁-alcohols ethoxylated with 1 to 6 mol of ethylene oxide, such as 2-methyl-branched C₉₋₁₁-alcohols with, on average, 3.5 mol of ethylene oxide (EO) or C₁₂₋₁₈-fatty alcohols with 1 to 4 EO. On account of their high foaming behavior, they are used in particular in cleaning compositions preferably only in relatively small amounts, for example in amounts of from 1 to 5% by weight.

A further class of anionic surfactants is the class of ether carboxylic acids obtainable by reaction of fatty alcohol ethoxylates with sodium chloroacetate in the presence of basic catalysts. They have the general formula: R¹⁰O—(CH₂—CH₂—O)ₚ—CH₂—COOH where R¹⁰=C₁-C₁₈ and p=0.1 to 20. Ether carboxylic acids are insensitive to water hardness and have exceptional surfactant properties.

Suitable anionic surfactants are, for example, also the partial esters of di- or polyhydroxyalkanes, mono- and disaccharides, polyethylene glycols with the ene adducts of maleic anhydride onto at least monounsaturated carboxylic acids with a chain length from 10 to 25 carbon atoms with an acid number from 10 to 140.

Besides an unbranched or branched, saturated or unsaturated, aliphatic or aromatic, acyclic or cyclic, optionally alkoxylated alkyl radical having 4 to 28, preferably 6 to 20, in particular 8 to 18, particularly preferably 10 to 16, exceptionally preferably 12 to 14, carbon atoms, preferred anionic surfactants have two or more anionic, in particular two, acid groups, preferably carboxylate, sulfonate and/or sulfate groups, in particular one carboxylate group and one sulfate group. Examples of these compounds are the ˜-sulfofatty acid salts, the acyl glutamates, the monoglyceride disulfates and the alkyl ethers of glycerol disulfate, and in particular the monoesterified sulfosuccinates described below.

Particularly preferred anionic surfactants are the sulfosuccinates, sulfosuccinamates and sulfosuccinamides, in particular sulfosuccinates and sulfosuccinamates, exceptionally preferably sulfosuccinates. The sulfosuccinates are the salts of the mono- and diesters of sulfosuccinic acid HOOCCH(SO₃H)CH₂COOH, while the sulfosuccinamates are understood as meaning the salts of the monoamides of sulfosuccinic acid, and the sulfosuccinamides are understood as meaning the salts of the diamides of sulfosuccinic acid.

The salts are preferably alkali metal salts, ammonium salts and also mono-, di- and trialkylammonium salts, for example mono-, di- or triethanolammonium salts, in particular lithium, sodium, potassium or ammonium salts, particularly preferably sodium or ammonium salts, exceptionally preferably sodium salts.

In the sulfosuccinates, one or both carboxyl groups of sulfosuccinic acid has/have preferably been esterified with one or two identical or different unbranched or branched, saturated or unsaturated, acyclic or cyclic, optionally alkoxylated alcohols having 4 to 22, preferably 6 to 20, in particular 8 to 18, particularly preferably 10 to 16, exceptionally preferably 12 to 14, carbon atoms. Particular preference is given to the esters of unbranched and/or saturated and/or acyclic and/or alkoxylated alcohols, in particular unbranched, saturated fatty alcohols and/or unbranched, saturated fatty alcohols alkoxylated with ethylene oxide and/or propylene oxide, preferably ethylene oxide, and having a degree of alkoxylation of from 1 to 20, preferably from 1 to 15, in particular 1 to 10, particularly preferably 1 to 6, exceptionally preferably 1 to 4. Within the context of the present invention, the monoesters are preferred over the diesters. A particularly preferred sulfosuccinate is sulfosuccinic acid lauryl polyglycol ester disodium salt (lauryl-EO-sulfosuccinate, disodium salt; INCI Disodium Laureth Sulfosuccinate), which is commercially available, for example, as Tego® Sulfosuccinate F 30 (Goldschmidt) with a sulfosuccinate content of 30% by weight.

In the sulfosuccinamates or sulfosuccinamides, one or both carboxyl groups of sulfosuccinic acid preferably form(s) a carboxamide with a primary or secondary amine which bears one or two identical or different, unbranched or branched, saturated or unsaturated, acyclic or cyclic, optionally alkoxylated alkyl radicals having 4 to 22, preferably 6 to 20, in particular 8 to 18, particularly preferably 10 to 16, exceptionally preferably 12 to 14, carbon atoms. Particular preference is given to unbranched and/or saturated and/or acyclic alkyl radicals, in particular unbranched, saturated fatty alkyl radicals.

Also suitable are, for example, the following sulfosuccinates and sulfosuccinamates designated according to INCI, which are described in detail in the International Cosmetic Ingredient Dictionary and Handbook: Ammonium Dinonyl Sulfosuccinate, Ammonium Lauryl Sulfosuccinate, Diammonium Dimethicone Copolyol Sulfosuccinate, Diammonium Lauramido-MEA Sulfosuccinate, Diammonium Lauryl Sulfosuccinate, Diammonium Oleamido PEG-2 Sulfosuccinate, Diamyl Sodium Sulfosuccinate, Diacapryl Sodium Sulfosuccinate, Dicyclohexyl Sodium Sulfosuccinate, Diheptyl Sodium Sulfosuccinate, Dihexyl Sodium Sulfosuccinate, Diisobutyl Sodium Sulfosuccinate, Dioctyl Sodium Sulfosuccinate, Disodium Cetearyl Sulfosuccinate, Disodium Cocamido MEA-Sulfosuccinate, Disodium Cocamido Glucoside Sulfosuccinate, Disodium Cocoyl Butyl Gluceth-10 Sulfosuccinate, Disodium C12-15 Pareth Sulfosuccinate, Disodium Deceth-5 Sulfosuccinate, Disodium Deceth-6 Sulfosuccinate, Disodium Dihydroxyethyl Sulfosuccinylundecylenate, Disodium Dimethicone Copolyol Sulfosuccinate, Disodium Hydrogenated Cottonseed Glyceride Sulfosuccinate, Disodium Isodecyl Sulfosuccinate, Disodium Isostearamido MEA-Sulfosuccinate, Disodium Isostearamido MIPA-Sulfosuccinate, Disodium Isostearyl Sulfosuccinate, Disodium Laneth-5 Sulfosuccinate, Disodium Lauramido MEA-Sulfosuccinate, Disodium Lauramido PEG-2 Sulfosuccinate, Disodium Lauramido PEG-5 Sulfosuccinate, Disodium Laureth-6 Sulfosuccinate, Disodium Laureth-9 Sulfosuccinate, Disodium Laureth-12 Sulfosuccinate, Disodium Lauryl Sulfosuccinate, Disodium Myristamido MEA-Sulfosuccinate, Disodium Nonoxynol-10 Sulfosuccinate, Disodium Oleamido MEA-Sulfosuccinate, Disodium Oleamido MIPA-Sulfosuccinate, Disodium Oleamido PEG-2 Sulfosuccinate, Disodium Oleth-3 Sulfosuccinate, Disodium Oleyl Sulfosuccinate, Disodium Palmitamido PEG-2 Sulfosuccinate, Disodium Palmitoleamido PEG-2 Sulfosuccinate, Disodium PEG-4 Cocamido MIPA-Sulfosuccinate, Disodium PEG-5 Laurylcitrate Sulfosuccinate, Disodium PEG-8 Palm Glycerides Sulfosuccinate, Disodium Ricinoleamido MEA-Sulfosuccinate, Disodium Sitostereth-14 Sulfosuccinate, Disodium Stearamido MEA-Sulfosuccinate, Disodium Stearyl Sulfosuccinamate, Disodium Stearyl Sulfosuccinate, Disodium Tallamido MEA-Sulfosuccinate, Disodium Tallowamido MEA-Sulfosuccinate, Disodium Tallow Sulfosuccinamate, Disodium Tridecylsulfosuccinate, Disodium Undecylenamido MEA-Sulfosuccinate, Disodium Undecylenamido PEG-2 Sulfosuccinate, Disodium Wheat Germamido MEA-Sulfosuccinate, Disodium Wheat Germamido PEG-2 Sulfosuccinate, Di-TEA-Ole-amido PEG-2 Sulfosuccinate, Ditridecyl Sodium Sulfosuccinate, Sodium Bisglycol Ricinosulfosuccinate, Sodium/MEA Laureth-2 Sulfosuccinate and Tetrasodium Dicarboxyethyl Stearyl Sulfosuccinamate. Yet another suitable sulfosuccinamate is disodium C₁₆₋₁₈-alkoxypropylenesulfosuccinamate.

The content of anionic surfactants, preferably of the specified anionic surfactants, in the composition according to the invention can vary within wide ranges, depending on the purpose served by the composition in question. Thus, a composition according to the invention can comprise very large amounts of anionic surfactant, preferably up to an order of magnitude of up to 40, 50 or 60% by weight or more. A composition according to the invention can likewise comprise only very small amounts of anionic surfactant, for example less than 15 or 10% by weight or less than 5% by weight or even less. However, in the compositions according to the invention, anionic surfactants are advantageously present in amounts of from 2 to 35% by weight and in particular 5 to 30% by weight, with concentrations above 10% by weight and even above 15% by weight being particularly preferred. According to a preferred embodiment, the product according to the invention comprises anionic surfactants, preferably in amounts of at least 0.1% by weight, based on the total product.

In addition to the specified anionic surfactants, but also independently of them, it is possible for soaps to be present in the compositions according to the invention. Of particular suitability are saturated fatty acid soaps, such as the soaps of lauric acid, myristic acid, palmitic acid, stearic acid, hydrogenated erucic acid and behenic acid, and also, in particular, soap mixtures derived from natural fatty acids, e.g. coconut, palm kernel or tallow fatty acids. The content of soaps in the composition, independently of other anionic surfactants, is preferably not more than 3% by weight and in particular 0.5 to 2.5% by weight, based on the total composition.

The anionic surfactants and soaps can be in the form of their sodium, potassium or ammonium salts, and also as soluble salts of organic bases, such as mono-, di- or triethanolamine. Preferably, they are in the form of their sodium or potassium salts, in particular in the form of the sodium salts. Anionic surfactants and soaps can also be prepared in situ, by incorporating the anionic surfactant acids and optionally fatty acids into the composition to be spray-dried, these acids then being neutralized by the alkali carriers in the composition to be spray-dried.

Advantageously it is possible for nonionic surfactants to likewise be present in the compositions according to the invention, both in solid compositions and in liquid compositions. For example, their content can be 2 or 3 or 5% by weight. It is also possible for larger amounts of nonionic surfactant to be present, for example up to 5% by weight or 10% by weight or 15% by weight or 20% by weight or 30% by weight or even more, if this is expedient. Useful lower limits can lie at values of 1, 2, 3 or 4% by weight.

However, the nonionic surfactants are preferably present in relatively large amounts, i.e. up to 50% by weight, advantageously from 0.1 to 40% by weight, particularly preferably from 0.5 to 30% by weight and in particular from 2 to 25% by weight, in each case based on the total composition. According to a preferred embodiment, the product according to the invention comprises nonionic surfactants, preferably in amounts of at least 0.1% by weight, based on the total product.

All of the nonionic surfactants known from the prior art can advantageously be present in the compositions according to the invention. Preferred nonionic surfactants are presented below.

The compositions according to the invention, such as, in particular, cleaning, care and washing compositions, can preferably also comprise cationic surfactants. Suitable cationic surfactants are, for example, surface-active quaternary compounds, in particular with an ammonium, sulfonium, phosphonium, iodonium or arsonium group. Through the use of quaternary surface-active compounds with antimicrobial effect it is possible to configure the composition with an antimicrobial effect and/or to improve its antimicrobial effect which may already exist on account of other ingredients.

Particularly preferred cationic surfactants are the quaternary, in some cases antimicrobially effective, ammonium compounds (QACs; INCI Quaternary Ammonium Compounds) according to the general formula (R^{I})(R^{II})(R^{III})(R^{IV})N⁺X⁻, in which R^{I} to R^{IV} are identical or different C₁₋₂₂-alkyl radicals, C₇₋₂₈-aralkyl radicals or heterocyclic radicals, where two, or, in the case of an aromatic incorporation as in pyridine, even three, radicals, together with the nitrogen atom form the heterocycle, e.g. a pyridinium or imidazolinium compound, and X⁻ are halide ions, sulfate ions, hydroxide ions or similar anions. For an optimum antimicrobial effect, at least one of the radicals preferably has a chain length of from 8 to 18, in particular 12 to 16, carbon atoms.

QACs can be prepared by reacting tertiary amines with alkylating agents, such as, for example, methyl chloride, benzyl chloride, dimethyl sulfate, dodecyl bromide, but also ethylene oxide. The alkylation of tertiary amines with a long alkyl radical and two methyl groups takes place particularly readily, and the quaternization of tertiary amines having two long radicals and a methyl group can also be carried out with the help of methyl chloride under mild conditions. Amines which have three long alkyl radicals or hydroxy-substituted alkyl radicals have low reactivity and are preferably quaternized with dimethyl sulfate.

Suitable QACs are, for example, benzalkonium chloride (N-alkyl-N,N-dimethylbenzylammonium chloride, CAS No. 8001-54-5), benzalkone B (m,p-dichlorobenzyl-dimethyl-C₁₂-alkylammonium chloride, CAS No. 58390-78-6), benzoxonium chloride (benzyldodecylbis(2-hydroxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chloride, such as di-n-decyl-dimethylammonium chloride (CAS No. 7173-51-5-5), didecyldimethyl-ammonium bromide (CAS No. 2390-68-3), dioctyldiethylammonium chloride, 1-cetylpyridinium chloride (CAS No. 123-03-5) and thiazoline iodide (CAS No. 15764-48-1) and mixtures thereof. Preferred QACs are the benzalkonium chlorides having C₈-C₁₈-alkyl radicals, in particular C₁₂-C₁₄-alkylbenzyl-dimethylammonium chloride. A particularly preferred QAC cocopentaethoxy-methylammonium methosulfate (INCI PEG-5 Cocomonium Methosulfate; Rewoquat® CPEM).

To avoid possible incompatibilities of the antimicrobial cationic surfactants with the anionic surfactants present in the composition according to the invention, the cationic surfactant used is as anionic surfactant-compatible as possible and/or is used in the smallest amount possible, or, in a preferred embodiment of the invention, cationic surfactants are dispensed with entirely.

Later on below, particularly in connection with conditioners and softeners, a description is given of further cationic surfactants, including quaternary ammonium compounds. These too may preferably be present in the compositions according to the invention.

The compositions according to the invention, such as preferably cleaning, care and washing compositions, can comprise one or more cationic surfactants, advantageously in amounts, based on the total composition, of from 0 to 30% by weight, more advantageously greater than 0 to 20% by weight, preferably 0.01 to 10% by weight, in particular 0.1 to 5% by weight. Suitable minimum values may also be 0.5, 1, 2 or 3% by weight. According to a preferred embodiment, the product according to the invention comprises cationic surfactants, preferably in amounts of at least 0.1% by weight, based on the total product.

The compositions according to the invention, such as preferably cleaning, care and washing compositions, can likewise also comprise amphoteric surfactants. These are described in more detail later on below, particularly in connection with conditioners and softeners.

The compositions according to the invention, such as cleaning, care and washing compositions, can comprise one or more amphoteric surfactants, advantageously in amounts, based on the total composition, of from 0 to 30% by weight, more advantageously greater than 0 to 20% by weight, preferably 0.01 to 10% by weight, in particular 0.1 to 5% by weight.

Further ingredients of the compositions according to the invention may be inorganic or organic builder substances. The inorganic builder substances include water-insoluble or non-water-soluble ingredients, such as aluminosilicates and, in particular, zeolites.

In a preferred embodiment, the composition according to the invention comprises no phosphate and/or no zeolite. However, it is also possible for the composition to comprise zeolite. It can then be preferred that this zeolite fraction, based on the total weight of the composition, is less than 5% by weight, preferably at most 4% by weight, at most 3% by weight or at most 2% by weight.

However, it can advantageously also be intended that the composition according to the invention has a zeolite content of at least 10% by weight, e.g. at least 15% by weight or at least 20% by weight or at least 30% by weight, or even more, for example at least 50% by weight.

The composition according to the invention can comprise soluble builders preferably in amounts of from 10% by weight to 30% by weight, preferably 15% by weight to 25% by weight and particularly preferably 18% by weight to 20% by weight, based on the total weight of the composition, with sodium carbonate being a particularly preferred soluble builder. However, it may advantageously also be envisaged that the composition according to the invention comprises less than 10% by weight, for example less than 5% by weight, of soluble builders.

A finely crystalline, synthetic zeolite containing bound water that can be used is preferably zeolite A and/or P. A particularly preferred zeolite P is, for example, zeolite MAP® (commercial product from Crosfield). However, zeolite X and also mixtures of A, X and/or P are also suitable. Also of particular interest is a cqcrystallized sodium/potassium aluminum silicate of zeolite A and zeolite X, which is commercially available as VEGOBOND AX® (commercial product from Condea Augusta S.p.A.). This product is described in more detail below. The zeolite can be used as a spray-dried powder or else as an undried, stabilized suspension that is still wet from its preparation. Where the zeolite is used in the form of a suspension it is possible for said suspension to comprise small additions of nonionic surfactants as stabilizers, for example 1 to 3% by weight, based on zeolite, of ethoxylated C₁₂-C₁₈ fatty alcohols having 2 to 5 ethylene oxide groups, C₁₂-C₁₄-fatty alcohols having 4 to 5 ethylene oxide groups or ethoxylated isotridecanols. Suitable zeolites have an average particle size of preferably less than 10 μm (volume distribution; measurement method: Coulter counter) and preferably contain 18 to 22% by weight, in particular 20 to 22% by weight, of bound water.

Further particularly suitable zeolites are zeolites of the faujasite type. Together with zeolites X and Y, the mineral faujasite is one of the faujasite types within zeolite structural group 4 which are characterized by the double six-membered ring subunit D6R. Besides said faujasite types, zeolite structural group 4 also includes the minerals chabazite and gmelinite and also the synthetic zeolites R (chabazite type), S (gmelinite type), L and ZK-5. The two last-mentioned synthetic zeolites have no mineral analogs.

Zeolites of the faujasite type are composed of β cages linked tetrahedrally via D6R subunits, the β cages being arranged similarly to the carbon atoms in a diamond. The three-dimensional network of the faujasite-type zeolites suitable according to the invention has pores of 2.2 and 7.4 Å; the unit cell moreover contains 8 cavities of approximately 13 Å in diameter and may be described by the formula Na₈₆-[(AlO₂)₈₆(SiO₂)₁₀₆]≅264H₂O. The network of zeolite X contains a cavity volume of approximately 50%, based on the dehydrated crystal, which constitutes the greatest empty space of all known zeolites (zeolite Y: about 48% cavity volume, faujasite: about 47% cavity volume).

For the purposes of the present invention, the term “faujasite-type zeolite” characterizes all three zeolites which form the faujasite subgroup of zeolite structural group 4. Thus, according to the invention, not only zeolite X but also zeolite Y and faujasite, and mixtures of these compounds, are suitable, preference being given to straight zeolite X.

Also suitable according to the invention are mixtures or cocrystallizates of faujasite-type zeolites with other zeolites, which do not necessarily have to belong to zeqlite structural group 4, where preferably at least 50% by weight of the zeolites are of the faujasite type.

The suitable aluminum silicates are commercially available, and the methods for preparing them are described in standard monographs.

Examples of commercially available zeolites of the X type can be described by the following formulae:

Na₈₆[(AlO₂)₈₆(SiO₂)₁₀₆].xH₂O,

K₈₆[(AlO₂)₈₆(SiO₂)₁₀₆].xH₂O.

Ca₄₀Na₆[(AlO₂)₈₆(SiO₂)₁₀₆].xH₂O,

Sr₂₁Ba₂₂[(AlO₂)₈₆(SiO₂)₁₀₆].xH₂O,

in which x can assume values of greater than 0 to 276. These zeolites have pores sizes of from 8.0 to 8.4 Å.

Also suitable, for example, is zeolite A-LSX, which corresponds to a cocrystallizate of zeolite X and zeolite A and in its anhydrous form has the formula (M_{2/n}O+M′_{2/n}O)≅Al₂O₃≅zSiO₂, where M and M′ may be alkali metal or alkaline earth metals and z is a number from 2.1 to 2.6. This product is commercially available under the tradename VEGOBOND AX from CONDEA Augusta S.p.A.

Zeolites of the Y type are also commercially available and can be described, for example, by the formulae

Na₅₆[(AlO₂)₅₆(SiO₂)₁₃₆].xH₂O,

K₅₆[(AlO₂)₅₆(SiO₂)₁₆₆]xH₂O,

in which x is numbers of greater than 0 to 276. These zeolites have pore sizes of 8.0 Å.

The particle sizes of the suitable zeolites here is advantageously in the range from 0.1 μm up to 100 μm, preferably from 0.5 μm to 50 μm and in particular from 1 μm to 30 μm, in each case measured using standard particle size determination methods.

In a preferred embodiment of the invention all of the inorganic constituents present should preferably be water-soluble. In these embodiments, therefore, builder substances other than the specified zeolites are used.

Further suitable builder substances are polyacetals, which can be obtained by reaction of dialdehydes with polyolcarboxylic acids which have 5 to 7 carbon atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic builder substances are dextrins, for example oligomers or polymers of carbohydrates which can be obtained by partial hydrolysis of starches. The hydrolysis can be carried out by customary methods, examples being acid- or enzyme-catalyzed methods. The hydrolysis products in question are preferably those with average molar masses in the range from 400 to 500 000 g/mol. Preference is given here to a polysaccharide with a dextrose equivalent (DE) in the range from 0.5 to 40, in particular from 2 to 30, where DE is a customary measure of the reducing effect of a polysaccharide compared to dextrose, which has a DE of 100. It is possible to use either maltodextrins with a DE between 3 and 20 and dry glucose syrups with a DE between 20 and 37, and also so-called yellow dextrins and white dextrins with higher molar masses in the range from 2000 to 30 000 g/mol. A preferred dextrin is described in the British patent application 94 19 091. The oxidized derivatives of such dextrins are their reaction products with oxidizing agents which are capable of oxidizing at least one alcohol function of the saccharide ring to the carboxylic acid function.

Oxydisuccinates and other derivatives of disuccinates, preferably ethylenediamine disuccinate, are also further suitable cobuilders. Here, ethylenediamine N,N′-disuccinate (EDDS) is preferably used in the form of its sodium or magnesium salts. In this connection, further preference is also given to glycerol disuccinates and glycerol trisuccinates. Suitable use amounts are, for example, 3 to 15% by weight, based on the total composition.

Further organic cobuilders that can be used are, for example, acetylated hydroxycarboxylic acids and salts thereof, which may optionally also be present in lactone form and which contain at least 4 carbon atoms and at least one hydroxy group and at most two acid groups.

A further substance class with cobuilder properties is the phosphonates. These are, in particular, hydroxyalkanephosphonates or aminoalkanephosphonates. Among the hydroxyalkanephosphonates, 1-hydroxyethane-1,1-diphosphonate (HEDP) is of particular importance as a cobuilder. It is used preferably as the sodium salt, the disodium salt giving a neutral reaction and the tetrasodium salt an alkaline (pH 9) reaction. Suitable aminoalkanephosphonates are preferably ethylenediaminetetramethylene-phosphonate (EDTMP), diethylenetriaminepentamethylenephosphonate (DTPMP) and their higher homologs. They are preferably used in the form of the neutrally reacting sodium salts, e.g. as the hexasodium salt of EDTMP and as the heptasodium and octasodium salts of DTPMP. Builders used here, from the class of phosphonates, are preferably HEDP. In addition, the aminoalkanephosphonates have pronounced heavy metal-binding capacity. Accordingly, particularly if the compositions also comprise bleach, it may be preferred to use aminoalkanephosphonates, in particular DTPMP, or mixtures of said phosphonates.

In cases where a phosphate content is tolerated, it is also possible to use phosphates, in particular pentasodium triphosphate, and possibly also pyrophosphates and orthophosphates, which act primarily as precipitants for lime salts. Phosphates are predominantly used in machine dishwashing compositions, but sometimes also in laundry detergents as well. Alkali metal phosphates is the collective term for the alkali metal (in particular sodium and potassium) salts of the various phosphoric acids, among which metaphosphoric acids (HPO₃)ₙ and orthophosphoric acid H₃PO₄, as well as higher molecular mass representatives, may be differentiated. The phosphates combine a number of advantages: they act as alkali carriers, prevent limescale deposits on machine components and lime encrustations in fabrics and, moreover, contribute to the cleaning performance.

Sodium dihydrogen phosphate, NaH₂PO₄, exists as the dihydrate (density 1.91 gcm⁻³, melting point 60° C.) and as the monohydrate (density 2.04 gcm⁻³). Both salts are white powders of very readily solubility in water which lose the water of crystallization upon heating and undergo conversion at 200° C. into the weakly acidic diphosphate (disodium hydrogen diphosphate, Na₂H₂P₂O₇), and at the higher temperature into sodium trimetaphosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogen phosphate (primary or monobasic potassium phosphate, potassium biphosphate, KDP), KH₂PO₄, is a white salt of density 2.33 gcm⁻³, has a melting point of 2530 [decomposition with formation of potassium polyphosphate (KPO₃)ₓ] and is readily soluble in water.

Disodium hydrogen phosphate (secondary sodium phosphate), Na₂HPO₄, is a colorless crystalline salt that is very readily soluble in water. It exists in anhydrous form and with 2 mol (density 2.066 gcm⁻³, water loss at 950), 7 mol (density 1.68 gcm⁻³, melting point 480 with loss of 5H₂O) and 12 mol of water (density 1.52 gcm⁻³, melting point 350 with loss of 5H₂O), becomes anhydrous at 100°, and if heated more severely, undergoes transition to the diphosphate Na₄P₂O₇. Disodium hydrogen phosphate is prepared by neutralization of phosphoric acid with sodium carbonate solution using phenolphthalein as indicator. Dipotassium hydrogen phosphate (secondary or dibasic potassium phosphate), K₂HPO₄, is an amorphous, white salt, which is readily soluble in water.

Trisodium phosphate, tertiary sodium phosphate, Na₃PO₄, are colorless crystals which as the dodecahydrate have a density of 1.62 gcm⁻³ and a melting point of 73-76° C. (decomposition), as the decahydrate (corresponding to 19-20% P₂O₅) have a melting point of 100° C., and in anhydrous form (corresponding to 39-40% P₂O₅) have a density of 2.536 gcm⁻³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent granular powder of density 2.56 gcm⁻³, has a melting point of 1340° and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the cleaning products industry over corresponding sodium compounds.

Tetrasodium diphosphate (sodium pyrophosphate), Na₄P₂O₇, exists in anhydrous form (density 2.534 gcm⁻³, melting point 9880, 8800 also reported) and as the decahydrate (density 1.815-1.836 gcm⁻³, melting point 940 with loss of water). Both substances are colorless crystals which dissolve in water with an alkaline reaction. Na₄P₂O₇ is formed when disodium phosphate is heated at >2000 or by reacting phosphoric acid with sodium carbonate in stoichiometric ratio and dewatering the solution by spraying. The decahydrate complexes heavy metal salts and hardness formers and therefore reduces the hardness of the water. Potassium diphosphate (potassium pyrophosphate), K₄P₂O₇, exists in the form of the trihydrate and is a colorless, hygroscopic powder of density 2.33 gcm⁻³ which is soluble in water, the pH of the 1% strength solution at 250 being 10.4.

Condensation of NaH₂PO₄ or of KH₂PO₄ gives rise to higher molecular weight sodium and potassium phosphates, among which it is possible to differentiate cyclic representatives, the sodium and potassium metaphosphate, and catenated types, the sodium and potassium polyphosphates. For the latter in particular a large number of names are in use: fused or calcined phosphates, Graham's salt, Kurrol's and Maddrell salt. All higher sodium and potassium phosphates are referred to collectively as condensed phosphates.

The industrially important pentasodium triphosphate, Na₅P₃O₁₀ (sodium tripolyphosphate) is a nonhygroscopic, white, water-soluble salt which is anhydrous or crystallizes with 6H₂O and has the general formula NaO—[P(O)(ONa)—O]ₙ—Na where n=3. About 17 g of the anhydrous salt dissolve in 100 g of water at room temperature, at 60° C. about 20 g, at 100° around 32 g; after heating the solution to 1000 for two hours, about 8% orthophosphate and 15% diphosphate are produced by hydrolysis. For the preparation of pentasodium trisphosphate, phosphoric acid is reacted with sodium carbonate solution or sodium hydroxide solution in stoichiometric ratio and the solution is dewatered by spraying. In a similar way to Graham's salt and sodium diphosphate, pentasodium triphosphate dissolves numerous insoluble metal compounds (including lime soaps etc.). Pentapotassium triphosphate, K₅P₃O₁₀ (potassium tripolyphosphate) is commercially available, for example, in the form of a 50% strength by weight solution (>23% P₂O₅, 25% K₂O). The potassium polyphosphates are used widely in the detergents and cleaners industry. There also exist sodium potassium tripolyphosphates, which can likewise be used for the purposes of the present invention. These are formed, for example, when sodium trimetaphosphate is hydrolyzed with KOH:

(NaPO₃)₃+2 KOH→Na₃K₂P₃O₁₀+H₂O

These can be used according to the invention in precisely the same way as sodium tripolyphosphate, potassium tripolyphosphate or mixtures of these two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

In a preferred embodiment of the invention, carbonates and silicates are used in particular as inorganic builder substances.

Mention is to be made here in particular of crystalline, layered sodium silicates of the general formula NaMSiₓO₂ₓ₊₁.yH₂O, where M is sodium or hydrogen, x is a number from 1.6 to 4, preferably 1.9 to 4.0 and y is a number from 0 to 20 and preferred values for x are 2, 3 or 4. However, since crystalline silicates of this kind lose their crystalline structure, at least partly, in a spray drying process, crystalline silicates are preferably admixed subsequently to the direct or aftertreated spray-drying product. Preferred crystalline sheet silicates of the formula indicated are those in which M is sodium and x assumes the values 2 or 3. In particular, both β- and δ-sodium disilicates Na₂Si₂O₅.yH₂O are preferred. Compounds of this kind are commercially available, for example, under the name SKS® (Clariant). SKS-6® is predominantly a δ-sodium disilicate with the formula Na₂Si₂O₅.yH₂O; SKS-70 is primarily the p-sodium disilicate. Reaction with acids (e.g. citric acid or carbonic acid) produces from the β-sodium disilicate kanemite NaHSi₂O₅.yH₂O, commercially available under the names SKS-9® and SKS-10® (Clariant). It may also be advantageous to use chemical modifications of these sheet silicates. Thus, for example, the alkalinity of the sheet silicates can be influenced in a suitable way. Compared to the 6-sodium disilicate, phosphate-doped and/or carbonate-doped sheet silicates have altered crystal morphologies, dissolve more rapidly, and exhibit a calcium-binding capacity which is higher than that of δ-sodium disilicate. Thus, sheet silicates of the general empirical formula xNa₂O.ySiO₂.zP₂O₅, in which the ratio of x to y corresponds to a number 0.35 to 0.6, the ratio of x to z corresponds to a number from 1.75 to 1200 and the ratio of y to z corresponds to a number from 4 to 2800, are known. The solubility of the sheet silicates can also be increased by using particularly finely divided sheet silicates. Compounds of the crystalline sheet silicates with other ingredients can also be used. In this context, mention is to be made in particular of compounds with cellulose derivatives, which have advantages in the disintegrating effect, and also compounds with polycarboxylates, e.g. citric acid, and/or polymeric polycarboxylates, e.g. copolymers of acrylic acid.

Preferred builder substances also include amorphous sodium silicates with an Na₂O:SiO₂ modulus of from 1:2 to 1:3.3, preferably from 1:2 to 1:2.8 and in particular from 1:2 to 1:2.6, which have secondary washing properties. In the context of this invention, the term “amorphous” is also understood as meaning “X-ray amorphous”. This means that in X-ray diffraction experiments the silicates do not produce the sharp X-ray reflections typical of crystalline substances but instead produce at best one or more maxima of the scattered X-radiation, having a width of several degree units of the diffraction angle. However, good builder properties, very probably even particularly good builder properties, may result if the silicate particles in electron diffraction experiments produce vague or even sharp diffraction maxima. The interpretation of this is that the products have microcrystalline regions with a size of from 10 to a few hundred nm, where values up to max. 50 nm and in particular up to max. 20 nm are preferred. Such so-called X-ray-amorphous silicates, which likewise have delayed dissolution relative to the conventional waterglasses, are known. Particular preference is given to compacted amorphous silicates, compounded amorphous silicates and overdried X-ray-amorphous silicates. The content of the (X-ray-)amorphous silicates particularly in the zeolite-free compositions is preferably 1 to 10% by weight, which corresponds to a preferred embodiment of the invention.

Particularly preferred inorganic water-soluble builders are alkali metal carbonates and alkali metal bicarbonates, with sodium carbonate and potassium carbonate and in particular sodium carbonate being among the preferred forms. The content of the alkali metal carbonates in particular in zeolite-free compositions can vary within a very broad spectrum and is preferably 5 to 40% by weight, in particular 8 to 30% by weight, where the content of alkali metal carbonates is usually higher than that of (X-ray-)amorphous silicates.

Organic builder substances that can be used are, for example, the polycarboxylic acids, usable in the form of their alkali metal and in particular sodium salts, such as citric acid, adipic acid, succinic acid, glutaric acid, tartaric acid, sugar acids, aminocarboxylic acids, nitrilotriacetic acid (NTA), provided such use is not objectionable on ecological grounds, and also mixtures of these. Preferred salts are the salts of the polycarboxylic acids such as citric acid, adipic acid, succinic acid, glutaric acid, tartaric acid, sugar acids and mixtures of these. The acids per se may also be used. Besides their builder effect, the acids typically also have the property of an acidifying component and thus also serve, as for example in the granules according to the invention, to establish a lower and milder pH of detergents and cleaners. In this context, mention may be made in particular of citric acid, succinic acid, glutaric acid, adipic acid, gluconic acid and any desired mixtures thereof.

Also suitable as organic builders are polymeric polycarboxylates; these are, for example, the alkali metal salts of polyacrylic acid or of polymethacrylic acid, for example those with a relative molecular mass of from 500 to 70 000 g/mol. Within the meaning of this specification, the molar masses stated for polymeric polycarboxylates are weight-average molar masses Mw of the respective acid form, which have in principle been determined by means of gel permeation chromatography (GPC), using a UV detector. The measurement was made against an external polyacrylic acid standard which, on account of its structural similarity to the polymers investigated, provides realistic molecular weight values. These figures differ markedly from the molecular weight data obtained using polystyrenesulfonic acids as standard. The molar masses measured against polystyrenesulfonic acids are generally much higher than the molar masses stated in this specification.

The compositions according to the invention can also comprise polymers, in particular as supports for the perfume oils. Suitable polymers which can also be used as support substances in conjunction with fragrance include, in particular, polyacrylates, which preferably have a molecular mass of from 2000 to 20 000 g/mol. On account of their superior solubility, preference in this group may in turn be given to the short-chain polyacrylates which have molar masses of from 2000 to 10 000 g/mol, and particularly preferably from 3000 to 5000 g/mol.

Also of suitability are copolymeric polycarboxylates, especially those of acrylic acid with methacrylic acid and of acrylic acid or methacrylic acid with maleic acid. Copolymers of acrylic acid with maleic acid which comprise 50 to 90% by weight of acrylic acid and 50 to 10% by weight of maleic acid have proven particularly suitable. Their relative molecular mass, based on free acids, is generally from 2000 to 70 000 g/mol, preferably 20 000 to 50 000 g/mol and in particular 30 000 to 40 000 g/mol.

The content of organic builder substances in the compositions can vary within a broad spectrum. Preference is given to contents of from 2 to 20% by weight, where in particular contents of at most 10% by weight are particularly well received.

At this point, it may be pointed out that the % by weight figures refer in each case to the total composition unless stated otherwise.

The compositions according to the invention can have components from the classes of the graying inhibitors (soil carriers), the neutral salts and/or the textile-softening auxiliaries (for example cationic surfactants), which is preferred.

The function of graying inhibitors is to keep the soiling detached from the fiber suspended in the liquor and thus to prevent reattachment of the soiling. Of suitability for this purpose are water-soluble colloids, mostly organic in nature, for example the water-soluble salts of polymeric carboxylic acids, size, gelatin, salts of ether carboxylic acids or ether sulfonic acids of starch or of cellulose or salts of acidic sulfuric acid esters of cellulose or of starch. Water-soluble polyamides containing acid groups are also suitable for this purpose. Furthermore, it is possible to use soluble starch preparations and starch products other than those mentioned above, for example degraded starch, aldehyde starches etc. It is also possible to use polyvinylpyrrolidone. However, preference is given to using cellulose ethers, such as carboxymethylcellulose (Na salt), methylcellulose, hydroxyalkylcellulose and mixed ethers, such as methylhydroxyethylcellulose, methylhydroxypropyl-cellulose, methylcarboxymethylcellulose and mixtures thereof, and also polyvinypyrrolidone, for example in amounts of from preferably 0.1 to 5% by weight, based on the compositions.

A typical example of a suitable representative of the neutral salts is sodium sulfate. It can be used in amounts of, for example, 0 to 60% by weight, preferably 2 to 45% by weight.

Suitable softeners, which are described in more detail later on below, are, for example, swellable sheet silicates of the type of corresponding montmorillonites, for example bentonite, and also cationic surfactants.

The water content in the composition is governed inter alia by whether the composition is present in liquid or solid form, is therefore preferably 0 to less than 100% by weight and in particular 0.5 to 95% by weight, where values of at most 5% by weight, particularly in the case of solid or nonaqueous liquid compositions, are particularly preferred. In the case of solid compositions, these figures do not include the water adhering to any aluminosilicates present, such as zeolite.

In the case of liquid compositions, according to a preferred embodiment the composition according to the invention comprises water in an amount of more than 20% by weight, advantageously more than 30% by weight, in a further advantageous manner more than 40% by weight, yet more advantageously more than 50% by weight, in particular 60 to 95% by weight, particularly preferably 70 to 93% by weight and extremely preferably 80 to 90% by weight, based on the total composition.

Where it is a solid, the composition according to the invention may have excellent free-flow behavior. According to a preferred embodiment, the composition according to the invention is essentially in the form of a solid, preferably present in pulverulent, compressed or granular form.

If the composition is in particulate form, the particles can be aftertreated, for example by rounding the particles of the composition. Rounding may take place in a customary spheronizer. Preferably, the rounding time here is not longer than 4 minutes, in particular not longer than 3.5 minutes. Rounding times of at most 1.5 minutes or below are particularly preferred. Rounding achieves a further increase in the uniformity of the particle spectrum since any agglomerates formed are comminuted.

A composition according to the invention in particle form can be aftertreated in particular with nonionic surfactants, perfume oil and/or foam inhibitors or preparation forms which comprise these ingredients, preferably with amounts up to 20% by weight of active substance, in particular with amounts of from 2 to 18% by weight of active substance, in each case based on the aftertreated product, in a manner customary per se, preferably in a mixer or possibly a fluidized bed.

In particular, a composition according to the invention can likewise be powdered or aftertreated with solids, preferably in amounts up to 15% by weight, in particular in amounts of from 2 to 15% by weight, in each case based on the total weight of the aftertreated composition.

Solids that can be used for the aftertreatment are preferably bicarbonate, carbonate, zeolite, silica, citrate, urea or mixtures of these, in particular in amounts of from 2 to 15% by weight, based on the total weight of the aftetreated product. The aftertreatment can be carried out advantageously in a mixer and/or by means of spheronizers.

In a preferred embodiment of the invention, a composition according to the invention is aftertreated with nonionic surfactants, which may for example also comprise optical brighteners and/or hydrotropes, perfume, and/or a solution of optical brightener and/or foam inhibitors or preparation forms which can comprise these ingredients. Preferably, these ingredients or preparation forms which comprise these ingredients are applied in liquid, melted or paste form to the particulate composition which is to be aftertreated.

In this connection it is preferred for the aftertreatment with the substances specified here to take place in a customary mixer, merely for example in a twin-screw mixer, over the course of a maximum of 1 minute, preferably over the course of 30 seconds, and, for example, over the course of 20 seconds, the time indications simultaneously being for addition time and mixing time.

The nonionic surfactants are described in more detail below. These nonionic surfactants can be applied to the particulate compositions in an aftertreatment step. However, all nonionic surfactants can of course advantageously be directly present in the composition according to the invention, may be liquid or solid, or in the form of a foam or gel.

The nonionic surfactants used are preferably alkoxylated, advantageously ethoxylated, in particular primary alcohols having preferably 8 to 18 carbon atoms and, on average, 1 to 12 mol of ethylene oxide (EO) per mole of alcohol, in which the alcohol radical may be linear or, preferably, methyl-branched in position 2 and/or can contain linear and methyl-branched radicals in a mixture, as are customarily present in oxo alcohol radicals. In particular, however, preference is given to alcohol ethoxylates containing linear radicals from alcohols of native origin having 12 to 18 carbon atoms, e.g. from coconut, palm, palm kernel, tallow fatty or oleyl alcohol, and on average 2 to 8 EO per mole of alcohol. Preferred ethoxylated alcohols include, for example, C₁₂-C₁₄-alcohol containing 3 EO to 6 EO, C₉-C₁₁-alcohols containing 7 EO, C₁₃-C₁₅-alcohols containing 3 EO, 5 EO, 7 EO or 8 EO, C₁₄-C₁₅-alcohols containing 4 EO, 5 EO, 7 EQ or 9 EO, C₁₂-C₁₈-alcohols containing 3 EO, 5 EO or 7 EO, and mixtures thereof, such as mixtures of C₁₂-C₁₄-alcohol containing 3 EO and C₁₂-C₁₈-alcohol containing 7 EO. The stated degrees of ethoxylation represent statistical mean values, which for a specific product may be an integer or a fraction.

Preferred alcohol ethoxylates have a narrowed homolog distribution (narrow range ethoxylates, NREs). In addition to these nonionic surfactants it is also possible to use fatty alcohols containing more than 12 EO. Examples thereof are (tallow) fatty alcohols containing 14 EO, 16 EO, 20 EO, 25 EO, 30 EO or 40 EO.

Preferred nonionic surfactants are one or more unbranched or branched, saturated or unsaturated C₁₀₋₂₂-alcohols which are alkoxylated with ethylene oxide (EO) and/or propylene oxide (PO) and have a degree of alkoxylation of up to 30, preferably ethoxylated C₁₀₋₁₈-fatty alcohols having a degree of ethoxylation of less than 30, preferably 1 to 20, in particular 1 to 12, particularly preferably 1 to 8, exceptionally preferably 2 to 5, for example C₁₂₋₁₄-fatty alcohol ethoxylates with 2, 3 or 4 EO or a mixture of the C₁₂₋₁₄-fatty alcohol ethoxylates with 3 and 4 EO in a weight ratio of 1:1 or isotridecyl alcohol ethoxylate with 5, 8 or 12 EO.

Furthermore, further nonionic surfactants which can be used are also alkyl glycosides of the general formula RO(G)ₓ, in which R is a primary straight-chain or methyl-branched, in particular 2-methyl-branched, aliphatic radical having 8 to 22, preferably 12 to 18, carbon atoms, and G is the symbol representing a glycose unit having 5 or 6 carbon atoms, preferably glucose. The degree of oligomerization x, which indicates the distribution of monoglycosides and oligoglycosides, is any desired number from 1 to 10; preferably, x is 1.1 to 1.4.

A further class of preferably used nonionic surfactants, which are used either as the sole nonionic surfactant or in combination with other nonionic surfactants, in particular together with alkoxylated fatty alcohols and/or alkyl glycosides, are alkoxylated, preferably ethoxylated or ethoxylated and propoxylated fatty acid alkyl esters, preferably having 1 to 4 carbon atoms in the alkyl chain, in particular fatty acid methyl esters, particularly preferably C₁₂-C₁₈-fatty acid methyl esters with on average 3 to 15 EO, in particular with on average 5 to 12 EO.

Nonionic surfactants of the amine oxide type, for example N-cocoalkyl-N,N-dimethylamine oxide and N-tallowalkyl-N,N-dihydroxyethyl-amine oxide, and of the fatty acid alkanolamide type, may also be suitable. The amount of these nonionic surfactants is preferably not more than that of the ethoxylated fatty alcohols, in particular not more than half thereof.

Also suitable are alkoxylated amines, advantageously ethoxylated and/or propoxylated, in particular primary and secondary amines having preferably 1 to 18 carbon atoms per alkyl chain and on average 1 to 12 mol of ethylene oxide (EO) and/or 1 to 10 mol of propylene oxide (PO) per mole of amine.

In the case of compositions according to the invention which are suitable in particular for machine dishwashing, in particular dishwashing detergents in the form of tablet shaped bodies, such as tabs, suitable surfactants are in principle all surfactants. However, for this intended use, preference is given in particular to the nonionic surfactants described above and, of those, primarily to the low-foaming nonionic surfactants. Particular preference is given to the alkoxylated alcohols, particularly the ethoxylated and/or propoxylated alcohols. In this connection, the person skilled in the art generally takes alkoxylated alcohols to mean the reaction products of alkylene oxide, preferably ethylene oxide, with alcohols, preferably, for the purposes of the present invention, the relatively long-chain alcohols C₁₀ to C₁₈, preferably from C₁₂ to C₁₆, such as C11-, C₁₂—, C₁₃—, C₁₄—, C₁₅—, C₁₆—, C₁₇- and C₁₈-alcohols. As a rule, n mols of ethylene oxide and one mol of alcohol produce, depending on the reaction conditions, a complex mixture of addition products of varying degrees of ethoxylation. A further embodiment consists in the use of mixtures of the alkylene oxides, preferably of the mixture of ethylene oxide and propylene oxide. It is also possible, if desired, through a final etherification with short-chain alkyl groups, such as preferably the butyl group, to arrive at the substance class of the “capped” alcohol ethoxylates, which can likewise be used for the purposes of the invention. Very particular preference is given in this context, for the purposes of the present invention, to highly ethoxylated fatty alcohols or mixtures thereof with terminally capped fatty alcohol ethoxylates.

Advantageously, the compositions according to the invention can also comprise foam inhibitors, for example foam-inhibiting paraffin oil or foam-inhibiting silicone oil, for example dimethylpolysiloxane. The use of mixtures of these active ingredients is also possible. Suitable additives that are solid at room temperature, particularly in the case of the specified foam-inhibiting active ingredients, are paraffin waxes, silicas, which may also be hydrophobicized in a known manner, and bisamides derived from C₂₋₇-diamines and C₁₂₋₂₂-carboxylic acids.

Suitable foam-inhibiting paraffin oils preferred for use, which may also be present in admixture with paraffin waxes, are generally complex substance mixtures without a defined melting point. For characterization, the melting range is usually determined by means of differential thermoanalysis (DTA) and/or the solidification point. This is understood as meaning the temperature at which the paraffin undergoes the transition from the liquid state to the solid state by slow cooling. Paraffins with fewer than 17 carbon atoms cannot be used according to the invention, and their fraction in the paraffin oil mixture should therefore be as low as possible, and is preferably below the limit which can be measured significantly using customary analytical methods, for example gas chromatography. Preference is given to using paraffins which solidify in the range from 20° C. to 70° C. In this connection, it should be taken into consideration that even paraffin wax mixtures that appear solid at room temperature can contain different fractions of liquid paraffin oils. In the case of the paraffin waxes which can be used in accordance with the invention, the liquid fraction at 40° C. is as high as possible, without already amounting to 100% at this temperature. Preferred paraffin wax mixtures have at 40° C. a liquid fraction of at least 50% by weight, in particular of from 55% by weight to 80% by weight, and at 60° C. have a liquid fraction of at least 90% by weight. Consequently, the paraffins are flowable and pumpable at temperatures down to at least 70° C., preferably down to at least 60° C. Furthermore, it should be ensured that the paraffins as far as possible contain no volatile fractions. Preferred paraffin waxes contain less than 1% by weight, in particular less than 0.5% by weight, of fractions which can be evaporated at 110° C. under atmospheric pressure. Paraffins that can be used according to the invention can be acquired, for example, under the tradenames Lunaflex® from Fuller and Deawax® from DEA Mineralöl AG.

The paraffin oils can comprise bisamides that are solid at room temperature and are derived from saturated fatty acids having 12 to 22, preferably 14 to 18, carbon atoms and also from alkylenediamines having 2 to 7 carbon atoms. Suitable fatty acids are lauric acid, myristic acid, stearic acid, arachidic acid and behenic acid, and also mixtures thereof, as are obtainable from natural fats or hydrogenated oils, such as tallow or hydrogenated palm oil. Suitable diamines are, for example, ethylenediamine, 1,3-propylene-diamine, tetramethylenediamine, pentamethylenediamine, hexamethylene-diamine, p-phenylenediamine and tolylenediamine. Preferred diamines are ethylenediamine and hexamethylenediamine. Particularly preferred bisamides are bismyristoylethylenediamine, bispalmitoylethylenediamine, bistearoyl-ethylenediamine and mixtures thereof, and also the corresponding derivatives of hexamethylenediamine.

The products according to the invention can preferably be mixed with further constituents, in particular of washing, care and/or cleaning compositions or cosmetic ingredients. It is generally known from the broad prior art which ingredients of washing or cleaning compositions and which raw materials can usually also be admixed. These are, for example substances such as bleaches, bleach activators and/or bleach catalysts, enzymes, temperature-sensitive dyes etc., which may of course also be present directly in the composition.

The composition can preferably have UV absorbers, which advantageously attach to the treated textiles and improve the photostability of the fibers and/or the photostability of other formulation constituents. UV absorbers are understood as meaning organic substances (photoprotective filters) which are able to absorb ultraviolet rays and to emit the absorbed energy again in the form of radiation of longer wavelength, e.g. heat. Compounds which have these desired properties are, for example, the compounds and derivatives of benzophenone, which are active by radiationless deactivation, and have substituents in position 2 and/or 4. Also suitable are, furthermore, substituted benzotriazoles, acrylates phenyl-substituted in position 3 (cinnamic acid derivatives), with or without cyano groups in position 2, salicylates, organic Ni complexes, and natural substances such as umbelliferone and the endogenous urocanic acid. Of particular importance are biphenyl derivatives and, in particular, stilbene derivatives, commercially available as Tinosorb® FD or Tinosorb® FR from: Ciba. UV-B absorbers to be mentioned are 3-benzylidenecamphor or 3-benzylidenenorcamphor and derivatives thereof, e.g. 3-(4-methylbenzylidene)camphor; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylenes); esters of salicylic acid, preferably 2-ethylhexyl salicylate, 4-isopropylbenzyl salicylate, homomethyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzaylmalonic acid, preferably di-2-ethylhexyl 4-methoxybenz-malonate; triazine derivatives, such as, for example, 2,4,6-trianilino(p-carbo-2′-ethyl-1′-hexyloxy-1,3,5-triazine and octyltriazone, or d ioctylbutamidotriazone (Uvasorb® HEB); propane-1,3-diones, such as, for example, 1-(4-tert-butylphenyl)-3-(4′-methoxyphenyl)propane-1,3-dione; ketotricyclo(5.2.1.0)-decane derivatives. Of further suitability are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, such as, for example, 4-(2-oxo-3-bornylidenemethyl)benzenesulfonic acid and 2-methyl-5-(2-oxo-3-bornylidene)sulfonic acid and salts thereof.

Suitable typical UV-A filters are, in particular, derivatives of benzoylmethane, such as, for example, 1-(4′-tert-butylphenyl)-3-(4′-methoxy-phenyl)propane-1,3-dione, 4-tert-butyl-4″methoxydibenzoylmethane (Parsol 1789), 1-phenyl-3-(4′-isopropylphenyl)propane-1,3-dione, and enamine compounds. The UV-A and UV-B filters can of course also be used in mixtures. Besides the specified soluble substances, insoluble photoprotective pigments are also suitable for this purpose, namely finely disperse, preferably nanoized metal oxides and/or salts. Examples of suitable metal oxides are, in particular, zinc oxide and titanium dioxide and, in addition, oxides of iron, zirconium, silicon, manganese, aluminum and cerium, and also mixtures thereof. Salts which can be used are silicates (talc), barium sulfate or zinc stearate. The oxides and salts are already used, in the form of a pigment, for skin care and skin-protecting emulsions and decorative cosmetics. The particles should have an average diameter of less than 100 nm, preferably of from 5 to 50 nm and in particular from 15 to 30 nm. They may have a spherical form, although it is also possible to use particles which have an ellipsoidal shape or a shape which deviates in some other way from the spherical. The pigments can also be in surface-treated form, i.e. hydrophilized or hydrophobicized. Typical examples are coated titanium dioxides, such as, for example, titanium dioxide T 805 (Degussa) or Eusolex® T2000 (Merck). Suitable hydrophobic coating compositions here are primarily silicones and specifically trialkoxyoctylsilanes or simethicones. Preferably, micronized zinc oxide is used. Further suitable UV photoprotective filters can be found in the relevant prior art.

The UV absorbers can advantageously be present in the composition in amounts of from 0.01% by weight to 5% by weight, preferably from 0.03% by weight to 1% by weight. They can also be admixed to the composition subsequently, for example together with other substances.

The compositions according to the invention can preferably, where they are solid, also be in the form of tablets or shaped bodies. For the purposes of the present application, “tablets” or “shaped bodies” are the terms used to refer to dimensionally stable, solid bodies, irrespective of the nature of their production. Bodies of this kind can be produced, for example, by crystallization, casting, injection molding, reactive or thermal sintering, (co)extrusion, prilling, pelletizing, or compacting methods such as calandering or tableting. The production of the “tablets” or “shaped bodies” by tableting is particularly preferred within the scope of the present application. The tablet thus preferably consists of compressed, particulate material.

Compositions according to the invention in solid form, preferably in the form of tablets or shaped bodies, can preferably comprise disintegration auxiliaries. Suitable swellable disintegration auxiliaries are, for example, bentonites or other swellable silicates. Synthetic polymers, in particular the crosslinked polyvinylpyrrolidone or the superabsorbents that are used in the hygiene sector, can also be used.

Polymers based on starch and/or cellulose are particularly advantageously used as swellable disintegration auxiliaries. These base substances can be processed on their own or in a mixture with further natural and/or synthetic polymers to give swellable disintegrants. In the simplest case, a cellulosic material or pure cellulose can be converted by granulation, compaction or other application of pressure into secondary particles, which, upon contact with water, swell and thus serve as disintegrants. Cellulose material that has proven useful is wood pulp, which is obtainable by thermal or chemothermal methods from wood or wood chips (sawn chips, sawhouse wastes). This cellulose material from the TMP process (thermomechanical pulp) or the CTMP process (chemothermo mechanical pulp) can then be compacted by application of pressure, preferably roll-compacted, and converted to particle form. In exactly the same way it is of course also possible to use pure cellulose, although this is more expensive owing to its raw material basis. In that case it is possible to use both microcrystalline and also amorphous, finely divided cellulose and mixtures thereof.

Another way consists in granulating the cellulosic material with the addition of granulation auxiliaries. Granulation auxiliaries that have proven useful are, for example, solutions of synthetic polymers or nonionic surfactants. In order to avoid residues on textiles washed with the compositions according to the invention, the primary fiber length of the cellulose used or of the cellulose in the cellulosic material should be below 200 μm, preference being given to primary fiber lengths below 100 μm, in particular below 50 μm.

The secondary particles ideally have a particle size distribution in which preferably more than 90% by weight of the particles have sizes above 200 μm. A certain dust fraction can contribute to improved storage stability of the thus-produced tablets. Amounts of a fine dust fraction of less than 0.1 mm up to 10% by weight, preferably up to 8% by weight, may be present in the compositions used according to the invention containing disintegrant granules.

Furthermore, the compositions according to the invention can be in the form of a conditioning composition and/or conditioning substrate and comprise the corresponding components. For the purposes of this invention, the term conditioning is preferably to be understood as meaning the finishing treatment of textiles, substances and fabrics. The conditioning gives the textiles positive properties, such as, for example, an improved soft hand, increased gloss and color brilliance, an improved scent impression, reduction in felting, greater ease of ironing through a reduction in slip properties, a reduction in creasing and in static charging, and also inhibition of color transfer in the case of dyed textiles.

Compositions according to the invention, in particular conditioning compositions, can, for example, comprise polymerizable betaine esters of the general formula (I):

[R^{a}—X—(CH₂)ₖ—NR^{b}R^{c}—(CR^{d}R^{e})ₗ—(C═O)—O—(R^{f}—O)ₘ—R^{g}]⁽⁺⁾A⁽⁻⁾ (I)

in which
R^{a} is an ethylenically unsaturated radical containing at least one carbonyl function, such as, for example, acryloyl, methacryloyl, maleoyl or itaconoyl;
X is an oxygen atom, —N(CH₃)— or —NH—;
R^{b}, R^{c} independently of one another are unbranched or branched alkyl radicals having 1 to 4 carbon atoms, and may contain heteroatom substituents, in particular O, S, N, P;
the radicals
R^{d}. R^{e} are selected independently of one another from hydrogen (H), optionally branched alkyl radicals having 1 to 4 carbon atoms, optionally substituted aryl or benzyl radicals, and —CH₂COOH, —CH₂COOR,
—CH₂CH₂COOH, —CH₂CH₂COOR; where R is linear or branched and/or cyclic and/or substituted hydrocarbon radicals which optionally contain multiple bonds, contain halogen atoms and/or heteroatoms and/or carbonyl groups, and have 1 to 18 carbon atoms, or else R is a polyether composed exclusively of ethylene oxide or propylene oxide or butylene oxide or styrene oxide;
R^{f} is a branched and/or substituted and/or cyclic hydrocarbon radical which optionally contains multiple bonds and has 1 to 10, preferably 2 or 3, carbon atoms, or is a styrene radical or is composed exclusively of ethylene or propylene or butylene or styrene radicals, or is a block copolymer or random copolymer containing said radicals;
R^{g} is an optionally branched, optionally cyclic hydrocarbon radical which optionally contains double bonds and has 1 to 22 carbon atoms, where R^{g} is an optionally branched hydrocarbon radical that optionally contains double bonds when m=0 and R^{g} may be H when m>0;
k, l independently of one another are 1 to 4, where k is preferably 2 or 3 and l is preferably 1; and
m has a value between 0 and 100, preferably 0 to 40;
A⁽⁻⁾ is an anion; and/or homopolymers prepared from polymerizable betaine esters of the general formula (I), and copolymers prepared from polymerizable betaine esters of the general formula (I) and suitable comonomers of the general formula (II).

R^{w}R^{z}C═CR^{x}R^{y} (III)

in which
R^{x} and R^{y} are H,
R^{w} is H or CH₃ and
R^{z} is a radical containing at least one carbonyl group, such as, for example, —C(O)OR, —C(O)NR′R″, where R, R′ and R″ are H or linear or branched and/or cyclic and/or substituted hydrocarbon radicals which optionally contain multiple bonds, contain halogen atoms and/or heteroatoms and/or carbonyl groups, and have 1 to 18 carbon atoms; or in which
R^{w} and R^{x} are H,
R^{y} and R^{z} are radicals containing a carbonyl group, such as, for example —C(O)OR, —C(O)NR′R″, where R, R′ and R″ are H or linear or branched and/or cyclic aliphatic or aromatic and/or substituted hydrocarbon radicals which optionally contain multiple bonds, and contain halogen atoms and/or heteroatoms and have 1 to 18 carbon atoms;
or in which
R^{w}, R^{x} and R^{y} are H and
R^{z} is an aromatic or heteroaromatic that is optionally halogen atom-substituted and/or heteroatom-substituted and contains linear and/or branched alkyl substituents;
or in which
R^{w}, R^{x} and R^{y} are H and
R^{z} is —(CH₂)ₐ—OR^{III}, where R^{III} is H or an alkyl radical optionally containing carbonyl groups and having 1 to 22 carbon atoms, or a polyether composed exclusively of ethylene or propylene or butylene or styrene oxide and represents a block copolymer or random copolymer containing said radicals, and a is 0 or 1.

The aforementioned polymerizable betaine esters of the formula (I) and/or the polymeric betaine esters, which in the case of the homopolymers are prepared from the monomeric polymerizable betaine esters of the general formula (I) and/or in the case of the copolymers are prepared from polymerizable betaine esters of the general formula (I) and suitable comonomers of the general formula (II), can preferably be used in conditioning compositions according to the invention. Particularly stable, and therefore likewise preferable for use as conditioning composition, are the polymerizable betaine esters of the general formula (I) and/or the polymeric betaine esters, which in the case of the homopolymers are prepared from the monomeric polymerizable betaine esters of the general formula (I) and/or in the case of the copolymers are prepared from polymerizable betaine esters of the general formula (I) and suitable comonomers of the general formula (II), for which X is —N(CH₃)— or —NH—.

Preferably, the compositions according to the invention, in particular conditioning compositions, can comprise oligomers and polymers prepared by copolymerization of from 0.5 to 100 mol % of a polymerizable betaine ester of the general formula (I) (at 100 mol % the compounds in question are homopolymers) and from 0 to 99.5 mol % of an ethylenically unsaturated comonomer of the general formula (II), preferably prepared by copolymerization of from 20 to 70 mol % of a polymerizable betaine ester of the general formula (I), and from 30 to 80 mol % of an unsaturated comonomer of the general formula (II), particularly preferably prepared by copolymerization of from 40 to 60 mol % of a polymerizable betaine ester of the general formula (I), and from 60 to 40 mol % of an ethylenically unsaturated comonomer of the general formula (II). Homopolymers prepared from polymerizable betaine esters of the formula (I) are exceptionally preferably used in the compositions according to the invention. The homopolymers offer the advantage that they carry a higher content of esterified active alcohols and, additionally, exhibit improved attachment behavior and thus improved textile-conditioning properties, such as soft fabric hand. Where X=—N(CH₃)— or —NH—, moreover, the polymers exhibit particularly good stability to hydrolysis, leading to a desired slow, i.e. delayed, release of the esterified fragrances. Homopolymers in which k=3 are particularly advantageous. Polymerizable betaine esters of the formula (I) and polymeric betaine esters preparable therefrom that have proven particularly useful are those in which m=0 and R^{g} is a fragrance alcohol.

Compositions according to the invention, in particular conditioning compositions, can comprise polymerizable betaine esters of the formula (I) and/or polymeric betaine esters, which in the case of the homopolymers are prepared from the monomeric polymerizable betaine esters of the general formula (I) and/or in the case of the copolymers are prepared from polymerizable betaine esters of the general formula (I) and suitable comonomers of the general formula (II), in which R^{g} is an aromatic fragrance alcohol. Particularly preferred fragrance alcohols are therefore phenylethanol, phenoxyethanol, 2-phenylpropanol, 3-phenylpropanol, α-methylbenzyl alcohol, amyl salicylate, benzyl alcohol, benzyl salicylate, butyl salicylate, cyclohexyl salicylate, dimethylbenzylcarbinol, ethyl salicylate, ethylvanillin, eugenol, hexyl salicylate, isoeugenol, phenol, phenyl salicylate, thymol, vanillin, cinnamyl alcohol and 3-methyl-4-phenyl-1-pentanol.

However, the aforementioned selection does not represent any restriction with regard to the aromatic fragrance alcohols that are suitable.

Compositions according to the invention, in particular conditioning compositions, can advantageously have a pH of less than or equal to 8, preferably less than 7, particularly preferably between 1 and 6 and in particular between 2 and 5.

In a preferred embodiment, the conditioning compositions according to the invention can additionally comprise surfactants. The additional use of surfactants has the effect of reinforcing the conditioning properties and, moreover, contributes to improved storage stability and dispersibility or emulsifiability of the individual components of the conditioning composition.

In order to improve the soft hand and the finishing properties, the compositions according to the invention can have softener components. Examples of such compounds are quaternary ammonium compounds, cationic polymers and emulsifiers, as are used in haircare compositions and also in compositions for textile finishing. These softening compounds, which are also described in more detail below, can be present in all compositions according to the invention, but in particular in the conditioning compositions and in compositions aiming to achieve a softening effect.

Suitable examples are quaternary ammonium compounds of the formulae (III) and (IV):

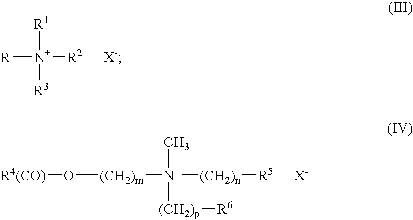

where, in (III), R and R¹ are an acyclic alkyl radical having 12 to 24 carbon atoms, R² is a saturated C₁-C₄-alkyl or hydroxyalkyl radical, R³ is either R, R¹ or R² or is an aromatic radical. X⁻ is either a halide, methosulfate, methophosphate or phosphate ion and mixtures thereof. Examples of cationic compounds of the formula (III) are didecyldimethylammonium chloride, ditallowedimethylammonium chloride or dihexadecylammonium chloride.

Compounds of the formula (IV) are so-called ester quats. Ester quats are characterized by excellent biodegradability. Here, R⁴ is an aliphatic alkyl radical having 12 to 22 carbon atoms with 0, 1, 2 or 3 double bonds; R⁵ is H, OH or O(CO)R⁷, R⁶ is, independently of R⁵, H, OH or O(CO)R⁸, where R⁷ and R⁸, independently of one another, are each an aliphatic alk(en)yl radical having 12 to 22 carbon atoms with 0, 1, 2 or 3 double bonds. m, n and p can each, independently of one another, have the value 1, 2 or 3. X⁻ can either be a halide, methosulfate, methophosphate or phosphate ion and mixtures thereof. Preference is given to compounds which contain the group O(CO)R⁷ for R⁸, and alkyl radicals having 16 to 18 carbon atoms for R⁴ and R⁷. Particular preference is given to compounds in which R⁶ is additionally OH. Examples of compounds of the formula (IV) are methyl-N-(2-hydroxyethyl)-N,N-di(tallow-acyloxyethyl)ammonium methosulfate, bis(palmitoyl)ethyl-hydroxyethylmethylammonium methosulfate or methyl-N,N-bis(acyloxyethyl)-N-(2-hydroxyethyl)ammonium methosulfate. If quaternized compounds of the formula (IV) which have unsaturated alkyl chains are used, preference is given to the acyl groups whose corresponding fatty acids have an iodine number between 5 and 80, preferably between 10 and 60 and in particular between 15 and 45 and which have a cisitrans isomer ratio (in % by weight) greater than 30:70, preferably greater than 50:50 and in particular greater than 70:30. Standard commercial examples are the methylhydroxyalkyldialkoyloxy-alkylammonium methosulfates sold by Stepan under the tradename Stepantex®, or the products from Cognis known under Dehyquart®, or the products from Goldschmidt-Witco known under Rewoquat®. Further preferred compounds are the diester quats of the formula (V) which are available under the name Rewoquat® W 222 LM or CR 3099 and, besides the softness, also ensure stability and color protection.

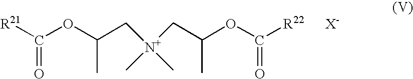

R²¹ and R²² here are, independently of one another, each an aliphatic radical having 12 to 22 carbon atoms with 0, 1, 2 or 3 double bonds. Besides the above-described quaternary compounds, it is also possible to use other known compounds, such as, for example, quaternary imidazolinium compounds of the formula (VI),

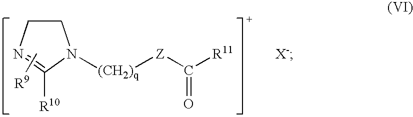

where R⁹ is H or a saturated alkyl radical having 1 to 4 carbon atoms, R¹⁰ and R¹¹, independently of one another, are each an aliphatic, saturated or unsaturated alkyl radical having 12 to 18 carbon atoms, R¹⁰ may alternatively also be O(CO)R²⁰, where R²⁰ is an aliphatic, saturated or unsaturated alkyl radical having 12 to 18 carbon atoms, and Z is an NH group or oxygen and X⁻ is an anion. q can assume integral values between 1 and 4.

Further suitable quaternary compounds are described by formula (VII)

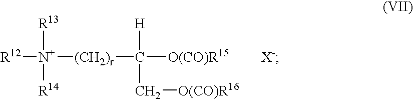

where R¹², R¹³ and R¹⁴, independently of one another, are a C₁₋₄-alkyl, alkenyl or hydroxyalkyl group, R¹⁵ and R¹⁶ are each, selected independently, a C₈₋₂₈-alkyl group and r is a number between 0 and 5.

Besides the compounds of the formulae (III) and (IV), short-chain, water-soluble, quaternary ammonium compounds can also be used, such as trihydroxyethylmethylammonium methosulfate or the alkyltrimethylammonium chlorides, dialkyldimethylammonium chlorides and trialkylmethylammonium chlorides, e.g. cetyltrimethylammonium chloride, stearyltrimethylammonium chloride, distearyldimethylammonium chloride, lauryldimethylammonium chloride, lauryldimethylbenzylammonium chloride and tricetylmethylammonium chloride.

Protonated alkylamine compounds which have a softening effect, and the nonquaternized, protonated precursors of the cationic emulsifiers, are also suitable.

Further cationic compounds which can be used according to the invention are the quaternized protein hydrolyzates.

Suitable cationic polymers include the polyquaternium polymers, as specified in the CTFA Cosmetic Ingredient Dictionary (The Cosmetic, Toiletry and Fragrance, Inc., 1997), in particular the polyquaternium-6, polyquaternium-7, polyquaternium-10 polymers (Ucare polymer IR 400; Amerchol), also referred to as merquats, polyquaternium-4 copolymers, such as graft copolymers with a cellulose backbone and quaternary ammonium groups which are bonded via allyldimethylammonium chloride, cationic cellulose derivatives, such as cationic guar, such as guar hydroxypropyl-triammonium chloride, and similar quaternized guar derivatives (e.g. cosmedia guar, manufacturer: Cognis GmbH), cationic quaternary sugar derivatives (cationic alkyl polyglucosides), e.g. the commercial product Glucquat®100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g. Luviquat Care from BASF) and also cationic biopolymers based on chitin, and derivatives thereof, for example the polymer obtainable under the tradename Chitosan® (manufacturer: Cognis).

According to the invention, it is likewise possible to use cationic silicone oils, such as, for example, the commercially available products Q2-7224 (manufacturer: Dow Corning; a stabilized trimethylsilylamodimethicone), Dow Corning 929 emulsion (comprising a hydroxylamino-modified silicone, which is also referred to as amodimethicone), SM-2059 (manufacturer: General Electric), SLM-55067 (manufacturer: Wacker) Abil®-Quat 3270 and 3272 (manufacturer: Goldschmidt-Rewo; diquaternary polydimethylsiloxanes, quaternium-80), and Siliconquat Rewoquat® SQ 1 (Tegopren® 6922, manufacturer: Goldschmidt-Rewo).

It is likewise possible to use compounds of the formula (VIII),

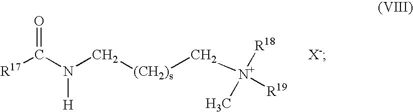

which may be alkylamidoamines in their nonquaternized form or, as shown, their quaternized form. R¹⁷ may be an aliphatic alk(en)yl radical having 12 to 22 carbon atoms with 0, 1, 2 or 3 double bonds. s can assume values between 0 and 5. R¹⁸ and R¹⁹, independently of one another are each H, C₁₋₄-alkyl or hydroxyalkyl. Preferred compounds are fatty acid amidoamines, such as the stearylamidopropyldimethylamine obtainable under the name Tego Amid®S 18, or the 3-tallowamidopropyltrimethylammonium methosulfate obtainable under the name Stepantex® X 9124, which are characterized not only by a good conditioning effect but also by color-transfer-inhibiting effect and in particular by their good biodegradability.

Particular preference is given to alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methoxsulfate.

Suitable nonionic softeners are primarily polyoxyalkylene glycerol alkanoates, polybutylene, long-chain fatty acids, ethoxylated fatty acid ethanolamides, alkyl polyglycosides, in particular sorbitan mono-, di- and triesters, and fatty acid esters of polycarboxylic acids.

In a composition according to the invention, preferably conditioning composition, softeners may be present in amounts of from 0.1 to 80% by weight, usually 0.1 to 70% by weight, preferably 0.2 to 60% by weight and in particular 0.5 to 40% by weight, in each case based on the total composition.

Conditioning compositions according to the invention can preferably comprise one or more anionic surfactants, in particular those which have already been described above.

Conditioning compositions according to the invention can preferably comprise one or more nonionic surfactants, in particular those which have already been described above.

Suitable further surfactants for all of the compositions according to the invention, in particular for the conditioning compositions, are so-called gemini surfactants. These are generally understood as meaning those compounds which have two hydrophilic groups and two hydrophobic groups per molecule. These groups are generally separated from one another by a so-called spacer. This spacer is usually a carbon chain which should be long enough for the hydrophilic groups to be adequately spaced so that they can function independently of one another. Such surfactants are generally characterized by an unusually low critical micelle concentration and the ability to greatly reduce the surface tension of water. In exceptional cases, however, the expression gemini surfactants is understood as meaning not only dimeric surfactants, but also trimeric surfactants.

Suitable gemini surfactants are, for example, sulfated hydroxy mixed ethers or dimer alcohol bis- and trimer alcohol tris-sulfates and ether sulfates. Terminally capped dimeric and trimeric mixed ethers are characterized in particular by their bi- and multifunctionality. Thus, said terminally capped surfactants have good wetting properties and are low-foam, meaning that they are suitable in particular for use in machine washing or cleaning processes.

However, it is also possible to use gemini polyhydroxy fatty acid amides or poly-polyhydroxy fatty acid amides, as described in the relevant prior art.

Further suitable surfactants are polyhydroxy fatty acid amides of the following formula,

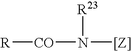

in which RCO is an aliphatic acyl radical having 6 to 22 carbon atoms, R²³ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the following formula:

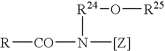

in which R is a linear or branched alkyl or alkenyl radical having 7 to 12 carbon atoms, R²⁴ is a linear, branched or cyclic alkyl radical or an aryl radical having 2 to 8 carbon atoms and R²⁵ is a linear, branched or cyclic alkyl radical or an aryl radical or an oxyalkyl radical having 1 to 8 carbon atoms, where C₁₋₄-alkyl or phenyl radicals are preferred and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can then be converted to the desired polyhydroxy fatty acid amides, for example by reaction with fatty acid methyl esters in the presence of an alkoxide as catalyst.

The compositions according to the invention preferably also comprise amphoteric surfactants. Besides numerous mono- to trialkylated amine oxides, the betaines represent a significant class.

Betaines are known surfactants prepared predominantly by carboxyalkylation, preferably carboxymethylation, of aminic compounds. Preferably, the starting materials are condensed with halocarboxylic acids or salts thereof, in particular with sodium chloroacetate, where one mol of salt is formed per mole of betaine. A further possibility is the addition reaction of unsaturated carboxylic acids, such as, for example, acrylic acid. As regards nomenclature and especially to differentiate between betaines and “true” amphoteric surfactants, reference is made to the relevant technical literature. Examples of suitable betaines are the carboxyalkylation products of secondary and in particular tertiary amines which conform to the formula (IX),

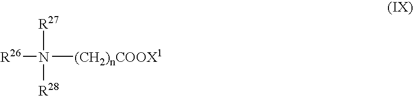

in which R²⁶ is an alkyl and/or alkenyl radical having 6 to 22 carbon atoms, R²⁷ is hydrogen or alkyl radicals having 1 to 4 carbon atoms, R²⁸ is alkyl radicals having 1 to 4 carbon atoms, n is numbers from 1 to 6 and X¹ is an alkali metal and/or alkaline earth metal or ammonium. Typical examples are the carboxymethylation products of hexylmethylamine, hexyldimethylamine, octyldimethylamine, decyldimethylamine, dodecylmethylamine, dodecyl-dimethylamine, dodecylethylmethylamine, C_{12/14}-cocoalkyldimethylamine, myristyidimethylamine, cetyldimethylamine, stearyldimethylamine, stearyl-ethylmethylamine, oleyldimethylamine, C_{16/18}-tallowalkyldimethylamine, and their technical mixtures.

Also suitable, furthermore, are carboxyalkylation products of amidoamines which conform to the formula (X),

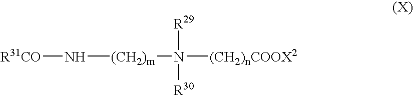

in which R³¹CO is an aliphatic acyl radical having 6 to 22 carbon atoms and 0 or 1 to 3 double bonds, m is numbers from 1 to 3 and R²⁹, R³⁰, n and X² have the meanings given above. Typical examples are reaction products of fatty acids having 6 to 22 carbon atoms, namely caproic acid, caprylic acid, capric acid, lauric acid, myristic acid, palmitic acid, palmoleic acid, stearic acid, isostearic acid, oleic acid, elaidic acid, petroselic acid, linoleic acid, linolenic acid, elaeostearic acid, arachidic acid, gadoleic acid, behenic acid and erucic acid, and technical mixtures thereof, with N,N-dimethylaminoethylamine, N,N-dimethylaminopropylamine, N,N-diethylaminoethylamine and N,N-diethyl-aminopropylamine, which are condensed with sodium chloroacetate. The use of a condensation product of C_{8/18}-coconut fatty acid-N,N-dimethylamino-propylamide with sodium chloroacetate is preferred.

Also suitable as appropriate starting materials for the betaines which can be used for the purposes of the invention are imidazolines that conform to the formula (XI),

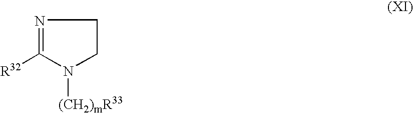

in which R³² is an alkyl radical having 5 to 21 carbon atoms, R³³ is a hydroxyl group, an OCOR³² or NHCOR³² radical and m is 2 or 3. These substances too are known substances which can be obtained, for example, by cyclizing condensation of 1 or 2 mol of fatty acid with polyfunctional amines, such as aminoethylethanolamine (AEEA) or diethylenetriamine. The corresponding carboxyalkylation products are mixtures of different open-chain betaines. Typical examples are condensation products of the abovementioned fatty acids with AEEA, preferably imidazolines based on lauric acid or, again, C_{12/14}-coconut fatty acid, which are then betainized with sodium chloroacetate.

In a preferred embodiment, the compositions according to the invention are present in liquid form, for example in the form of conditioning compositions or liquid detergents etc. To achieve a liquid consistency, the use both of liquid organic solvents, and also that of water may be appropriate. The compositions according to the invention therefore optionally comprise solvents.

Solvents which can be used in the compositions according to the invention originate, for example, from the group of mono- or polyhydric alcohols, alkanolamines or glycol ethers, provided they are miscible with water in the stated concentration range. Preferably, the solvents are selected from ethanol, n- or isopropanol, butanols, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, butoxypropoxypropanol (BPP), dipropylene glycol monomethyl or monoethyl ether, diisopropylene glycol monomethyl or monoethyl ether, methoxy, ethoxy or butoxy triglycol, 1-butoxyethoxy-2-propanol, 3-methyl-3-methoxybutanol, propylene glycol t-butyl ether, and mixtures of these solvents.

Some glycol ethers are available under the tradenames Arcosolv® (Arco Chemical Co.) or Cellosolve®, Carbitol® or Propasol® (Union Carbide Corp.); these also include, for example, ButylCarbitol®, HexylCarbitol®, MethylCarbitol®, and Carbitol® itself, (2-(2-ethoxy)ethoxy)ethanol. The choice of glycol ether can readily be made by the person skilled in the art on the basis of its volatility, solubility in water, its percentage by weight of the overall dispersion and the like. Pyrrolidone solvents, such as N-alkylpyrrolidones, for example N-methyl-2-pyrrolidone or N—C₈-C₁₂-alkylpyrrolidone, or 2-pyrrolidone, can likewise be used. Also preferred as the sole solvents or as a constituent of a solvent mixture are glycerol derivatives, in particular glycerol carbonate.

The alcohols which can be used in the present invention preferably as cosolvents include liquid polyethylene glycols, with a low molecular weight, for example polyethylene glycols with a molecular weight of 200, 300, 400 or 600. Further suitable cosolvents are other alcohols, for example (a) lower alcohols, such as ethanol, propanol, isopropanol and n-butanol, (b) ketones, such as acetone and methyl ethyl ketone, (c) C₂-C₄-polyols, such as a diol or a triol, for example ethylene glycol, propylene glycol, glycerol or mixtures thereof. From the class of diols, particular preference is given to 1,2-octane-diol.

In a preferred embodiment, the composition according to the invention comprises one or more solvents from the group comprising C₁- to C₄-monoalcohols, C₂- to C₆-glycols, C₃- to C₁₂-glycol ethers and glycerol, in particular ethanol. The C₃- to C₁₂-glycol ethers according to the invention contain alkyl or alkenyl groups having fewer than 10 carbon atoms, preferably up to 8, in particular up to 6, particularly preferably 1 to 4 and exceptionally preferably 2 to 3, carbon atoms.

Preferred C₁- to C₄-monoalcohols are ethanol, n-propanol, isopropanol and tert-butanol. Preferred C₂- to C₆-glycols are ethylene glycol, 1,2-propylene glycol, 1,3-propylene glycol, 1,5-pentanediol, neopentyl glycol and 1,6-hexanediol, in particular ethylene glycol and 1,2-propylene glycol. Preferred C₃- to C₁₋₂-glycol ethers are di-, tri-, tetra- and pentaethylene glycol, di-, tri- and tetrapropylene glycol, propylene glycol monotertiary-butyl ether and propylene glycol monoethyl ether, and the solvents referred to according to INCI as butoxydiglycol, butoxyethanol, butoxyisopropanol, butoxypropanol, butyloctanol, ethoxydiglycol, ethoxyethanol, ethyl hexanediol, isobutoxypropanol, isopentyldiol, 3-methoxybutanol, methoxyethanol, methoxyisopropanol and methoxymethylbutanol.

The composition according to the invention, preferably conditioning composition or liquid detergent, can comprise one or more solvents in an amount of usually up to 40% by weight, preferably 0.1 to 30% by weight, in particular 2 to 20% by weight, particularly preferably 3 to 15% by weight, exceptionally preferably 5 to 12% by weight, for example 5.3 or 10.6% by weight, in each case based on the total composition.

In a preferred embodiment, the composition according to the invention, such as, in particular, the conditioning composition, can optionally comprise one or more complexing agents.

Complexing agents (INCI Chelating Agents), also called sequestrants, are ingredients which are able to complex and deactivate metal ions, for example in order to prevent their disadvantageous effects on the stability or the appearance of the composition, for example turbidity. On the one hand, it is important to complex calcium and magnesium ions of water hardness which are incompatible with numerous ingredients. The complexation of the ions of heavy metal such as iron or copper delays the oxidative decomposition of the finished compositions.

Of suitability are, for example, the following complexing agents named in accordance with INCI, which, for example, are described in more detail in the International Cosmetic Ingredient Dictionary and Handbook: Aminotrimethylene Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, sodium EDTMP, Sodium Gluceptate, Sodium Gluconate, Sodium glycereth-1 Polyphosphate, Sodium Hexametaphosphate, Sodium Metaphosphate, Sodium Metasilicate, Sodium Phytate, Sodium Polydimethylglycinophenol-sulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Preferred complexing agents are tertiary amines, in particular tertiary alkanolamines (amino alcohols). The alkanolamines have both amino and also hydroxy and/or ether groups as functional groups. Particularly preferred tertiary alkanolamines are triethanolamine and tetra-2-hydroxypropylethylenediamine (N,N,N′,N′-tetrakis(2-hydroxypropyl)ethylene-diamine). Particularly preferred combinations of tertiary amines with zinc ricinoleate and one or more ethoxylated fatty alcohols as nonionic solubility promoters and optionally solvents are described in the prior art.

A particularly preferred complexing agent is etidronic acid (1-hydroxyethylidene-1,1-diphosphonic acid, 1-hydroxyethane-1,1-diphosphonic acid, HEDP, acetophosphonic acid, INCI Etidronic Acid) including its salts. In a preferred embodiment, the composition according to the invention accordingly comprises etidronic acid and/or one or more of its salts as complexing agent.

In a particular embodiment, the composition according to the invention comprises a complexing agent combination of one or more tertiary amines and one or more further complexing agents, preferably one or more complexing agent acids or salts thereof, in particular of triethanolamine and/or tetra-2-hydroxypropylethylenediamine and etidronic acid and/or one or more of its salts.

The composition according to the invention, such as in particular conditioning composition, comprises complexing agents advantageously in an amount of usually 0 to 20% by weight, preferably 0.1 to 15% by weight, in particular 0.5 to 10% by weight, particularly preferably 1 to 8% by weight, exceptionally preferably 1.5 to 6% by weight, based on the total composition.

In a further embodiment, the composition according to the invention, such as, in particular, conditioning composition, optionally comprises one or more viscosity regulators, which preferably function as thickeners.

The viscosity of the compositions can be measured using customary standard methods (for example Brookfield viscometer RVD-VII at 20 rpm and 20° C., spindle 3) and is preferably in the range from 10 to 5000 mpas. Preferred liquid to gel-like compositions have viscosities of from 20 to 4000 mpas, particular preference being given to values between 40 and 2000 mPas.

Suitable thickeners are inorganic or polymeric organic compounds. Mixtures of two or more thickeners can also be used.

The inorganic thickeners include, for example, polysilicic acids, clay minerals such as montmorillonites, zeolites, silicas, aluminum silicates, sheet silicates and bentonites.

The organic thickeners originate from the groups of natural polymers, modified natural polymers and completely synthetic polymers.

Polymers originating in nature which are used as thickeners are, for example, xanthan, agar-agar, carrageen, tragacanth, gum arabic, alginates, pectins, polyoses, guar flour, gellan gum, carob seed flour, starch, dextrins, gelatin and caseine.

Modified natural substances originate primarily from the group of modified starches and celluloses, examples which may be mentioned here being carboxymethylcellulose and other cellulose ethers, hydroxyethylcellulose and hydroxypropylcellulose, highly etherified methylhydroxyethylcellulose, and carob flour ether.

A large group of thickeners which is used widely in very diverse fields of application are the completely synthetic polymers, such as polyacrylic and polymethacrylic compounds, which may be crosslinked or uncrosslinked and optionally cationically modified, vinyl polymers, polycarboxylic acids, polyethers, activated polyamide derivatives, castor oil derivatives, polyimines, polyamides and polyurethanes. Examples of such polymers are acrylic resins, ethyl acrylate-acrylamide copolymers, acrylic ester-methacrylic ester copolymers, ethyl acrylate-acrylic acid-methacrylic acid copolymers, N-methylol-methacrylamide, maleic anhydride-methyl vinyl ether copolymers, polyether-polyol copolymers, and butadiene-styrene copolymers.

Further suitable thickeners are derivatives of organic acids and alkoxide adducts thereof, for example aryl polyglycol ethers, carboxylated nonylphenol ethoxylate derivatives, sodium alginate, diglycerol monoisostearate, nonionogenic ethylene oxide adducts, coconut fatty acid diethanolamide, isododecenylsuccinic anhydride, and galactomannan. Thickeners from said classes of substance are commercially available and are supplied, for example, under the tradenames Acusol®-820 (methacrylic acid (stearyl alcohol-20-EO) ester-acrylic acid copolymer, 30% strength in water, Rohm & Haas), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on D-D-glucose, D-mannose, D-glucuronic acid, Schöner GmbH), Deuteron®-XN (nonionogenic polysaccharide, Schöner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), Shellflo®-XA (xanthan biopolymer, stabilized with formaldehyde, Shell), Keizan, Keltrol T (Kelco).

In a further preferred embodiment, the composition according to the invention, such as, in particular, conditioning composition, optionally comprises one or more enzymes.

Suitable enzymes are, in particular, those from the classes of hydrolases, such as the proteases, esterases, lipases or lipolytic enzymes, amylases, cellulases or other glycosylhydrolases and mixtures of said enzymes. All of these hydrolases contribute, during laundering, to the removal of stains such as proteinaceous, grease-containing or starchy stains and graying. Cellulases and other glycosylhydrolases can, moreover, contribute to color retention and to an increase in the softness of the textile by removing pilling and microfibrils. For bleaching and for inhibiting color transfer it is also possible to use oxyreductases.

Of particularly good suitability are enzymatic active ingredients obtained from bacterial strains or fungi such as Bacillus subtilis, Bacillus licheniformis, Streptomyceus griseus and Humicola insolens. Preference is given to using proteases of the subtilisin type and in particular proteases obtained from Bacillus lentus. In this connection, enzyme mixtures, for example of protease and amylase or protease and lipase or lipolytic enzymes or protease and cellulase or cellulase and lipase or lipolytic enzymes or protease, amylase and lipase or lipolytic enzymes or protease, lipase or lipolytic enzymes and cellulase, but in particular protease and/or lipase-containing mixtures or mixtures with lipolytic enzymes are of particular interest. Examples of such lipolytic enzymes are the known cutinases. Peroxidases or oxidases have also proven to be suitable in some cases. Suitable amylases include, in particular, α-amylases, isoamylases, pullulanases and pectinases. As cellulases, preference is given to using cellobiohydrolases, endoglucanases and β-glucosidases, which are also called cellobiases, or mixtures thereof. Since various types of cellulose differ by virtue of their CMCase and avicelase activities, the desired activities can be established through targeted mixing of the cellulases.

The enzymes can be embedded as shaped bodies adsorbed or coated onto carrier substances in order to protect them against premature decomposition. The fraction of the enzymes, enzyme mixtures or enzyme granules can, for example, be about 0.1 to 5% by weight, preferably 0.12 to about 2% by weight, based on the total composition.

The compositions according to the invention, such as in particular detergents or cleaners, care compositions or conditioning compositions, can optionally comprise bleaches. Among the compounds serving as bleaches which produce H₂O₂ in water, sodium percarbonate, sodium perborate tetrahydrate and sodium perborate monohydrate are of particular importance. Further bleaches which can be used are, for example, peroxopyrophosphates, citrate perhydrates, and H₂O₂-producing peracidic salts or peracids, such as persulfates or persulfuric acid. It is also possible to use the urea peroxohydrate percarbamide, which can be described by the formula H₂N—CO—NH₂═H₂O₂. Particularly when the compositions are used for cleaning hard surfaces, for example during machine dishwashing, they may, if desired, also comprise bleaches from the group of organic bleaches, although their use is in principle also possible in compositions for the washing of textiles. Typical organic bleaches are the diacryl peroxides, such as, for example, dibenzoyl peroxide. Further typical organic bleaches are the peroxy acids, particular examples being the alkylperoxy acids and the arylperoxy acids. Preferred representatives are peroxybenzoic acid and its ring-substituted derivatives, such as alkylperoxybenzoic acids, but also peroxy-α-naphthoic acid and magnesium monoperphthalate, the aliphatic or substituted aliphatic peroxy acids, such as peroxylauric acid, peroxystearic acid, ε-phthalimidoperoxy-caproic acid (phthalimidoperoxyhexanoic acid, PAP), o-carboxybenzamido-peroxycaproic acid, N-nonenylamidoperadipic acid and N-nonenylamido-persuccinates, and aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid) can be used.

The bleaches can preferably be coated in order to protect them against premature decomposition.

Dyes can be used in the composition according to the invention, the amount of one or more dyes being chosen to be so low that no visible residues remain following use of the composition. The composition according to the invention is preferably free from dyes.

The composition according to the invention can preferably comprise one or more antimicrobial active ingredients or preservatives in an amount of from usually 0.0001 to 3% by weight, preferably 0.0001 to 2% by weight, in particular 0.0002 to 1% by weight, particularly preferably 0.0002 to 0.2% by weight, exceptionally preferably 0.0003 to 0.1% by weight.

Antimicrobial active ingredients or preservatives are differentiated, depending on the antimicrobial spectrum and mechanism of activity, between bacteriostats and bactericides, fungistats and fungicides etc. Important substances from these groups are, for example, benzalkonium chlorides, alkylarylsulfonates, halophenols and phenol mercuriacetate. Within the scope of the teaching according to the invention, the terms antimicrobial effect and antimicrobial active ingredient have the standard specialist meanings. Suitable antimicrobial active ingredients are preferably selected from the groups of alcohols, amines, aldehydes, antimicrobial acids and salts thereof, carboxylic esters, acid amides, phenols, phenol derivatives, diphenyls, diphenylalkanes, urea derivatives, oxygen-, nitrogen-acetals and -formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propylbutyl carbamate, iodine, iodophores, peroxo compounds, halogen compounds, and any desired mixtures of the above.

Here, the antimicrobial active ingredient can be selected from ethanol, n-propanol, isopropanol, 1,3-butanediol, phenoxyethanol, 1,2-propylene glycol, glycerol, undecylenic acid, benzoic acid, salicylic acid, dihydracetic acid, o-phenylphenol, N-methylmorpholinium acetonitrile (MMA), 2-benzyl-4-chlorophenol, 2,2′-methylenebis(6-bromo-4-chlorophenol), 4,4′-dichloro-2′-hydroxydiphenyl ether (dichlosan), 2,4,4′-trichloro-2′-hydroxydiphenyl ether (trichlosan), chlorhexidine, N-(4-chlorophenyl)-N-(3,4-dichlorophenyl)urea, N,N′-(1,10-decanediyldi-1-pyridinyl-4-ylidene)bis(1-octanamine) dihydrochloride, N,N′-bis(4-chlorophenyl)-3,12-diimino-2,4,11,13-tetraazatetradecanediimide amide, glucoprotamines, antimicrobial surface-active quaternary compounds, guanidines, including the bi- and polyguanidines, such as, for example, 1,6-bis(2-ethylhexylbiguanidohexane) dihydrochloride, 1,6-di(N₁,N₁′-phenyldiguanido-N₅,N₅′)hexane tetrahydro-chloride, 1,6-di(N₁,N₁′-phenyl-N₁,N₁-methyldiguanido-N₅,N₅′)hexane dihydrochloride, 1,6-di(N₁,N₁′-o-chlorophenyldiguanido-N₅,N₅′)hexane dihydrochloride, 1,6-di(N₁,N₁′-2,6-dichlorophenyldiguanido-N₅,N₅′)hexane dihydrochloride, 1,6-di(N₁,N₁′-beta(p-methoxyphenyl)diguanido-N₅,N₅′)hexane dihydrochloride, 1,6-di(N₁,N₁′-alpha-methyl-beta-phenyldiguanido-N₅,N₅′)hexane dihydrochloride, 1,6-di(N₁,N₁′-p-nitrophenyldiguanido-N₅,N₅′)hexane dihydrochloride, omega,omega-di(N₁,N₁′-phenyldiguanido-N₅,N₅′)-di-n-propyl ether dihydrochloride, omega,omega″-di(N₁,N₁′-p-chloro-phenyldiguanido-N₅,N₅′)-di-n-propyl ether tetrahydrochloride, 1,6-di(N₁,N₁′-2,4-dichlorophenyldiguanido-N₅,N₅′)hexane tetrahydrochloride, 1,6-di(N₁,N₁-p-methylphenylguanido-N₅,N₅′)hexane dihydrochloride, 1,6-di(N₁,N₁′-2,4,5-trichlorophenyldiguanido-N₅,N₅′)hexane tetrahydrochloride, 1,6-di[N₁,N₁′-alpha(p-chlorophenyl)ethyldiguanido-N₅,N₅′]hexane dihydrochloride, omega,omega-di(N₁,N₁′-p-chlorophenyldiguanido-N₅,N₅′)-m-xylene dihydrochloride, 1,12-di(N₁,N₁′-p-chlorophenyldiguanido-N₅,N₅′)dodecane dihydrochloride, 1,10-di(N₁,N₁′-phenyldiguanido-N₅,N₅′)decane tetrahydro-chloride, 1,12-di(N₁,N₁′-phenyldiguanido-N₅,N₅′)dodecane tetrahydrochloride, 1,6-di(N₁,N₁′-o-chlorophenyldiguanido-N₅,N₅′)hexane dihydrochloride, 1,6-di(N₁,N₁′-o-chlorophenyldiguanido-N₅,N₅′)hexane tetrahydrochloride, ethylenebis(1-tolylbiguanide), ethylenebis(p-tolylbiguanide), ethylenebis(3,5-dimethylphenylbiguanide), ethylenebis(p-tert-amylphenylbiguanide), ethylene-bis(nonylphenylbiguanide), ethylenebis(phenylbiguanide), ethylenebis(N-butylphenylbiguanide), ethylenebis(2,5-diethoxyphenylbiguanide), ethylene-bis(2,4-dimethylphenylbiguanide), ethylenebis(o-diphenylbiguanide), ethylenebis(mixed amyl naphthylbiguanide), N-butylethylenebis(phenyl-biguanide), trimethylenebis(o-tolylbiguanide), N-butyltrimethylebis(phenyl-biguanide) and the corresponding salts, such as acetates, gluconates, hydrochlorides, hydrobromides, citrates, bisulfites, fluorides, polymaleates, N-cocoalkyl sarcosinates, phosphites, hypophosphites, perfluorooctanoates, silicates, sorbates, salicylates, maleates, tartrates, fumarates, ethylenediaminetetraacetates, iminodiacetates, cinnamates, thiocyanates, arginates, pyromellitates, tetracarboxybutyrates, benzoates, glutarates, monofluorophosphates, perfluoropropionates, and any desired mixtures thereof. Also suitable are halogenated xylol and cresol derivatives, such as p-chlorometacresol or p-chlorometaxylol, and natural antimicrobial active ingredients of vegetable origin (e.g. from spices or herbs), animal origin, or microbial origin. Preference may be given to using antimicrobial surface-active quaternary compounds, a natural antimicrobial active ingredient of vegetable origin and/or a natural antimicrobial active ingredient of animal origin, exceptionally preferably at least one natural antimicrobial active ingredient of vegetable origin from the group comprising caffeine, theobromine and theophylline, and essential oils, such as eugenol, thymol and geraniol, and/or at least one natural antimicrobial active ingredient of animal origin from the group comprising enzymes such as protein from milk, lysozyme and lactoperoxidase, and/or at least one antimicrobial surface-active quaternary compound with an ammonium, sulfonium, phosphonium, iodonium or arsonium group, peroxo compounds and chlorine compounds. Substances of microbial origin, so-called bacteriocines, can also be used. Glycine, glycine derivatives, formaldehyde, compounds which readily release formaldehyde, formic acid and peroxide are preferably used.

The quaternary ammonium compounds (QACs) suitable as antimicrobial active ingredients have already been described above. Of particular suitability is, for example, benzalkonium chloride etc. Benzalkonium halides and/or substituted benzalkonium halides are commercially available, for example, as Barquat® ex Lonza, Marquat® ex Mason, Variquat® ex Witco/Sherex and Hyamine® ex Lonza, and Bardac® ex Lonza. Further commercially available antimicrobial active ingredients are N-(3-chloroallyl)-hexaminium chloride, such as Dowicide® and Dowicil® ex Dow, benzethonium chloride, such as Hyamine® 1622 ex Rohm & Haas, methylbenzethonium chloride such as Hyamine® 10X ex Rohm & Haas, cetylpyridinium chloride such as cepacol chloride ex Merrell Labs.

Furthermore, the compositions according to the invention, such as, in particular, detergents or cleaners, care compositions or conditioning compositions, can optionally comprise ironing assistants for improving the water absorption capacity, the rewettability of the treated textiles and for facilitating the ironing of the treated textile. For example, silicone derivatives may be used in the formulations. These additionally improve the rinse-out behavior of the detersive formulations by virtue of their foam-inhibiting properties. Preferred silicone derivatives are, for example, polydialkylsiloxanes or alkylarylsiloxanes in which the alkyl groups have one to five carbon atoms and are wholly or partly fluorinated. Preferred silicones are polydimethylsiloxanes, which may optionally be derivatized and are then amino-functional or quaternized or have Si—OH, Si—H and/or Si—Cl bonds. The viscosities of the preferred silicones at 25° C. are in the range between 100 and 100 000 mPas, where the silicones can be used in amounts between 0.2 and 5% by weight, based on the total composition.

The compositions according to the invention, in particular conditioning compositions, can be obtained by all known techniques familiar to the person skilled in the art. For example, the compositions can be obtained directly from their raw material by mixing, where appropriate with the use of high-shear mixing apparatuses. For liquid formulations, in particular conditioning compositions, it is advisable to melt any softener components present and then to disperse the melt in a solvent, preferably water. The inventively useful polymerizable betaine esters of the formula (I) or polymers preparable therefrom according to the invention can be integrated into the conditioning compositions, for example, by simple admixing.

Preferably, the conditioning compositions are in the form of fabric softeners. In this case, they are usually introduced into the rinse cycle of an automatic washing machine.

The invention further provides a substrate, in particular a conditioner substrate, which is impregnated and/or coated with a composition according to the invention, in particular conditioning composition, which thus, besides other constituents, comprises the fragrance composition according to the invention.

Conditioner substrates according to the invention are used primarily in textile treatment and in particular in textile drying processes. The substrate material consists preferably of porous, flat cloths. They can consist of a fibrous or cellular flexible material which has adequate thermal stability for use in the dryer and which can retain adequate amounts of an impregnation or coating composition in order to effectively condition substances without significant leakage or bleeding of the composition taking place during storage. These cloths include cloths made of woven and nonwoven synthetic and natural fibers, felt, paper or foam material, such as hydrophilic polyurethane foam.

Preference is given here to using conventional cloths made of nonwoven material (nonwovens). Nonwovens are generally defined as adhesively bonded fibrous products which have a mat or layered fiber structure, or those which include fiber mats in which the fibers are distributed randomly or in a statistical arrangement. The fibers may be natural, such as wool, silk, jute, hemp, cotton, linen, sisal or ramie; or synthetic, such as rayon, cellulose ester, polyvinyl derivatives, polyolefins, polyamides or polyesters. In general, any fiber diameter or titer is suitable for the present invention. The nonwoven materials used here have a tendency, on account of the random or statistical arrangement of fibers in the nonwoven material, to impart excellent strength in all directions, not tear or disintegrate when they are used, for example, in a domestic tumble dryer. Examples of nonwoven substances which are suitable substrates in the present invention are known, for example, from WO 93/23603. Preferred porous and flat cleaning cloths consist of one or different fiber materials, in particular of cotton, finished cotton, polyamide, polyester or mixtures of these. Preferably, the cleaning substrates in cloth form have an area of from 10 to 5000 cm², preferably from 50 to 2000 cm², in particular from 100 to 1500 cm² and particularly preferably from 200 to 1000 cm². The gramage of the material here is usually between 20 and 1000 g/m², preferably from 30 to 500 g/m² and in particular from 50 to 150 g/m². Conditioning substrates can be obtained by soaking or impregnation or else by melting the inventive compositions or conditioning compositions onto a substrate.

The invention further provides the use of a conditioning composition according to the invention or of a conditioning substrate according to the invention in a textile conditioning process, such as, for example, a rinse cycle, a textile drying process and a textile dry-cleaning method or textile freshening-up method. A conditioned substrate, e.g. made of wood, paper, leather or the like can likewise be used as air freshener.

Preferred compositions according to the invention are liquid detergents, preferably comprising surfactant(s) and further customary ingredients of detergents or cleaners. For example, liquid detergents suitable according to the invention can comprise, as thickening system, in each case based on the total composition, a) 0.1 to 5% by weight of a polymeric thickener, b) 0.5 to 7% by weight of a boron compound, and c) 1 to 8% by weight of a complexing agent.

Within the scope of the present invention, preference is given to aqueous liquid detergents of higher viscosity whose content of surfactant(s) is above 35% by weight.

Suitable thickeners, also called swell(ing) agents, such as, for example, alginates or agar agar, have already been described above. Preferred aqueous liquid detergents comprise, as thickening system from 0.2 to 4% by weight, preferably 0.3 to 3% by weight and in particular 0.4 to 1.5% by weight, of a polysaccharide.

A polymeric thickener to be used with preference is xanthan, a microbial anionic heteropolysaccharide which is produced by Xanthomonas campestris and a few other species under aerobic conditions and has a molar mass of from 2 to 15 million daltons. Xanthan is formed from a chain with β-1,4-attached glucose (cellulose) with side chains. The structure of the subgroups consists of glucose, mannose, glucuronic acid, acetate and pyruvate, where the number of pyruvate units determines the viscosity of the xanthan.

Liquid detergents according to the invention can preferably comprise a boron compound, which is used in amounts of from 0.5 to 7% by weight. Examples of boron compounds which can be used within the scope of the present invention are boric acid, boron oxide, alkali metal borates, such as ammonium, sodium and potassium ortho-, meta- and pyroborates, borax in its different hydration states and polyborates, such as, for example, alkali metal pentaborates.

Organic boron compounds such as esters of boric acid can also be used, as can, for example, reaction products of H₃BO₃ with nonionic surfactants and/or fragrances.

Preferred liquid detergents comprise 0.5 to 4% by weight, preferably 0.75 to 3% by weight and in particular 1 to 2% by weight of boric acid and/or sodium tetraborate.

Furthermore, liquid detergents according to the invention can comprise 1 to 8% by weight of a complexing agent. Particularly preferred liquid detergents here comprise citric acid or sodium citrate, preference being given to liquid detergents which comprise 2.0 to 7.5% by weight, preferably 3.0 to 6.0% by weight and in particular 4.0 to 5.0% by weight, of sodium citrate.

Besides the constituents of the thickening system, the liquid detergents according to the invention preferably comprise surfactant(s), in which case anionic, nonionic, cationic and/or amphoteric surfactants are used. From an application point of view, preference is given to mixtures of anionic and nonionic surfactants, where the fraction of the nonionic surfactants may preferably be greater than the fraction of anionic surfactants. It is likewise possible to use sugars and/or sugar derivatives, such as, for example, alkyl polyglucosides or cyclodextrins.

Other than in the operating examples, where otherwise indicated, or where required to distinguish over the prior art, all numbers expressing quantities of ingredients or reaction conditions disclosed herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

Practical and preferred embodiments of the invention can be further illustrated by means of the following examples, which are not intended as limiting the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1

A solid, unperfumed detergent was divided in terms of amount in the ratio 1:2. Component 1 was then perfumed with a perfume oil of scent direction “citrus freshness” by spraying; component 2 was perfumed with a colored perfume oil of scent direction “balsamic, caring”.

Via separate conveyor belts, the two partial streams were poured into a rotating, oblique funnel which fed into the packaging to be filled. Through appropriate choice of the belt speeds, which were each varied independently of one another, it was possible to adjust the mixing ratio of components 1 and 2 such that it was not constant over the duration of the filling operation.

This resulted in a product in which two differently smelling perfume oils were not evenly distributed in the product in proportion to one another.

### Example 2

A solid, unperfumed compact detergent with spherical basic structure was separated into two identical partial streams using a wedge-shaped insertion aid on a conveyor belt. One partial stream was sprayed with a very liquid perfume oil of the “Eau de Cologne” type, the other partial stream, to which colored speckles had also been added, was supplemented with a significantly more viscous perfume oil of the “flower accord” type. The two partial streams were introduced into the packages through a chute “arbitrarily”, i.e. by the chance principle, to give a layer structure of the detergent in the package. I.e. detergent layers perfumed with the perfume oil of the “Eau de Cologne” type and detergent layers perfumed with perfume oil of the “flower accord” type each alternated several times in one and the same package in an irregular manner, the ratio being controllable between 80:20 and 20:80, based on the overall package. This resulted in a product in which two differently smelling perfume oils were not evenly distributed in the product in proportion to one another.

In a modification of this example, an extremely high-value perfume (middle note) was additionally introduced, into the middle of the package, at a fill amount of about 47% by weight, based on the total fill amount of detergent, likewise as powder on the compact detergent as carrier. Upon reaching a fill amount of about 53% by weight, based on the total fill amount of detergent, detergent layers as described above were then produced again.

### Example 3

A liquid detergent was produced as base mass and provided with a perfume of the “mandarin lemon” type. Another, differently smelling perfume oil composition II was introduced into particles, which were then suspended in the liquid detergent in such a way that afterwards they neither rose up nor sank. The particle collective which was incorporated into the liquid detergent comprised in each case the same perfume oil composition II, based on the individual particles, but in quite different concentrations. The result was therefore a product in which two differently smelling perfume oils were not evenly distributed in the product in proportion to one another.

1. A consumer product having fragrance, comprising at least two differently smelling perfume oils that are not evenly distributed in the product in proportion to one another.

2. The product of claim 1, wherein the at least two perfume oils distributed unevenly in the product in an unsystematic way.

3. The product of claim 1, wherein the at least two perfume oils are distributed unevenly in the product in a systematic way.

4. The product of claim 1, comprising at least 3, 4, or 5 differently smelling perfume oils that are not evenly distributed in the product in proportion to one another.

5. The product of claim 1, comprising at least one compound selected from the group consisting of galaxolide, dihydromyrcenol, 4-tert-butyl cyclohexylacetate, gamma-isomethylionone, tetrahydrolinalool, hexylcinnamaldehyde, lilial, linalool, amylcinnamaldehyde, 6-methyl-gamma-ionone, methyl oleate, neryl acetate, 15-pentadecalactone, phenoxyethyl isobutyrate, phenylethyl methanoate, a-pinenes, b-pinenes, rose oxides, sabinenes, anethole, 2-hydroxypentyl benzoate, diphenyl ether, benzophenone, cyclamenaldehyde, a-damascone, decanal, dicyclopentadiene alcohol, allyl cyclohexylpropionate, isobornyl acetate, bornyl acetate, dihydromethyl jasmonate, eucalyptol, n-dodecanol, ethyl palmitate, geraniol acetate, hexyl acetate, n-hexyl salicylate, a-ionone, 1-limonene, methyl palmitate, 2-naphthyl methyl ketone, isopropyl myristate, rosephenone, a-terpineol, styrallyl acetate, thujopsen, dimethylbenzylcarbinyl butyrate, d-limonene, dimethylbenzylcarbinyl acetate, citronellol, 2-tert-butylcyclohexanol, caryophyllenes, ethyl stearate, tonalide, 2,4-hexadienal, methanoazulene, methyl laurate, methyl myristate, 2-methylundecanol, myrcenes, nonanal, nopyl acetate, 15-pentadecalactone, beta-phellandrenes, 3-phenyl-2-methylpropene, rose acetate, traseolides, widdrenes and/or d-limonene.

6. The product of claim 1, comprising a layer structure wherein adjacent layers are differently fragranced relative to one another.

7. The product of claim 1, comprising a detergent, cleaner, or cosmetic.

8. The product of claim 1, comprising at least 0.1% by weight of an anionic surfactant.

9. The product of claim 1, comprising at least 0.1% by weight of a nonionic surfactant.

10. The product of claim 1, comprising at least 0.1% by weight of a cationic surfactant.

11. The product of claim 1, in pulverulent, compressed, or granular form.

12. The product of claim 1, in solid form.

13. The product of claim 1, in liquid form.

14. The product of claim 13, comprising a suspended solid that carries a perfume oil.

15. The product of claim 12, comprising a supported perfume oil.

16. The product of claim 13, comprising a supported perfume oil.

17. The product of claim 1, comprising one or more components selected from the group consisting of anionic surfactants, cationic surfactants, amphoteric surfactants, nonionic surfactants, acidifying agents, alkalizing agents, anticrease compounds, antibacterial substances, antioxidants, antiredeposition agents, antistats, builder substances, bleaches, bleach activators, bleach stabilizers, bleach catalysts, ironing aids, cobuilders, shrink preventers, electrolytes, enzymes, color protectants, colorants, dyes, color transfer inhibitors, fluorescent agents, fungicides, germicides, odor-complexing substances, auxiliaries, hydrotropes, rinse aids, complexing agents, preservatives, corrosion inhibitors, optical brighteners, perfume carriers, pearlizing agents, pH extenders, phobicization and impregnation agents, polymers, swelling and antislip agents, foam inhibitors, sheet silicates, soil repellent substances, silver protectants, silicone oils, UV protection substances, viscosity regulators, thickeners, discoloration inhibitors, graying inhibitors, vitamins, and fabric softeners.

18. The product of claim 1, wherein the at least two differently-smelling perfume oils produce at least two different scent note selected from the group consisting of almond-like odor, apple-like odor, apple peel-like odor, apricot-like odor, banana-like odor, bitter almond-like odor, black currant-like odor, citrus-like odor, cocoa-like odor, coconut-like odor, cream-like odor, flower-like odor, fresh odor, fruit odor, geranium-like odor, grape-like odor, grapefruit-like odor, grass-like odor, green note, green tea-like odor, herb-like odor, honey-like odor, hyacinth-like odor, jasmine-like odor, lavender-like odor, lemon-like odor, lily-like odor, magnolia-like odor, mandarin-like odor, melon-like odor, mint-like odor, nut-like odor, orange-like odor, peach-like odor, peppermint-like odor, pine-like odor, pineapple-like odor, plum-like odor, raspberry-like odor, rose-like odor, green mint-like odor, strawberry-like odor, sweetish odor, vanilla-like odor, and wood-like odor.
